(19) United States
(12) Patent Application Publication
(10) Pub. No.: US 2025/0189004 A1
(43) Pub. Date: Jun. 12, 2025

(54) ELECTROMECHANICAL BRAKE, WEAR ADJUSTMENT DEVICE AND METHOD FOR OPERATING AN ELECTROMECHANICAL BRAKE

(71) Applicant: STOP-IN-TIME GMBH, Bad Waltersdorf (AT)

(72) Inventors: Michael Putz, Sebersdorf (AT); Thomas Zipper, Vienna (AT)

(21) Appl. No.: 18/023,037

(22) PCT Filed: Aug. 24, 2021
(86) PCT No.: PCT/AT2021/060293

§ 371 Date: Jul. 21, 2023

(30) Foreign Application Priority Data
Aug. 24, 2020 (AT) A60260/2020
Dec. 8, 2020 (AT) A60363/2020
Jul. 14, 2021 (AT) A60191/2021

(51) Int. Cl. F16D 65/38; F16D 66/00; F16D 121/24; F16D 121/26; F16D 125/36; F16D 125/58; F16D 125/64

(52) U.S. Cl. CPC F16D 65/38; F16D 66/00; F16D 2065/386; F16D 2066/001; F16D 2066/005; F16D 2121/24; F16D 2121/26; F16D 2125/36; F16D 2125/582; F16D 2125/64

(57) ABSTRACT

In particular, the invention relates to an electromechanical brake, a machine, a wear readjustment device and a method or procedure, whereby the electromechanical brake comprises an actuator, a transmission unit, a brake lining and a friction surface, the actuator which is moving in a limited actuator actuation range, the actuator which is executing a lining stroke over at least a portion of its actuator actuation range via the transmission unit, whereby the transmission unit has a non-linearity, i.e. a transference ratio which is not constant over at least part of the actuator operating range, and whereby the transference ratio of the transmission unit is selected and/or configured in such a way that at least two subsections with differently acting non-linearities are formed along the actuator operating range.

### TECHNICAL FIELD

The invention relates to an electromechanical brake, a machine, a wear adjustment device and a method according to the general terms of the independent patent claims.

### BACKGROUND OF THE INVENTION

Different types of brakes are known from the status of technology. For example, types of brakes are known in which the actuator of the brake is essentially operated at an optimum operating point of the actuator in all partial areas. However, the disadvantage of such brakes is that they are not adapted to the different operating conditions of the brake itself.

### SUMMARY OF THE INVENTION

The task of the invention is to overcome the disadvantages of the status of technology. In particular, it is the task of the invention to provide an electromechanical brake which is adapted to a wide variety of operating conditions and load conditions which occur during the operation of an electromechanical brake. Furthermore, it can be a task of the invention to provide possibilities for the targeted detection of parameters describing the behavior of the brake, such as mechanical losses, as well as for the targeted performance of special tasks, such as actuation of a wear adjuster or avoidance of a residual grinding torque.

The task according to the invention will be solved in particular by the features of the independent patent claims.

In particular, the invention relates to an electromechanical brake which comprises an actuator, in particular an electric actuator, a transmission unit, a brake lining and a friction surface.

Preferably, it is provided that the actuator can move within a limited actuator operating range.

Preferably, it is provided that the actuator executes a, in particular functional, lining stroke via the transmission unit at least in a part of its actuator operating range.

In the context of the present invention, functional lining stroke can be understood as a lining stroke in which the brake lining is moved in a targeted manner, in particular in the direction of the friction surface. In other words, a functional lining stroke can also be relevant to braking efficiency.

In the context of the present invention, a brake-activity relevant lining stroke can be understood as a lining stroke by which the brake lining is moved, in particular in the direction of the friction surface, in particular the friction lining.

If applicable, it is provided that the actuator effects a functional lining stroke via the transmission unit in at least part of its actuator operating range.

For braking, the brake lining can be moved in the direction of the friction surface to generate a press-on force and a resulting braking torque and subsequently pressed against the friction surface.

Preferably, the transmission unit is provided with a non-linearity i.e. a transference ratio which is not constant over at least part of the actuator operating range.

Preferably, the transference for the transmission unit is selected and/or designed in such a way that at least two sections with differently acting non-linearities are created along the actuator operating range.

Preferably, the two differently acting non-linearities are selected and/or designed from the following non-linearities: Non-linearity in order to overcome an air gap between the brake lining and the friction surface and non-linearity to determine the contact point of the friction surface and the brake lining.

Non-linearity in order to achieve a minimum braking effect, non-linearity to generate an increasing braking torque, non-linearity to operate with lowered electrical power requirements, non-linearity to quickly achieve high braking effects, non-linearity to measure and/or adjust parameters, non-linearity to reduce electrical and mechanical loads during lining stroke, non-linearity to compensate for possible brake fade, non-linearity for wear adjustment.

If applicable, it is provided that, when the actuator is moved, then the transmission unit will be actuated. In a further step, it can be provided that a lining stroke is executed by the actuation of the transmission unit and, in particular, that the brake lining executes a movement.

If applicable, the transmission unit or at least a part of the transmission unit is to be designed or configured in a non-linear manner.

The transmission unit can include several transmission unit parts. In particular, the transmission unit can comprise at least one gear train and/or at least one transference unit, which in particular has at least one non-linear transmission ratio which varies over the actuation path. Furthermore, the transmission unit can include at least one transference unit for driving or not driving various parts.

The movement of the actuator can, if applicable, be non-linear when related to the resulting movement of the brake lining, in particular the lining stroke.

If applicable, a movement of the actuator in some areas can also not generate a lining stroke. In particular, it can be provided that at the beginning and at the end of the limited actuator operating range i.e. in particular of the actuator movement range, the movement of the actuator does not cause any, in particular no functional, lining stroke and/or is free of lining stroke.

The zero position of the transmission unit can be determined geometrically and/or mechanically by the transmission unit, in particular the non-linearities. Accordingly, in the context of the invention, the zero position of the transmission unit can be understood to be the position from which an actuation of the actuator in an initial direction causes a, in particular functional, lining stroke. The zero position of the transmission unit can also be determined, among other things, by the geometry of the transmission unit, in particular the start of the slope.

If applicable, the actuator can be brought into a rest position with functional lining stroke and without braking effect, in particular starting from the zero position of the transmission unit. From the rest position, the actuator can be moved, if applicable, in an initial direction in order to overcome the air gap and/or in order to increase the braking effect and/or in a second direction of operation in order to execute other tasks.

The rest position of the transmission unit can be a position of the transmission unit in which the air gap has a defined size. If applicable, the rest position can be identical to the zero position.

Where appropriate, it is envisaged that the transmission unit is adapted in ranges for the basis of different requirements for the brake, such as moderate deceleration, full braking, continuous braking and/or the like, as well as internal functionalities. In other words, the transmission unit, especially the non-linearities, can be optimized to the operating conditions which can occur during the operation of an electromechanical brake.

If applicable, it is envisaged that this adaptation and/or optimization of the transmission unit will be executed with the superordinated objective of achieving the highest possible functional safety of the electromechanical brake and the entire braking system. In other words, executing this adaptation and/or optimization of the transmission unit should not be based on individual components, such as the electric actuator.

If applicable, it is provided that at least two ranges of the transmission unit with in particular functional, preferably braking effect-relevant, lining stroke are optimized and/or adapted differently.

If applicable, it is envisaged that at least two ranges of the transmission with, in particular functional, preferably braking effect-relevant, lining stroke have two different non-linearities.

In the context of the present invention, the term “conveying device or transporting device” can be understood to mean any device and/or machine with which it is possible to drive and/or with which it is possible to transport people and/or loads while driving.

If applicable, it is provided that the transference for the transmission unit is selected and/or designed in such a way that at least one section with a non-linearity is created, provided and/or arranged along the actuator operating range.

If applicable, it is provided that the transference for the transmission unit is selected and/or designed in such a way that two, three, four, five, six, seven, eight, nine, ten or more subsections with differently acting non-linearities are created, provided and/or arranged along the actuator operating range.

In the context of the present invention, a non-linearity can therefore be understood as a non-linear transference.

In the context of the present invention, EMB can be understood to mean the, in particular electromechanical braking device and/or the, in particular an electromechanical brake.

There can be and/or can occur in the brake movements and forces in the direction of the lining press-on force (especially with parts for lining press-on force) but also movement components and force components which are different to this (also essentially perpendicular to this).

Also, with reference to the figures utilized in the patent application or common installation positions of brakes, the term “height error”, “transverse” or “normal” is utilized where appropriate on a case-by-case basis in order to indicate a movement component which deviates from the advantageous pressing direction e.g. in figures approximately horizontally, and which is also undesirable in this case. Accordingly, the term “high” can therefore be understood to mean the position of the press-on force movement or the position of a component which deviates from it. When press-on force parts move as relative to each other with a relative movement, in particular also sliding and/or also undesired, in particular with a relative movement of their surfaces, then this movement is sometimes referred to as a “scraping” movement.

If applicable, it is provided that the transference for the transmission unit is selected and/or designed in such a way that the actuator is operated in at least one partial range, in particular with a brake-effect relevant and/or functional lining stroke, at an operating point which deviates from the optimum operating point of the actuator.

If applicable, it is provided that the transference ratio for the transmission unit is selected and/or designed in such a way that the actuator is operated in at least one partial range, in particular with functional and/or braking effect-relevant lining stroke, at an operating point which deviates from an operating point of maximum power of the actuator.

If applicable, it is provided that the transmission unit executes or converts a movement of the actuator in an initial direction starting from an initial position, in particular a zero position, of the transmission unit for braking.

If applicable, it is provided that, starting from an initial position, in particular a zero position, of the transmission unit for adjusting the air gap, in particular for operating a wear adjustment device, the transmission unit executes or converts a movement of the actuator in a second direction, in particular opposite to the initial direction.

If applicable, it is provided that at least one part of the actuator rotates once in an initial direction of rotation and once in a second direction of rotation. The second direction of rotation can be opposite to the initial direction. If applicable, the transmission unit can convert the initial direction of rotation of the actuator into a movement in the initial direction. If applicable, the transmission unit can convert the second direction of rotation of the actuator into a movement in the second direction.

If applicable, it is provided that the transmission converts only a part of the actuator movement, in particular only a part of the actuator operating range, into a functional lining stroke, in particular one which is relevant to the braking effect.

If applicable, it is provided that the actuator is moved in the initial direction and the second direction via the transmission, if applicable, before and/or after the part of the actuator operating range relevant for the functional and/or braking effect-relevant lining stroke, without generating a functional and/or braking effect-relevant lining stroke.

If applicable, it is provided that the transference for the transmission unit is selected and/or designed in such a way that, starting from the initial position, in particular the zero position, of the transmission unit, the non-linearities are therefore arranged along the movement of the actuator, in particular of the lining stroke, in the initial direction.

If applicable, it is provided that at least two non-linearities are arranged along the initial direction according to the order given below: non-linearity for reducing electrical and mechanical stresses at lining stroke, non-linearity for overcoming the air gap between the brake lining and the friction surface, non-linearity for determining the contact point of the friction surface and the brake lining, non-linearity for achieving a minimum braking effect, non-linearity for operation with reduced electrical power requirement, non-linearity for rapidly achieving high braking effects, non-linearity for generating an increasing braking torque, the braking torque being adapted, if appropriate, to the respective braking dynamics, non-linearity for compensating for brake fade.

If applicable, it is provided that the aforementioned non-linearities are arranged successively on the transmission unit along the initial direction. In particular, the aforementioned non-linearities can be stepped through and/or traversed sequentially as the actuator moves.

If applicable, it is provided that the non-linearities are arranged along the initial direction in any order.

If applicable, it is provided that the aforementioned non-linearities are arranged in any order on the transmission unit along the initial direction.

If applicable, it is provided that the transference for the transmission unit is selected and/or designed in such a way that starting from the initial position, in particular the zero position, of the transmission unit along the movement of the actuator in the second direction, the non-linearity for measuring and/or setting parameters and/or the non-linearity for wear adjustment are arranged.

If applicable, it is provided that the non-linearities for measuring and/or setting parameters and/or the non-linearities for wear adjustment are arranged successively on the transmission unit along the second direction. In particular, the non-linearities for measuring and/or setting parameters and/or the non-linearities for wear adjustment can be stepped through and/or traversed in succession during the movement of the actuator.

If applicable, it is provided that the non-linearity is designed for measuring and/or adjusting parameters, if applicable, for measuring mechanical losses and, if applicable, the zero position of the transmission unit and, if applicable, the zero position of the actuator position and/or at least and, if applicable, a spring effect.

If applicable, it is provided that the non-linearity for measuring and/or setting parameters is designed in such a way that the actuator, starting from the zero position of the transmission unit, is moved in its first direction.

If applicable, it is provided that at least one parameter of the brake, in particular motor losses, transmission unit losses, mechanical losses and/or the effect of any springs which can be present, is or will be measured by the movement of the actuator in its initial direction.

If applicable, it is provided that the torque of the actuator, which is generated and/or resulting from the movement, is therefore detected.

If applicable, it is provided that the assessment of whether an adjustment of the brake is necessary will be implemented on the basis of a comparison of the at least one parameter of the brake, in particular the torque of the actuator, with expected values and/or with measured values of the torque of the actuator at other operating points and/or in other operating statuses.

If applicable, it is provided that the non-linearity for measuring and/or setting parameters is designed in such a way that the actuator, starting from the zero position of the transmission unit, is moved in its second direction.

If applicable, it is provided that a force measuring device, in particular a spring and/or an end stop, is provided in the second direction, against which at least a part of the transmission unit, in particular the actuator, is in contact, whereby, if applicable, the zero position of the actuator position can be measured and/or adjusted.

If applicable, it is provided that the at least one parameter of the brake is executed by comparing the torque, the motor current and/or the motor voltage in normal operation and the torque, the motor current and/or the motor voltage in measurement operation.

If applicable, it is provided that the non-linearity for reducing electrical stresses and mechanical stresses at the lining stroke start is such that the transference ratio of this non-linearity in the first half of the air gap is more than twice as large as the speed transference in the second half of the air gap.

If applicable, it is provided that the non-linearity for the reduction of electrical stresses and mechanical stresses at the lining stroke is designed in such a way that the transference ratio, in particular the speed transference of this non-linearity, preferably the ratio between the speed of the actuator and the speed of the lining stroke, in the first half of the air gap, in particular in the first half of the path for overcoming the air gap, is more than twice as large as the speed transference in the second half of the air gap.

If applicable, it is provided that the non-linearity for overcoming the air gap between the brake lining and the friction surface is designed in such a way, that the transference ratio of this non-linearity over more than half of the air gap is less than half the maximum speed transference in the lining stroke region adjacent to the air gap, so that, if applicable, the air gap is overcome more quickly when this is compared to normal operation.

If applicable, it is provided that the non-linearity for overcoming the air gap between the brake lining and friction surface is designed in such a way that the transference ratio, in particular the speed transference of this non-linearity, preferably the ratio between the speed of the actuator and the speed of the lining stroke, over more than half of the air gap, in particular more than half of the distance for overcoming the air gap, is less than half as large as the maximum speed transference in the lining stroke region adjoining the air gap, so that, if applicable, the air gap is overcome more quickly in comparison with normal operation.

If applicable, it is provided that the non-linearity for overcoming the air gap between the brake lining and the friction surface is such that the actuator is operated with the maximum actuator power, whereby the air gap is overcome as quickly as possible.

If applicable, it is provided that the non-linearity for overcoming the air gap between the brake lining and friction surface is to be designed in such a way that the air gap is overcome as quickly as possible by way of a device, in particular a cam or a ramp, having a gradient which is designed in such a way that, if applicable, starting current peaks and starting current loads can be prevented and/or reduced at the start of the lining stroke.

If applicable, it is provided that the non-linearity for determining the contact point of the friction surface and the brake lining is designed in such a way that the contact point of the brake lining and the friction surface can be recognized, in particular, from the energy, current and/or power consumption of the actuator and/or from the course of the actuator load, in particular the torque. If applicable, it is provided that, by means of the non-linearity for determining the contact point of the friction surface and the brake lining, it is possible to inspect whether an adjustment of the brake, in particular an adjustment of the brake lining and/or an adjustment of the air gap, is necessary.

If applicable, it is provided that the transference for the transmission unit for the non-linearity for determining the contact point of the friction surface and the brake lining, in the possible range of the contact point of the brake lining and the friction surface, generates an evaluable combination of transmission ratio and actuator torque, in particular an interpretable curve from the performance consumption for the energy, current and/or power of the actuator.

If applicable, it is provided that the evaluable combination of transference ratio and actuator torque is an interpretable progression from the performance consumption for the energy, current and/or power of the actuator, the actuator load and/or the actuator torque, via the actuation, in particular taking into account the respective transference ratio.

If applicable, it is provided that in the range of non-linearity for determining the contact point of the friction surface and the brake lining, there is a significant difference created from the behavior in the air gap from the contact of the friction surface and the brake lining.

If applicable, it is provided that the non-linearity for achieving a minimum braking effect is designed in such a way that a certain required minimum braking effect, in particular in the case of emergency braking, is achieved within a minimum effective time, the minimum effective time being only at most 20% above the time which, in particular for achieving the minimum braking effect, is technically possible with the electromechanical brake.

If applicable, it is provided that the non-linearity for generating an increasing braking torque, the braking torque being adapted to the braking dynamics if applicable, is designed in such a way that the speed of the braking torque build-up is adapted to the dynamic weight shift of the vehicle caused thereby, so that a locking of the wheels of the vehicle is counteracted if applicable.

If applicable, it is provided that the non-linearity for operation with reduced electrical power demand is designed in such a way that the power consumption of the actuator during operation of the transmission unit at low speeds and/or when the actuator is at a standstill is at least 20% lower than in comparison to a non-linearity which is designed in particular according to the criteria of the maximum achievable motor output power, for the same or a similar operation and/or operating point, in particular for operation at low speeds and/or with the actuator at a standstill, so that the power consumption of the actuator is reduced, in particular during longer continuous braking.

If applicable, it is provided that the transference for the transmission unit is selected and/or designed in such a way that, starting from the initial position, in particular the zero position, of the transmission unit along the movement of the actuator, in particular of the lining stroke, in the initial direction, the non-linearity for operation with reduced electrical power requirement is arranged in such a way that, in operating statuses which have a long holding time and/or a high temperature load, a low consumption of electrical energy and/or a low heat loss of the, in particular electrical, actuator will therefore result.

If applicable, it is provided that the non-linearity for compensation of brake fade is designed in such a way that the actuator is operated with a motor torque which, under the same operating conditions, in particular the operating temperature, is higher, in particular higher than the maximum permissible motor torque and/or higher than the maximum permissible shaft power, than that with a non-linearity which is designed according to the criteria of the maximum achievable motor output power, so that a braking effect is also achieved in the event of brake fade.

If applicable, it is provided that at least one non-linearity, in particular over the lining stroke, for compensation of air gap errors is designed in such a way that an air gap error, in particular a deviation of the size of the air gap from the assumed dimension, is compensated for whereby the air gap error preferably results from wear.

If applicable, it is provided that, if applicable, the brake is operated up to a certain deviation of the magnitude of the air gap error, in particular by adjusting the movement of the actuator, preferably without wear adjustment and/or without a wear adjustment device.

If applicable, it is provided that the non-linearity for wear adjustment is designed in such a way that the actuator, in particular starting from the zero position of the transmission unit, executes a movement against the direction of movement or direction of rotation which is utilized for braking, in particular a movement in the second direction and that, by this movement of the actuator, in particular without braking effect, the wear adjustment device is actuated.

If applicable, it is provided that the non-linearity for wear adjustment is designed in such a way that the actuator executes a movement in the direction of braking, in particular a movement in the initial direction, that the wear adjustment device is subsequently actuated by this movement of the actuator, in that, if applicable, after a maximum position of the actuator required for braking, in particular for parking braking, has been reached, an additional movement of the actuator, in particular without functional lining stroke, will result in actuation of the wear adjustment device or prepares this.

If applicable, it is provided that the non-linearity for quickly achieving high braking effects is designed in such a way that the actuator is operated with a motor torque which is equal to the maximum permissible motor torque and/or which is equal to the maximum permissible shaft power.

If applicable, it is provided that the actuator and/or the transmission is set up for braking and wear adjustment, in particular for actuating a wear adjustment device.

If applicable, it is provided that the brake comprises only one actuator for braking and for wear adjustment, in particular for actuating a wear adjustment device.

If applicable, it is provided that the brake comprises a wear adjustment device which is actuated, in particular exclusively, by the actuator.

If applicable, it is provided that the actuator comprises several parts.

If applicable, it is provided that the actuator comprises a spring and an electric motor, whereby, if applicable, the spring and the electric motor are independent of each other in terms of component size and/or direction of action.

If applicable, it is provided that the spring interacts with the electric motor via at least one additional component and/or via the transmission unit.

If applicable, it is provided that the actuator comprises two electric motors.

If applicable, it is provided that the electromechanical brake interacts with at least one electric machine and/or electromagnetically excited electric machine.

If applicable, it is provided that at least one actuator position of the actuator is retained with a lowered, in particular very low, electrical power requirement or as current free by corresponding design of at least one non-linearity and, if applicable, by the interaction of this at least one non-linearity with a spring, in particular a spring action.

If applicable, it is provided that the transmission unit comprises kinematic devices.

If applicable, it is provided that the transmission unit comprises a cam, a ball ramp, and/or a lever.

If applicable, it is provided that the transference ratio for the transmission unit, especially in braking operation, in particular the design and/or the effect of the non-linear transmission ratio, preferably the relationship between actuator position and effective transmission ratio, can be amended.

If applicable, it is provided that the transference ratio for the transmission unit can be amended, in particular actively, preferably by turning a ratchet.

If applicable, it is provided that the transference ratio for the transmission unit can be amended, in particular passively, preferably by spring-loaded backward movement of components, elastic deformation of components.

Within the context of the present invention, brake operation can therefore be understood to mean the period between commissioning and switching off for the brake during which the brake is ready to accept and implement braking commands. In other words, the brake is ready for operation for braking in braking mode.

If applicable, it is provided that the effective range of at least one non-linear and/or non-linear-acting component is distributed over several, in particular non-linearly designed and/or non-linearly acting parts of the transmission unit, in particular several transmission unit components, preferably cams and/or ball ramps which are rotated against each other.

The effective range of at least one non-linear and/or non-linear component, in particular the effective range and/or the design of the transmission unit components, can each be assigned to a specific actuator operating range.

By using additional non-linear acting components, it can be possible when applicable to increase and/or enlarge the overall actuator operating range, which is predetermined and/or limited by the non-linearity of the individual components. In particular, the effective range of the existing non-linearities, preferably the actuator operating range which is limited by the operating range and/or range of movement of the transmission unit components, can thereby be increased and/or enlarged.

If applicable, it is provided that an initial transmission unit component, in particular an initial non-linearity of the initial transmission unit component, is associated with an initial actuator operating region. In order to be able to increase the range of movement and/or the actuation range, a second transmission unit component can be provided, which is assigned to a second actuator operating range. This second transmission unit component can indicate another portion of the initial non-linearity and/or a second non-linearity. The second actuator operating range can be located as adjacent to the initial actuator operating range.

If applicable, it is provided that the transference for the transmission unit is selected and/or designed in such a way that an actuator movement without braking effect causes a movement of brake components, such as in particular the brake lining carrier.

If applicable, it is provided that this movement causes no and/or only a minimized residual drag torque.

If applicable, it is provided that a movement of brake components, such as in particular the brake lining carrier, is affected by an actuator movement which is free of braking effect i.e., without braking effect, in such a way that no and/or only a minimized residual drag torque remains, which is possibly known under the term “zero drag”.

In particular, the invention relates to a machine, a conveying device or transporting device, a vehicle, an elevator and/or a bicycle, which comprises an electromechanical brake according to the invention.

If applicable, the invention relates to a part of a conveying device or transporting device or a part of a machine, such as in particular a propeller shaft, which comprises an electromechanical brake according to the invention or is created from an electromechanical brake according to the invention.

If applicable, it is provided that the machine, in particular the conveying or transporting device, comprises an additional, in particular electronic, braking device, whereby the additional braking device is optionally designed as a, in particular spring-loaded, parking brake.

In particular, the invention relates to a wear adjuster, whereby the wear adjuster is adapted in such a way to be actuated by the actuator of the electromechanical brake according to the invention.

If applicable, it is provided that the wear adjuster is actuated by the actuator of the electromechanical brake according to the invention.

In particular, the invention relates to a method of operating an electromechanical brake according to the invention.

If applicable, it is provided that the actuator of the brake is moved within a limited actuator operating range.

If applicable, it is provided that the actuator executes a lining stroke via the transmission unit in at least a part of the actuator operating range and, in the case of braking, the brake lining is pressed in the direction of and/or against the friction surface in order to generate a press-on force and a resulting braking torque.

If applicable, it is provided that the transmission unit indicates a non-linearity i.e., a transference ratio which is not constant over at least part of the actuator operating range.

If applicable, it is provided that the actuator is moved along the actuator operating range via the transmission unit over or along at least two differently acting non-linearities.

If applicable, it is provided that the two different acting non-linearities are selected from the following non-linearities: non-linearity in order to overcome the air gap between the brake lining and the friction surface, non-linearity in order to determine the contact point of the friction surface and the brake lining, and the non-linearity in order to achieve a minimum braking effect, non-linearity in order to generate an increasing braking torque, non-linearity in order to operate with lowered electrical power requirements, non-linearity in order to quickly achieve high braking effects, non-linearity in order to measure and/or adjust parameters, non-linearity in order to reduce electrical and mechanical loads during lining stroke, non-linearity in order to compensate for brake fade, non-linearity for wear re-adjustment.

If applicable, it is provided that the transmission unit is designed in such a way that the actuator is operated in at least one partial range, in particular with functional and/or braking effect-relevant lining stroke, at an operating point which deviates from the optimum operating point of the actuator.

If applicable, it is provided that the actuator is operated in at least one partial range, in particular with functional and/or braking effect-relevant lining stroke, in an operating point which deviates from an operating point of maximum power of the actuator.

If applicable, it is provided that a movement of the actuator in an initial direction is converted by the transmission unit, in particular starting from a zero position of the transmission unit, for creating braking.

In particular, a movement in an initial direction can therefore be executed by the transmission unit if applicable.

If applicable, it is provided that a movement of the actuator in a second direction, in particular opposite to the initial direction, is implemented by the transmission unit, in particular starting from a zero position of the transmission unit, in order to adjust the air gap, in particular to operate a wear adjustment device.

In particular, a movement in a second direction can therefore be executed by the transmission unit if applicable.

If applicable, it is provided that only a part of the movement of the actuator, in particular of the actuator operating range, is converted into a functional and/or braking effect-relevant lining stroke via the transmission unit.

If applicable, it is provided that the actuator is moved in the initial direction and the second direction via the transmission unit, if applicable before and/or after the part of the actuator operating range which is relevant for the functional and/or braking effect-relevant lining stroke, without generating a functional and/or braking effect-relevant lining stroke.

If applicable, it is provided that the transference for the transmission unit is or will be designed in such a way that, starting from the initial position, in particular the zero position, of the transmission unit, the actuator and/or the transmission unit is or are moved in the initial direction, in particular along the lining stroke.

If applicable, it is provided that the non-linearities are therefore arranged along this initial direction.

If applicable, it is provided that the transference for the transmission unit is selected and/or designed in such a way that, starting from the initial position, in particular the zero position, of the transmission unit, the actuator and/or the transmission unit is moved in the second direction.

If applicable, it is provided that the non-linearity for measuring and/or setting parameters and/or the non-linearity for wear adjustment are therefore arranged along this second direction.

If applicable, it is provided that the non-linearity for measuring and/or setting parameters is or will be designed in such a way that the actuator, starting from the initial position, in particular the zero position, of the transmission unit, is moved in its initial direction.

If applicable, it is provided that at least one parameter of the brake, in particular motor losses, transmission unit losses, mechanical losses and/or the effect of any springs which are present, is measured by the movement of the actuator in its initial direction. If applicable, it is provided that by moving the actuator in its initial direction, then at least one parameter of the brake is measured by comparing this parameter when the actuator is moving in other directions.

If applicable, it is provided that the torque of the actuator which is generated and/or results from the movement is detected.

If applicable, it is provided that the at least one parameter of the brake, in particular of the torque of the actuator, is compared with expected values and/or with measured values of the torque of the actuator at other operating points and/or in other operating statuses.

If applicable, it is provided that, based on the comparison utilized, it will be evaluated whether an adjustment of the brake is necessary.

If applicable, it is provided that the non-linearity for measuring and/or setting parameters is or will be designed in such a way that the actuator, starting from the initial position, in particular the zero position, of the transmission unit, is moved in its second direction.

If applicable, it is provided that a force measuring device, in particular a spring and/or an end stop, is or will be provided in the second direction against which at least a part of the transmission unit, in particular the actuator, abuts, whereby the zero position of the actuator position is therefore measured and/or adjusted.

If applicable, it is provided that the non-linearity for reducing electrical stresses and mechanical stresses during the lining stroke is or will be designed in such a way that the transference ratio of the transmission unit, in particular the speed substitution of this non-linearity causes the actuator to move less quickly, in particular less than half as quickly, in a part, preferably in the first half, of the air gap than the maximum speed in the lining stroke region which is adjoining to the air gap.

If applicable, it is provided that the non-linearity for overcoming the air gap between the brake lining and the friction surface is or will be designed in such a way that the transference ratio of the transmission unit, in particular the speed transference of this non-linearity, causes the actuator to move quicker, in particular more than half as fast as the maximum speed in the lining stroke range adjoining the air gap, in particular more than half the distance for overcoming the air gap, and the actuator is moved quicker, in particular more than twice as fast as the maximum speed in the lining stroke range adjoining the air gap, so that the air gap is overcome faster in comparison with normal operation. In the context of the present invention, normal operation can therefore be understood to mean conventional operation of the electromechanical brake, such as that which occurs in particular to achieve normal braking.

If applicable, it is provided that the non-linearity for determining the contact point of the friction surface and the brake lining is or will be designed in such a way that the contact point of the brake lining and the friction surface is detected, in particular from the performance consumption for the energy, current and/or power of the actuator and/or from the course of the actuator load, in particular the torque.

If applicable, it will therefore be inspected whether an adjustment of the brake, in particular an adjustment of the brake lining and/or an adjustment of the air gap, is necessary in that, if applicable, by the transference for the transmission unit for this non-linearity, in particular in the possible area of the contact point of the brake lining and the friction surface, an evaluable combination of transference ratio and actuator torque, in particular an interpretable progression from the energy, current and/or power consumption of the actuator, the actuator load and/or the actuator torque, is generated over the actuation, in particular taking into account the respective transference ratio, so that, if appropriate, a significant difference from the behavior in the air gap is obtained as a result from the contact between the friction surface and the brake lining.

If applicable, it is provided that the non-linearity for achieving a minimum braking effect is or will be designed in such a way that a certain required minimum braking effect, in particular in the case of emergency braking, is achieved within a minimum effective time, the minimum effective time being only at most 20% above the time which, in particular for achieving the minimum braking effect, is or will be technically possible with the electromechanical brake.

If applicable, it is provided that the non-linearity for generating an increasing braking torque, whereby the braking torque is adapted to the braking dynamics if applicable, is or is designed in such a way that the speed of the braking torque build-up is adapted to the dynamic weight shift of the vehicle which is thereby caused, so that a locking of the wheels of the vehicle is counteracted if applicable.

If applicable, it is provided that the non-linearity for operation with reduced electrical power requirement is or is designed in such a way that at least 20% less power is consumed by the actuator during operation of the transmission unit at low speeds and/or when the actuator is at a standstill, when compared with the same or a similar operation and/or operating point, in particular for operation at low speeds and/or with the actuator at a standstill, in comparison with a non-linearity which is designed in particular according to the criteria of the maximum achievable motor output power, so that the power consumption of the actuator is reduced, in particular in the case of longer continuous braking.

If applicable, it is provided that the transference for the transmission unit is selected and/or designed in such a way that, starting from the initial position, in particular the zero position, of the transmission unit along the movement of the actuator, in particular of the, preferably functional and/or brake-effect-relevant, lining stroke, in the initial direction, that the non-linearity for operation with reduced electrical power requirement is arranged in such a way that, in operating statuses which have a long holding period and/or a high temperature load, low consumption of electrical energy and/or low heat loss of the actuator will therefore result.

If applicable, it is provided that the non-linearity for compensation of brake fade is or will be designed in such a way that the actuator is operated at a motor torque which, under the same operating conditions, in particular the operating temperature, is higher, in particular higher than the maximum permissible motor torque and/or higher than the maximum permissible shaft power, than that with a non-linearity which is designed according to the criteria of the maximum achievable motor output power, so that a braking effect is also achieved in the event of brake fade.

If applicable, it is provided that at least one non-linearity, in particular over the lining stroke for the compensation of air gap errors, is or will be designed in such a way that an air gap error, in particular a deviation of the size of the air gap from the assumed dimension, is compensated for whereby the air gap error preferably results from wear.

If applicable, it is provided that, if applicable, the brake is operated up to a certain deviation of the magnitude of the air gap error, in particular by adjusting the movement of the actuator, preferably without wear adjustment and/or without actuation of a wear adjustment device.

If applicable, it is provided that the non-linearity for wear adjustment and/or the actuation of a wear adjustment device is or will be designed in such a way that the actuator, in particular starting from the zero position of the transmission unit, is moved against the direction of movement or direction of rotation which is utilized for braking, in particular in the second direction.

If applicable, it is provided that the wear adjustment device is actuated by this movement of the actuator, in particular without braking effect.

If applicable, it is provided that the non-linearity for the wear adjustment is or will be designed in such a way that the actuator is moved in the direction of a braking, in particular in the initial direction, that the wear adjustment device is actuated by this movement of the actuator, in that, if applicable, after a maximum position of the actuator required for the braking, in particular for the parking braking, has been reached, then the wear adjustment device is actuated by an additional movement of the actuator.

in particular as lining stroke free, the wear adjustment device is actuated or this actuation is prepared.

If applicable, it is provided that the brake comprises a wear adjustment device which is actuated, in particular exclusively, by the actuator.

If applicable, it is provided that at least one actuator position of the actuator is retained with a lowered, in particular very low, electrical power requirement or as current free by a corresponding design of at least one non-linearity and, if applicable, by the interaction of this at least one non-linearity with a spring, in particular a spring action.

The semantic sequences thereby provided do not necessarily correspond to chronological sequences.

The procedure steps can be implemented once, never or also several times during the operation of a machine, in particular a conveying device, transporting device, a vehicle or an elevator.

In all embodiments, it is preferably provided that the procedure according to the invention is automated, in particular controlled and/or regulated by a control unit or control system from the vehicle.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective cut-away view of an electromechanical brake according to embodiments of the present invention:

FIGS. 2A-2C illustrate exemplary components of the electromechanical brake according to embodiments of the present invention:

FIGS. 3A-3D illustrate various configurations of a multi-disc brake according to embodiments of the present invention:

FIG. 4 illustrates exemplary components of the electromechanical brake according to embodiments of the present invention:

FIGS. 5A-5D illustrate various configurations of a sprint-actuated non-linear electromechanical brake according to embodiments of the present invention:

FIGS. 6A-6F illustrate various configurations of a floating-calliper disc brake according to embodiments of the present invention:

FIGS. 7A-7C illustrate various configurations of unwinding bodies according to embodiments of the present invention:

FIGS. 8A-8B illustrate exemplary electromechanical brakes according to embodiments of the present invention:

FIG. 9 illustrates exemplary components of the electromechanical brake according to embodiments of the present invention:

FIGS. 10A-10B illustrate exemplary components of the electromechanical brake according to embodiments of the present invention:

FIG. 11 illustrates the operation of various components of the electromechanical brake according to embodiments of the present invention:

FIG. 12 illustrates the operation of various components of the electromechanical brake according to embodiments of the present invention:

FIG. 13 illustrates the operation of various components of the electromechanical brake according to embodiments of the present invention:

FIGS. 14A-14D illustrate the operation of various components of the electromechanical brake according to embodiments of the present invention:

FIG. 15 illustrates exemplary components of the electromechanical brake according to embodiments of the present invention:

FIG. 16 illustrates exemplary components of the electromechanical brake according to embodiments of the present invention:

FIG. 17 illustrates an exemplary effect of the brake actuator torque according to embodiments of the present invention:

FIG. 18 illustrates an exemplary effect of the lining conditions according to embodiments of the present invention:

FIG. 19 illustrates an exemplary assembly for an electromechanical brake according to embodiments of the present invention:

FIG. 20 illustrates exemplary components of the electromechanical brake according to embodiments of the present invention:

FIGS. 21A-21B illustrate exemplary components of the electromechanical brake according to embodiments of the present invention:

FIG. 22 illustrates exemplary components of the electromechanical brake according to embodiments of the present invention:

FIGS. 23A-23B illustrate exemplary components of the electromechanical brake according to embodiments of the present invention;

FIG. 24 illustrates exemplary components of the electromechanical brake according to embodiments of the present invention:

FIG. 25 illustrates the operation of various components of the brake device according to embodiments of the present invention;

FIG. 26 illustrates the operation of various components of the electromechanical brake according to embodiments of the present invention; and

FIG. 27 illustrates an aircraft landing gear for use with an electromechanical brake according to embodiments of the present invention.

### DETAILED DESCRIPTION OF EXAMPLE EMBODIMENTS

Embodiments from the inventor are subsequently entered, which are intended to provide a better understanding of the invention. The features which are described in the following can be, but must not be, features of the electromechanical brake and/or method according to the invention. The electromechanical brake according to the invention and/or the method according to the invention can comprise and/or indicate the features which are listed individually or combined i.e., in any combination.

In the case of electrically actuated brakes, it would be physically correct to run the actuator motor at the speed for the highest output power at the fastest possible operation, which is also already known, but not very precisely described.

In this case, a fundamentally different approach is taken here by considering as many relevant conditions, statuses and tasks as possible which could arise during the actuation of an electromechanical brake. These cases will be solved favorably, which of course does not exclude that the actuator can run at the highest power even at the fastest actuation in some positions. The cases discussed here can also be at zero (or near zero) brake actuator output power, for example, when an actuator position or position range is to be retained for a longer time for longer braking. Another important task of a non-linear electromechanical brake (EMB) as executed here can be e.g., the correct wear adjustment, which should be actuated e.g., advantageously also from the electric brake actuator. Whereas it is known to derive a wear adjustment from the brake actuation, in this case however, if applicable, the special feature of non-linearity and operation in a favorable range of non-linearity is however taken into account, as well as the special possibilities and demands for the electric brake actuation.

Proposed here is a non-linear electromechanical friction brake, whose motion sequence is or is specifically adapted with respect to various specifications. “Electromechanical” hereby means that a circumferentially limited movement of a mechanical actuator has a direct, predictable relationship to the movement of the brake lining. The actuator can be operated by means of electrical energy, either directly (electric motor, electromagnet etc.) or indirectly, e.g. by storing energy in springs.

“Non-linear” means varying, various or different transference ratios in the actuation process via the actuator movement. This includes involved components such as electric actuators, brake linings, brake pads, springs, transferences for all mechanical or other types, transmission units, connecting elements such as couplings, clutches or slipping clutches and/or a wear adjustment to compensate for the wear of brake linings.

Solutions for non-linear translations are commonly known in a variety of options.

In contrast to optimizing the performance of the electric actuator, the preferred aim of the present invention is to design the course of transference ratios for specific brake applications in such a way that, in each actuator position, ratios are created which are advantageous for the operation of the brake in terms of the force and speed acting on the components involved, in accordance with the tasks to be fulfilled in the respective range. In many areas, this can not necessarily correspond to the maximum power of the electric actuator.

In addition, practical considerations, such as e.g. efficient manufacturing or production technologies or techniques, can also influence the design. If, for example, a brake needs lining contact forces of 0 to 30 kN (for e.g. roughly a passenger car front wheel lock), then one has to initially apply the brake at almost infinite speed (with low force) and against full braking at a low speed. Such a freely configurable variation of the transference is practically impossible with most known mechanical arrangements. For example, a ramp (cam) could theoretically switch over from vertical start (infinite speed) to horizontal end (infinite force), although it also has mechanical constraints, such as loading capacity of surface and line pressures and permitted radii of curves, and it could be assigned theoretical courses which do not exist in reality, such as “loops” in surface areas.

Subsequently, a large number of operating ranges and/or movement ranges, which are to be optimized, will be illustrated, in particular with deliberately strong deviations from an optimum operating point with regard to actuator performance. In addition, a different definition of “total actuation stroke” is utilized because the total possible actuator operation can include areas which are not directly utilized for brake actuation. Even in these special regions for actuator movement, highly “inefficient” operating statuses can be advantageous.

This EMB will advantageously utilize one or, e.g, for safety reasons, two actuator motors for brake actuation. In this case, the actuator which is normally utilized for service braking can fulfill the demands for automatically switching to the released status or braked status in the de-energized status (depending on the requirement) and the second actuator can remain de-energized in its final status (e.g., by utilizing a worm gear) and serve mainly as a parking brake, which remains de-energized in its final status and only performs service braking in exceptional cases. Also, in the electric actuator motor itself, an alteration can preferably be acquired during actuation, such as a voltage alteration, switching for e.g., windings, field monitoring or increase etc. In the case of electromagnetic actuation, of course, the force of the electromagnet can also vary along the actuation path.

Usually, the non-linear EMB requires a wear adjuster and/or a wear adjusting device in order to operate the non-linearity in a favorable range. Without a wear adjuster, operation is only possible when either the alterations are small enough to still be able to utilize the non-linearity meaningfully or when the range of non-linearity which is to be utilized can be tracked (with extended operating time). In this case, the wear adjuster will usually also have a behavior which can generally be described as non-linear, because it can, for example, only be designed in the direction of “more readjustment” or will only implement an adjustment process until a certain target is reached e.g., a certain lining press-on force or a certain readjustment movement.

Terms such as “and”, “or”, “and/or” are intended to be fundamentally non-exclusive. Features can in principle also be multiple e.g., several springs instead of one named or several brake actuators instead of one named actuator. Arrangement representations are one representation of several possibilities: if, for example, compression springs are shown, then this could also be implemented with tension springs or combinations, or other pushing forces or pulling forces. Modifications with the same or better effect are also hereby possible e.g. when a spring is truncated somewhere else than represented.

In the present case, “non-linear” is understood to mean any behavior which is not based on a constant transference ratio, such as e.g. a common transmission unit. This non-linear behavior can be defined very differently.

### EXAMPLES

Curve between input force and output force over the actuation path

Limitation to only one direction of movement

Limitation to a certain torque or a certain force

Allowing movement of one part when another is standing still.

In the case of straight movements (as in the case of brake linings), it therefore makes sense to speak of force and displacement (or stroke) in connection with transference ratios. For rotating parts (such as contact cams or actuator motors), we therefore talk about torque and angle. One position can be thought of as an angle or linear measure. In the following, the expressions are utilized equivalently i.e., “high force” can also mean e.g. a high actuator torque. The terms “control” and “regulating” are also utilized equivalently, except that the difference is explicitly pointed out. Since both rotary and linear movements can occur in EMBs, then force and torque and/or displacement and angle are usually utilized in the same sense i.e., not both versions are mentioned, although both usually occur, such as angle of the actuator shaft or stroke of the lining.

A “stationary part” is fixed (or stationary) with respect to the central axis of the movement which is to be braked e.g., with respect to the non-rotating part of the wheel bearing.

A “centered position” 1 refers to a (e.g., central) position with respect to the friction surfaces i.e. e.g. centered with respect to the two brake disc surface areas or at the same distance from them, in the case of e.g. drum brakes or multi-disc brakes. The friction surfaces are those which are mostly rotating or moving and mostly without a lining and the lining surface areas are pressed against these friction surfaces.

“Contact pressure” refers to the force which is utilized to apply press-on force to the lining. It reaches e.g. maximum 40 kN for passenger car front wheel disc brakes and maximum 240 kN for truck disc brakes. Average contact forces or press-on forces for everyday driving styles are e.g. ¼ to ⅓ of the maximum. The term “usual” is hereby understood to mean the force that one always applies when braking intentionally i.e., the force which can almost always be expected when braking intentionally. This corresponds, for example, to the force required for a distortion of g/10. The press-on force can be utilized by several friction pairs e.g. two for automotive disc brakes or more for e.g., multi-disc (slats) brakes.

The term “applying” the brake is understood to be an operation (from no braking effect, where there is advantageously an air gap) in order to increase the braking effect, while “releasing” is understood to be an operation to reduce the braking effect up to no braking effect and up to the lifting of the linings to thereby achieve the air gap. The braking effect can be viewed e.g., as braking torque, braking force or as vehicle delaying process, physically best as braking torque.

“Holding” and/or “holding range” is understood to be a set braking method (e.g., braking torque, actuator position) which is retained and/or held in the necessary range.

In this case, “brake actuator” is understood to be an electric brake actuating drive unit e.g., electric motor (preferably BLDC, but also others such as DC or asynchronous motors) or e.g., an electromagnet, but also others electric such as e.g., Piezo. The brake actuator generates at least one lining press-on force. The brake actuator acts, for example, via linear and non-linear transference members such as e.g. toothed gears, cams, ramps, rods, cables, chains, pressure (in solids, fluids, gases). Other actuators in an EMB, which perform other functions only or meaningfully, are referred to differently here, although a brake actuator can also perform other functions such as implemented adjustments for wear.

There can be several brake actuators present e.g. to achieve higher press-on force, higher actuation speed or fail-safety.

There can also be at least one spring action involved, including via additional non-linearities with respect to the spring action. The spring effect can originate from springs or other forms of stored energy. At least one spring can be either actuating or slack, completely effective or supporting, or can alter the direction of these two supports. The minimum of one spring can therefore, for example, assist in executing to lift off at least one brake lining or it can implement the actuation of the brake e.g. in the case of a parking brake or if, for example, the brake “automatically” should transfer over into the actuated status for safety reasons, such as in the case of railroad brakes. The interaction of any number of preferred springs and actuators and lining press-on forces simply results from the summation of all these forces or torques with the correct total, whereby a sensible procedure can be to relate them all to a same condition for their respective non-linearity e.g. to relate and/or convert all non-linearities into one uniform actuation measure or dimension i.e, for example the actuator angle or the lining stroke. One can utilize this spring action, for example, to support the brake actuator (“energy swing”) or, for example, to select the non-linearities of a spring-actuated parking brake in such a way that the spring strives for a sensible full braking effect and, if there is too much air gap present, then it still has an actuation reserve and, if applicable, acts on a wear adjustment and that, in the “fully released” status, the “released holding torque” on the actuator becomes so small that spring actuation is safely possible.

It is also possible, for example, for one brake actuator to set or release a spring-applied parking brake position and for another one to execute the service braking when the parking brake position is released. The two could also complement each other in such a way that, in the event of failure of this service braking function, the parking braking function thereby executes an orderly and/or regulated substitute service braking.

A “force distribution or torque distribution” (here mostly utilized and to be understood as equivalent) can cause at least two actions from one actuator action (i.e. mainly the brake actuator). For example, the brake actuator can initially execute a wear adjuster movement at the start of actuation and then subsequently execute the actual lining pressure instead of the wear adjustment during additional, ongoing actuation. For this purpose, for example, a planetary gear can initially rotate at least one load-free, smoothly-moving wear adjuster screw and, when the screw load (lining press-on force) takes effect, switch over to an output for actual lining press-on pressure. This distribution can be influenced by springs, pre-loaded forces, slipping clutches or couplings, play and tolerances etc. but also by switching functions such as electromagnets or directional dependencies.

An “air gap” (or total air gap, which consists of the total of all partial air gaps per friction pairing) is hereby utilized in an EMB in order to operate the brake without residual braking torque, or also to prevent dragging or clamping linings, which would cause overheating or more braking torque and more heat due to resulting thermal expansion. Accordingly, a brake actuation movement or brake actuator movement occurs in the air gap (or one without significant build-up of press-on force) and a subsequent one with build-up of press-on force. The wear adjustment therefore affects the air gap and/or retains it within the prescribed range.

The “contact point” can be defined as the point at which the air gap is overcome and the initial lining press-on pressure, and therefore the initial braking torque, is generated. In reality, this will be a point or area where there is already light lining pressure or light braking torque present.

A “spring or spring action” can consist of any preferred spring action and/or elastic device (tension spring or compression springs or other known spring construction shapes, pneumatic springs etc.). However, a spring is also referred to here as a collective term for all possibilities for storing mechanical energy and releasing mechanical energy which can be sensibly applied here i.e., also as e.g., magnetic force or “gas spring”. A spring can therefore be replaced in this instance e.g., also by a magnet with repelling force or attractive force or by a rubber part or elastomer part.

The term “wear adjuster” and/or wear adjustment device means, in particular, a device which maintains the non-linearity within the planned range of movement despite lining wear of e.g., 30 mm and other wear (e.g., brake disc up to e.g., 2 mm). It can preferably be at least one screw, for example, but it can also be the brake actuator itself which therefore compensates for part or even all of the wear when its non-linearity has been designed to permit this. The wear adjuster can also be a pressure transmission process e.g., a fluid pressure transmitting cup plunger, which e.g., via a slot, releases a fluid supply for the required wear adjustment or enables fluid removal in case of thermal expansion. The wear adjuster can therefore preferably be operated by the brake actuator, but can also be operated differently e.g., manually or not at all (which is advantageous, for example, in the case of low expected wear or possible wear). In practice, there can also be mixed variants provided if applicable, such as e.g., that a wear adjustment was necessary but has not yet been implemented, or that the wear adjustment was implemented with tolerance involved i.e., “incorrectly”. Such mixed variants can take into account, for example, the not yet implemented tolerance part or, for example, the tolerance part in an insertion of a displacement of the linear movement of the brake actuator on the brake lining. The wear adjustment can usually only act in one direction, assuming that wear can only increase, and the wear adjustment can be linked into a wear model so that only a readjustment, which is deemed useful or necessary by the model, will be implemented. Wear adjustments can preferably be divided into two procedures: Readjustment before building up normal press-on pressure and readjustment after executing an actuation movement.

The desired braking effect is produced by pressing the brake linings against the friction surfaces with sufficient force.

In the case of an EMB, generating the primary force is executed by utilizing an electric actuator e.g., the torque of a motor.

In addition, one or more springs can be effective in operation. An EMB can, for example, be designed as a spring-actuated parking brake or service brake which is released by the electric actuator in a controlled manner against the spring force. Or a spring can act only as a support process in order to relieve the actuator. The direction of the spring action can also alter and, for example, support the release of the brake at low actuation and relieve the actuator at higher actuation i.e., provide actuating assistance. A spring acts as an energy store. However, energy can also be stored in other ways (e.g., as pressure), so one should generally speak of “stored energy” (instead of spring).

Self-amplification or self-monitoring can also develop in the brake due to entrainment effects between friction surfaces and brake linings.

When the speed of movement alters, irrespective of whether as linear or rotary, then mass inertia forces act.

In particular, there are therefore up to five types of effective forces: Press-on force, actuator force, force created from an energy accumulator such as a spring, the self-amplifying force (strengthening or weakening) and, in some cases, the force from the mass inertia itself.

The function of an EMB thereby results from the relationship between the actuator position and/or brake lining position and the resulting press-on force. In order to determine the current conditions, it would be advantageous when one recorded a lining press-on force path diagram, but in the case of an EMB without a force sensor, only the actuator current can be measured. However, this can be converted very well into an actuator torque, when one advantageously calculates out the mass inertia effects during acceleration and takes into account other values such as motor rpm and temperature and possibly stores these exact conversion influences for each brake.

The aforementioned process can also be utilized in order to control during the actuation process whether it occurs as expected or is displaced and/or shifted or warped. Shifts can occur in particular when the air gap does not correspond to the expectations (usually due to wear of the brake linings), distortions can result e.g. from unconsidered friction losses.

The actual curve is advantageously a force-path diagram and/or actuator torque-angle diagram, whereby the actuator torque is to be determined from the actuator current. Assuming that with known non-linearity a known course of the actuator torque actually had to be observable, one can conclude on the one hand whether the actual course is shifted by a linear distance (which corresponded to a necessary wear adjustment) or whether the actual course had to be multiplied by a factor in order to correspond to the expected one, which therefore means that the mechanical losses are higher or lower than expected. A combination of the two effects is also possible.

Preferably, the clamping force which is calculated from the actuator torque and the linear lining travel can be utilized because, in these, a displacement due to wear is most plausibly recognizable. Therefore, by means of the actual process values, it is possible for one to distinguish whether a wear readjustment is necessary due to displacement or how high the mechanical losses really are at the moment due to a necessary multiplication. In principle, this can be implemented by utilizing statistical methods, with which one can identify various influencing factors, which one wants to recognize as causal for certain deviations of measured values and all these methods are proposed here.

If it is concluded from the actual course, in comparison to the assumed one, that the touch point is located at a different place than the one which was expected, then the necessity of a wear readjustment can be deduced from this and this can also be executed. During the execution, there are, for example, the possibilities that the necessary adjustment (i) can be set exactly (if enough resolution is possible), that one can only execute it (ii) inexactly (in the case of poor resolution, e.g., when only one tooth can be advanced), that it (iii) can only be more or less executed by a mechanic within the accuracy tolerances or (iv) that one cannot execute it all because one can only readjust the brake e.g. in the “released status” or only in certain statuses or movements such as e.g. overcoming the air gap or braking of a certain strength.

One can therefore compare the set point target value of the readjustment and the actual value of the readjustment and utilize any difference resulting from them in order to operate the brake's control model for error compensation in a status which is shifted by this value.

According to this procedure, there are in particular therefore two wear readjustments: one which actually brings the linings closer together and one which is covered by the brake actuator. The former can usually only be actuated under no clamping force or low clamping force and usually has a coarser resolution than the actual brake actuation. The part of the readjustment which deviates from the requirement (e.g. because too much or too little readjustment has been made due to the resolution or because, for example, adjustment cannot be made during the applied brake) is preferably adjusted with the brake actuator by correcting its linear stroke by the deviation. The relationship between the two types of wear can alter with each brake application.

The mechanical losses must also be considered in order to increase the accuracy of the determination for the required wear adjustment. On the one hand, this can be executed on the basis of theoretical values, although losses can also be estimated by comparing the actuator torque at actuation with that at loosening (in relation to the actuation position) and, from this estimating, the loss-freed value which can for example be positioned in the middle.

One can also consider the frictional heat development on the brake in order to increase the accuracy of the determination for the necessary wear readjustment: with a temperature model, it is possible, for example, for one to predict which temperature will develop at a certain point on the brake due to the frictional heat of braking and compare it with the actual temperature (e.g. at the lining carrier, at the wear adjuster, at the actuator). The wear readjustments can then be executed in such a way that the actual temperatures and set target value temperatures are matched or that the actual temperatures of the brakes (e.g. left and right) are matched by wear readjustment.

It is also advantageous, for example, to implement a wear model for the linings which, for example, would estimate the wear from clamping force, braking torque, speed, temperature etc., e.g. in the case of an aircraft landing, and one which only permits wear readjustments which are classified as realistic by this model.

The wear adjuster preferably comprises a position-stable element which retains its setting position without action, e.g. from a screw which can also advantageously have enough friction or be provided with enough friction so that it does not automatically alter the setting position. It can be equipped, for example, with a ratchet, which therefore permits only direction of rotation in the direction of former lining press-on force. If applicable, it can be provided with a ratchet (or even additional ratchets) which, when the actuator moves in the opposite direction to the readjustment, permit this opposite movement. There can be several adjusters located in one EMB, e.g. two, i.e. e.g. one for each lining, which can also be different in order to e.g. compensate for different braking effects of the linings, or one common adjuster per EMB. The readjustment can be provided with defined movement restrictions, such as end stops or play, which causes readjustment only after a certain degree of actuation. The adjustment can include force measuring parts or torque measuring parts such as e.g. a slip coupling which only permits a certain readjustment torque. The torque measuring part can also be, for example, the actuator for the readjustment, in which, for example, the torque is determined via the current and therefore the readjustment is controlled or regulated.

Internal shoe brakes almost always have springs installed between the shoes or the shoes and one “fixed” part. These are also utilized in the objective non-linear actuation and can advantageously also be utilized in order to calibrate the actuator current or actuator torque, because they exert a defined force before the loads are applied. On the one hand, in order to keep the jaws stable even in the non-braked status, and on the other hand, of course, to cause the linings to lift off in the non-braked status. Such tension springs or compression springs can of course also be utilized with all other brake designs, whereby one must create a “fixed part” artificially because, for example, with floating-calliper disc brakes, the position of the outboard lining, which is e.g. Located on the floating calliper, and the inboard lining shift against each other due to wear, and the floating calliper would therefore not be “fixed” against the disc position. In order to create a “fixed” position with respect to the disc, for example, a spring-loaded pin (or several, e.g. on two sides) can be “dragged along” i.e. the end position of the brake lining can be defined by the clamping force during braking in a defined position with respect to the lining surface and the disc and, in this respect, the end position of the brake lining can be defined in a similar way to that for internal shoe brakes, e.g. analogous to the end stops of the spring brake lining on which drum brake linings come to rest when they are completely loose. This “fixed” position can of course be generated with all conceivable brake designs which have been described here.

Spring-applied brakes (“normally closed”) must be held open most of the time by the electric actuator against the spring force. The requirement is therefore that this can be executed with as little actuator power as possible i.e. the non-linearity for spring and actuator in the “loosened” status requires as little force as possible on the actuator. For example, a switching inverter (e.g. voltage inverter) was therefore utilized in order to keep the actuator “loosened” with the lowest possible input current (into the inverter). When the power was switched off, the EMB went into the “actuated” status, and the movement sequence can be influenced by additional measures such as braking resistors, electrical control or mechanical influences. Minimum “loosened” holding current would be almost the opposite of the otherwise proposed dimensioning of the non-linearity to constant motor torque. Therefore a reversal of the spring action can be realized in such a way, that with “fully loosened”, the non-linearity (e.g. of the spring) acts in the “loosened” direction and therefore the actuator had to initiate an actuation process, which was then executed as described above.

In the “actuated” status, the non-linearities can be designed in such a way that, even with the most unfavorable tolerances and incorrect adjustments, the actuator can perform the slacking safely. Optimization in terms of engine performance does not play a significant role here either.

Particularly advantageously, the non-linearities can also be designed in such a way that actuation by the actuator is possible without a brake drum or brake disc (e.g. during the assembly process).

The envelope of a spring action, which has been described above, is an example of how a stable position which is retained without actuator power can be achieved. Additional magnets or electromagnets can also retain positions, also in combination with advantageously designed non-linearity in the holding area. Several stable positions can also be provided, e.g. by recesses or flat spots in actuation cams.

Such stable positions make it possible to also utilize a service brake as a parking brake. For example, in a fundamentally self-opening EMB, a flat spot or depression on a cam could create a local stable position. The cam or other non-linearity can also have two usable actuation directions-one for service braking and one for parking braking.

Favorable shaping of the non-linearity will therefore improve the possibility of identifying special points in the actuation process on the basis of a characteristic course of the actuator torque (e.g. start position with contact point). Such identification can also be executed in combination with another position detection (“sensor”), e.g. to fulfill safety requirements.

The non-linearity, in particular the non-linearity for measuring and/or setting parameters, can also be designed in such a way that a usable high torque occurs at the actuator in the actuation status at which braking starts, in order to be able to detect this touch point as well as possible. Advantageously, a certain course of the non-linearity can also be selected, such as lower actuator load in the start phase in order to overcome the mass inertia, followed by higher actuator load in order to detect the lining contact.

A degree of freedom e.g. a spring, can be built into the actuation movement (caused by actuator or spring), which therefore enables an input actuation movement even when the output actuation movement is hindered due to lack of self-strengthening. For example, an actuation spring or the actuator can attempt to actuate the EMB at standstill i.e., without self-amplification, but might not have enough force to be able to execute the actuation motion in the absence of self-amplification. A spring can, for example, strive for this actuating movement on the drive unit side (e.g. on the actuator side), but can only perform this movement on the output side when the required force is reduced by self-amplification. This enables, for example, a considerably self-amplifying EMB to be “preloaded” into a ready-to-brake status at standstill, with strong braking subsequently being triggered by self-amplification in the event of a small incipient movement. As above, the non-linearity of the loosening can be such that the loosening process is possible even under these circumstances.

In the case of self-strengthening EMBs, in particular highly self-strengthening EMBs, the self-strengthening can alter not only due to alterations in the coefficient of friction, but also due to other alterations e.g. in the instantaneously effective geometry. In the case of internal shoe brakes, for example, if actuation is executed at the top and wear adjustment at the bottom, then the resulting force can alter the point of application and therefore also the self-strengthening component. On the one hand, this can be taken into account in the non-linearity and, on the other hand, in the calculation of the braking torque, when the press-on force and braking torque are inferred from the actuator torque, or vice versa, when the actuator torque is determined for a target braking torque. Likewise, it is preferable to design the geometry in such a way that no unintentional seizure of the EMB will occur due to excessive self-strengthening. For example, actuators can have the “automotive” temperature range up to 125° C., they utilize enamel-insulated copper wire which e.g. is specified up to 200° C. and magnetic material suitable up to 180° C., for example. This means that one can only operate the actuators at a lower power at high (also permissible) temperature than at low temperature.

When an actuator has to apply force for a long time in order to hold the position (or a position range), then it will heat itself up. When there is a long braking (e.g. downhill travel, landing of an aircraft etc.) then the heating up which is caused by this will also reach through to the actuator. In areas where prolonged self-heating and/or brake heating occurs on the actuator and if the actuator force is lowered by suitable non-linearity, in particular non-linearity with lowered electrical power requirements, then one can utilize smaller dimensioned or more cost-effective actuators in such cases.

Long downhill trips on mountain pass roads, for example, only require several hundred Nm of braking torque for passenger cars (for comparison: front wheel full braking torque approx. 3000 Nm). It is therefore possible to reduce the torque required at the actuator to hold braking in this range by designing the non-linearity(ies), although still permit a higher torque at the actuator in other ranges to enable a fast brake application process overall.

For aircraft landings, the most significant heat generation will occur during short, heavy braking (e.g., take-off abort). If, for example, an actuator temperature of 150° C. is permitted and a brake temperature of 100° C. is assumed at the actuator location during long braking, then 50° C. is now available for heat dissipation.

When the brake only receives 50° C. on the actuator location during short braking, then 100° C. is still available for heat dissipation. Accordingly, the holding torque, and thereby the holding current which thermally loads the motor, should be half as large for long braking in this example as for short, strong braking.

This is the opposite for dimensioning the non-linearity for constant motor torque.

If the brake is strongly heated, then the coefficient of friction of the lining can decrease, which requires higher press-on force. This can make it necessary to greatly increase the press-on force, especially with brakes which are strongly self-energizing. It is therefore advantageous to design the non-linearity so that this press-on force is possible and/or to design it in such a way that this is possible with a smaller and less expensive actuator, or so that this press-on force is achievable with the spring.

In the case of this fading compensation, it is advantageous to design the non-linearity, preferably the non-linearity for brake fading compensation, especially for self-energizing or highly self-energizing brakes, in such a way that as the coefficient of friction decreases (which usually occurs earlier), higher actuator positions must be achievable for higher press-on force, thermal expansion should also be advantageously planned for i.e. disc expansion with a lower emergency actuator position or drum expansion with a higher emergency actuator position and then, during longer braking periods, the heat arrives at the actuator installation position and lower actuator torque is utilized here.

With this design of non-linearity, utilizing self-strengthening and strongly self-strengthening brakes can become meaningful in the first place.

In the case of drum brakes, the diameter increases as the drum heats up, while in the case of disc brakes, the brake discs expand and the calliper warps due to slower heating. These effects can be utilized or designed in such a way that, in the case of prolonged heating which affects the actuator installation position, the actuator torque sinks or decreases with a delay when the brakes heat up (when e.g., in the case of disc brakes, the calliper elongation is added to the disc elongation with a delay).

Non-linearities, in particular the non-linearities for wear readjustment, can be designed in such a way that in the case of the wear which is to be adjusted, a wear readjustment is affected. This can be executed during the normal actuation procedure. For example, if the air gap is too large, then more movement will be required than with correct wear readjustment, and this additional movement can be utilized in order to actuate a wear adjuster e.g. a tooth on a toothed pulley can be turned further and therefore a readjustment screw can be turned, whereby turning back can be prevented.

However, a correction of the current air gap can also be executed independently of the normal brake actuation by its own motion sequences and/or by using special regions of the actuator operation and/or non-linearity.

In a particularly advantageous embodiment of the wear readjustment, a suitable non-linearity, in particular the non-linearity for overcoming an air gap between the brake lining and friction surface, in particular friction lining, initiates a rapid lining movement in the air gap, in that, for example, a rapid movement (e.g. of an end stop on the actuating cam) acquires the overcoming process for the air gap and/or advantageously only takes it over when a predetermined clearance or a predetermined movement is overcome which corresponds, for example, to the desired air gap (i.e. the lining reaches the contact point at this movement value only when, for example, the air gap is set exactly correctly). From the moment of contact, a considerably measurable contact torque is generated, which can be measured, e.g., with the actuator, and/or is specified, e.g. limited, by a mechanical device.

When the movement in the air gap is advantageously fast, then the torque determination becomes more accurate than would be possible with normal lining press-on force. Now the actually determined touch point is compared with the expected one and the desired readjustment is therefore triggered, which can be triggered e.g., by an additional movement.

Advantageously, at least one spring can also be involved and there can also be an area without spring action. When this special movement is triggered, then one can first measure the torque which is necessary for the instantaneous loss overcoming, then the known spring torque in addition, then the touch point and finally the actuation of the wear readjustment. By detecting the instantaneous losses calibration with a known spring and the rapid translation, a particularly accurate wear readjustment is therefore possible.

These movements can be executed, for example, during normal passage through the air gap during normal brake application or over rotational areas which are not otherwise utilized for brake application. These actions can also be separated, e.g. the determination of the touch point during normal brake application and the readjustment after braking in an otherwise unused direction of rotation. The readjustment can also be quantized, i.e. in defined steps or more or less step-free by a certain extent of movement. This adjustment can in principle go in both directions, but will often only go in the direction which brings the lining closer to the friction surface. The readjustment can work advantageously with exceptions or rules and, for example, not adjust temperature-related fluctuations for the touch point.

The “touch point” unfortunately does not exist in practice in this clarity, it is mostly a more or less soft transition where feed movement needs increasing feed force and one will therefore advantageously use suitable detections for increasing feed force such as e.g. a threshold value or several points on the curve and, if applicable, utilize corrections such as a temperature or the instantaneous friction which has been estimated above, which can also be estimated even better when one executes the wear readjustment in two directions.

It is particularly advantageous to bring the brake into as well-defined a condition as possible beforehand: For example, a floating calliper can be located “anywhere”, i.e. as unknown for how the total air gaps are distributed on the lining.

Therefore, it is advantageous to initially trigger a clearing procedure which, for example, creates a lining or designs the lining, in order to improve the accuracy of the aforementioned procedures.

Here, the non-linearity, in particular the non-linearity to the wear readjustment, preferably acts along the path from actuator to lining press-on force and that of any springs together with the wear readjustment. It is suggested here that the wear readjustment be derived from the one actuator which is necessary for brake actuation, the second actuator (when present), from both (when, for example, both are in the position intended for this purpose), or even an additional readjustment actuator, which, however, incurs additional costs for its transmission unit, connector and control. For example, the brake actuator can be actuated for wear readjustment in a direction which is not normally utilized for normal braking and, for example, does not cause any stroke for the brake linings or, for example, only a certain one e.g., only up to the touch point. This wear readjustment can also be only made possible, for example, when both actuators are brought into a certain position, so that each actuator can individually utilize this position in order to calibrate its position measurement, for example, to utilize this position as an end stop. In the wear readjustment, for example, there can be a limiting function present, such as a slipping clutch, which prevents excessive wear readjustment, or a deliberate play or tolerance, so that the wear readjustment preferably starts only after the play or tolerance has been overcome. Friction ratchets or positive ratchets can limit wear readjustment to the direction of “bringing the lining closer to the friction surface” and intentional friction or any other complication of movement can prevent unintentional readjustment (e.g. due to vibration).

The non-linearity of the adjustment, in particular the non-linearity to the wear readjustment, can also interact with the non-linearity of the actuation: for example, it can be ensured that although the wear readjustment in extreme cases sets the air gap (with the brake released) between the lining and the friction surface to “no more air gap” and could even introduce a certain tolerable permanent pressure, the non-linearity in the actuation would still permit brake actuation in this condition.

Another non-linearity can advantageously be utilized at the end of the loosening movement in order to lift not only the outboard liner but also the inboard liner off the disc.

Drum brakes are almost always equipped with tension springs which pull the brake shoes back, on the one hand to lift them off the drum again after braking, but also in order to hold or guide the shoes together or to compress the hydraulic spreading cylinder again. This double-acting hydraulic cylinder also enables a “floating” compensation movement in order to apply pressure to both linings.

Such a floating compensation movement does not necessarily have to be present with mechanically pressed-on linings. Preferably, however, the mechanical lining pressure can be “floatingly” mounted here, i.e. the mechanical spreading body can be mounted here in such a way that it assumes a centered position when the brake is applied by the press-on forces and retains this position, e.g. by means of certain (also intentionally supported) frictional locking after loosening. The loose springs were therefore preferentially pulled back against this centered position and can, for example, have an end stop installed in order to limit the size of the air gap as created to a certain dimension.

The same can be applied mutatis mutandis to disc brakes when there is a (tension spring or compression spring) available to move the lining away from the friction surface, with at least one spring action against a centered position (held, e.g., by frictional engagement of an e.g. spring-loaded pin against a fixed part and found during the tension application). An end stop can in turn limit the size of the air gap, resulting in, for example, a spring-loaded pin in an oblong hole which takes up a centered position. At least one additional spring acquires the lifting of the lining and the stroke of the slotted hole limits the lifting movement. This can occur on both sides of a floating calliper, for example, and can affect only the floating calliper or also the lining which has been actuated by the actuator (usually the inboard lining).

Similarly, in a multi-disc brake (slatted brake), a whole chain of springs and lift-off stroke limiters can be provided in order to lift off and center all lining carriers, and additionally, one (or the same) chain of springs and lift-off stroke limiters can lift off and center the discs with friction surfaces, so that all friction surfaces and lining surfaces are lifted off from each other with a defined air gap. This can be applied to all brakes even when utilizing a pressure transmitting press-on part or wear adjuster. Every other one can, of course, be utilized instead of spring energy for lifting off.

In principle, one could want to always utilize the non-linearity in the same range in order to advantageously achieve “almost constant actuator torque”, even with thermal expansion. However, due to thermal expansion, the wear adjuster always had to be adjusted in both directions for achieving a constant contact point and/or air gap, which can cause considerable wear in the wear adjuster.

It can however be advantageous not to have to continuously adjust or reset a wear adjuster in such a way that the air gap is kept constant despite thermal expansion.

However, this constantly shifts (since friction brakes always generate heat when actuated) the actually utilized part of a non-linearity, which can therefore be adjusted accordingly. A “nearly constant actuator torque” is therefore impossible.

The fact that the EMB can always be operated, despite non-compensated thermal expansion, is a self-evident minimum requirement. In addition, it is therefore advantageous to implement that all (or certain) of the mentioned optimizations work at all temperatures, i.e. that e.g. “hold position” or “detection of the touch point” still work despite thermal expansion (and therefore a range of non-linearity which does not displace).

Disc brake clamping forces on passenger car front wheels start at zero (or just below if, for example, a spring helps to loosen them) and go up to 40,000 Newtons, for example, whereby the course of the force increase can show abrupt amendments (e.g. at the touch point). It is possible to produce non-linear transferences, which alter the force ratio correspondingly as strongly and quickly, but this can result in extreme formations (e.g. cams with tips), which will cause problems in manufacturing, production and operation.

Other mechanical solutions, such as toothed gear pairs with a non-constant radius, ball ramps or ball ramps with a spiral instead of a circular ball track, or lever replacements, can provide in practice, when they are to be even mechanically feasible or reasonable for production purposes, smaller amendments in the transference ratio with EMBs than would be necessary in order to effect a constant actuator torque. Also, when cam forms should not have too “pointed” positions (i.e. too small radii of curvature) in order to retain the mechanical load (e.g. line load, Hertzian pressure) within the desired limits, the possible alterations in the transference ratio are also still not considered to be sufficient to produce a constant actuator torque.

Many of the known non-linearities can only therefore be utilized for “constant motor torque” in a very limited way. When, for example, an alteration in the torque transference ratio of 1:10 is required, then the normal distance with a lever of 5 mm, for example, must alter to 50 mm, which requires very good accuracy in the 5 mm range in order not to position it at 4 mm, for example, and the course could hardly be designed here, rather it would be predetermined by the geometry. When, for example, the smallest radius of a non-centric gear would be 20 mm, then a 7 times larger one would already have a radius of 140 mm, which also requires space for twisting, and the progression from small to large radius could only be designed to a very limited extent because of finished teeth. Therefore ball ramps normally have a constant ramp slope and non-constant ramp pitches can cause unstable ball positions and/or the slope can only be altered within a certain range.

Therefore, non-linearities are preferably designed with a view to good manufacturability or production capability and gentle operation, and excessive alterations in the transference ratio are to be prevented if applicable. This can, if applicable, make a (largely) constant actuator torque impossible. Rather, in all forms of design, the actuator torque curve is preferably designed in such a way as to produce readily producible and contractual translation curves e.g., cams with “soft” curves for favorable mechanical loading.

This deliberately limited design capability for the transference ratio can be advantageously combined, for example, with the reduced holding torque for long position holding during brake reheating (see above).

The claim to operate the actuator in the range of maximum mechanical actuator performance is physically correct during the actuation process. Here, however, in contrast, special consideration is provided for how the non-linearity should be designed when the mechanical actuator power is zero or low. For example, when an actuator position is to be retained (approximately), then the product of angular speed multiplied by the actuator torque is zero or low, so preferably very far from the range of maximum mechanical actuator performance.

Actuator Load Increasing with Actuation

In the case of electromagnetic actuation, it can be very advantageous for regulating it when the electromagnetic actuator utilizes a current which increases with the actuation travel, which can be achieved, for example, by actuation force which increases with the actuation travel.

For example, it can be desirable to have the fastest possible movement when the linings come into contact with the friction surface in order to provide a better detectable actuator torque for measurement. However, if due to incorrect adjustment or some other deviation (e.g. thermal expansion), this actuator torque became too large for actuation, then this non-linearity can be rendered ineffective and replaced with a less rapid non-linearity, e.g. by permitting the initial non-linearity to enable such additional rotational movement of the actuator when a spring force is exceeded so that the slower non-linearity becomes effective. One could compare this as whether an additional automatic gear shifting is effective, which additionally acts as being effective for the altering transference ratio of a non-linearity. This can be designed, for example, in such a way that two cams are actuated, whereby normally the steeper one starts first, although the steeper one is carried along by a spring and, if there is too much torque, it can be left behind in order to let a flatter one act. This can also be applied to screws, for example, in that the faster one starts first and a slower one takes over when its drive torque is exceeded. There can also be more than two such transferences executed from one drive unit to another, and the individual drive units can in turn be linear or non-linear, and individual drive units can also be specifically influenced, e.g. prevented from turning back by means of ratchets.

This method can also be utilized when there is only one non-linearity present. For example, in the case of a self-energizing brake, the drive torque cannot be sufficient in order to enable a required actuation movement at standstill. In this case, such a degree of freedom will be built in (e.g. a spring), with which an actuation up to the desired position can be executed, the non-linearity can however only be executed with relief for the non-linear drive unit torque and therefore e.g. when with movement a self-amplification sets in.

These points are not thought to be dependent on each other i.e., any one can apply, regardless of others and whether others are thought of before or after.

If applicable, the invention relates to an electrically actuated friction brake with at least one transference ratio which varies over the actuation movement, whereby ranges with special requirements will determine the non-linearity which is prevailing there, and mechanical or pressure-transmitting intermediate members are also possible.

The invention relates, if applicable, to an electrically actuated brake with at least one transference ratio which varies with the actuation movement and with a minimum of one wear readjustment, in which mechanical or pressure-transmitting intermediate members are also possible.

The invention can concern, if applicable, an electromechanical brake with at least one transference ratio variable over the actuation movement and various functions during actuation, in which mechanical or pressure-transference intermediate members are also possible.

One or more of the following features and combinations of features can, if applicable, be optionally provided in the invention:

That a possible advantageous embodiment does not operate the brake actuator substantially in the range of constant actuator torque or highest mechanical actuator power at fastest possible actuation, rather in at least one operating point or operating range which thereby deviates from this with a special requirement, such as for example important operating conditions at zero or nearly zero output power of the actuator, when e.g. an actuator position or an actuator position range should be retained and a magnitude should be minimized, such as e.g. the current for this procedure or the thermal load of the actuator:

That the vehicle behavior is taken into account i.e. how fast and at which wheel how much braking torque can be built up at maximum and faster actuations are not provided for in the non-linearity, from which it follows that the brake actuator follows this requirement in areas and does not run in any other optimum, such as e.g. highest power:

That the electronics for actuator operation mainly reduce the electrical energy consumption (e.g. current consumption) during the holding of a position or a position range to a large extent in order to enable only the holding and, for this purpose, uses e.g. a position measurement, a position setting (e.g. switch) or a time setting until the position is therefore reached (and reduced after the time setting), or utilizes only the minimum current due to the regulating characteristic which prevents a motor angle alteration in a certain range and that the non-linearity or the non-linearities (e.g. from a spring actuation and an actuator actuation and/or a loosening with an actuator) in this position or this position range is preferably designed in such a way that the actuator torque becomes small to minimum here:

That the non-linearity is designed in such a way that the short-term, medium-term and long-term power supply to the vehicle is taken into account, e.g. a secure characteristic curve which enables considerable overcurrents in the short term, but in the long term (e.g. to hold a position or a position range) only enables the temperature-related current close to the rated current, and that, if applicable, the EMBs are coordinated with each other in such a way that, e.g. only the most necessary work is possible with very little current or that the EMBs adapt their actuation behavior to each other and to the available current, and that this adaptation is executed for different power supplies in the same way or adapted to the respective one, so that, for example, a backup power supply, e.g. with lower current delivery capability, is taken into account:

That the non-linearities for several brakes are adjusted to each other in such a way that an overall advantage results, e.g. that the brakes which are considered to be most important for fast full braking (e.g. front wheel brakes) build up braking effect preferentially and for this e.g. less important brakes are optimized to other advantages (e.g. they need less current in this status in order to make it available for the more important ones) and the individual non-linearities (also e.g. in certain ranges) are therefore designed e.g, for an overall optimum which can also take into account altering conditions such as e.g. heating up or current wheel load distribution:

That the non-linearity with respect to slow or no brake actuator motion and/or that the non-linearity with respect to fast brake actuator movement such as e.g. ABS oscillations or oscillating ESP operations of at least one EMB on the vehicle is designed with respect to the available power supply(s) and fuse(s) and/or that the fast brake actuator movements are reduced in such a way that non-linearity and power supply are possible and/or that these oscillations are replaced by a less oscillating operation such as e.g. braking with optimum slip: that in “braking with optimum slip” the transference to improved road grip is recognized e.g. By utilizing wheel speed alteration, also in connection with modulation of the wheel braking effect:

That the internal regulating for the EMB brake actuator prevents high current peaks, which hardly provide any gain in operation time e.g., by preventing rapid alterations of the actuator speed and e.g. by limiting currents which are due to short-circuit behavior e.g. those which result from full current supply of a stationary, slow running or even jerky running brake actuator. For this purpose, the actuator angle steps can also be specified in such a way that they can be reached by the actuator with a current which is considered to be reasonable:

That in the case of several brakes, the brakes are actuated individually (also individually or in groups) in such a way that a favorable total energy consumption is produced, thereby e.g. very slightly time-delayed, in order not to let the individual mass inertia loads act simultaneously during actuator acceleration, or e.g. in the case of ABS actuation and release and these oscillations, not to let these statuses coincide unfavorably or even to compensate each other, so that e.g. a releasing brake coincides with an actuating one:

That the non-linearity is designed at the very beginning of the operation in such a way that a lot of brake actuator torque is available in order to accelerate it, and then the non-linearity amends to high lining movement speed taking into account how much the mechanical execution of this non-linearity permits this:

That the operating range of the non-linearity is altered (e.g. non-adjusted wear) or it alters (e.g. wear, temperature):
That the non-linearity is altered during brake application or during loosening, e.g. by altering linear or non-linear transferences in their behavior against each other in the operating point or range, as e.g., application-dependent or force-dependent, one non-linearity is applied initially and then another subsequent non-linearity is altered e.g. initially the steeper ball ramp is rotated and then the flatter one;
That, in an advantageous version, a minimum of one non-linearity is not fixed during the design process, production or manufacture, rather that it can be adjusted during operation or during actuation or loosening, or can alter itself, or that the geometry of at least one non-linearity alters during operation (adjustment cam) and is not unambiguously defined beforehand, and that as the drive torque of this non-linearity increases, e.g., by back-stepping (against e.g. a spring, slipping or coupling clutches or other force specifications or torque input), to a translation ratio which again enables an output movement (e.g., by using a flatter part of a cam or e.g., a more favorable value of a normal distance of a lever). Non-linearities which alter during operation can also be electrical, such as field weakening, voltage alterations, switching over from e.g., poles or windings and/or that the speed of actuation is altered intentionally, e.g., in order to make allowances for available lower supply voltage or to save current;
That a cam upper surface is made of sheet metal, bar, rod or wire material (of e.g. rectangular or round cross-section) of a suitable hardness and roughness in order to save costs and that this cam surface can also act as a resilient cam surface, also with additional resilient elements and clamping points or support points and the cam surface can also deform selectively under the action of force in order to positively influence the slope and stroke for selective alteration of the non-linearity and/or respectively the surface itself has little or no spring behavior and the spring behavior originates from the support against a center part and that a pre-loading can also be introduced;
That ball ramps with spiral paths and/or non-constant slope are utilized;
That in the case of ball ramps which are arranged one behind the other, one is twisted first (e.g. the one with the largest slope) and, only after a certain twist or a certain twisting torque (or another criteria) has been implemented, does the twisting of the next ball ramp begin and, if applicable, this is propagated to the other ball ramps which are arranged one behind the other;
That two positions or angles are determined: for the actuator (i.e. exactly) e.g. given by actuator (e.g. Hall) or for actuator stored and press-on position e.g. determined on cam, ball ramp or adjustable cam or ball ramp and that the adjustment status can therefore be determined with it. Wear adjustment also acting via mechanical or pressure-transmitting intermediate elements, which is advantageously also operated with the brake actuator (or the brake actuators in interaction), which draws its energy directly from electric current or temporarily stores the electric energy in resiliently acting components and utilizes it during wear adjustment.

Wear adjustment, which originates from a rotary movement of a directly or indirectly electrically driven cam, ball ramp or lever and is actuated e.g. via intentional play or tolerance (to preset the air gap size) and advantageously with a force or torque limitation.

That the wear adjustment consists of a mechanical part, e.g. screw, or a pressure transference part, e.g. hydraulics.

Wear adjustment which is held positionally stable by intentional friction (e.g. spring, wrap spring) or other positional holding such as a magnet.

Wear adjustment which adjusts in one direction only (e.g. via at least one ratchet or ratchet action such as a wrap spring) and which can advantageously be reset manually or otherwise when the lining is renewed.

Wear adjustment which adjusts for insufficient force (torque) with an expected contact point or excessive press-on movement and/or remarks on and executes a subsequent adjustment, whereby these conditions can be mechanically specified by measuring or detecting torque(s), force or forces, switching conditions or measured values on the brake actuator such as e.g. position, torque, current, voltage and this procedure can also take temperature into account.

That the values of brake actuator torque and brake actuator angle (or press-on force and contact stroke) or similar expressive values are determined during operation and are compared with stored values, that advantageously the same are also determined and compared during loosening and that from the deviations of determined and stored values the necessary wear adjustment is concluded and if applicable this is executed, if applicable, or marked for execution, whereby also conditions are included in the determination and/or utilization for the stored values, such as e.g. temperatures, known, determined, assumed, estimated etc. Losses and especially, advantageously, the comparison of the values in the case of actuation and the comparison of the values in the case of loosening provides a good picture of the position of the instantaneous value pairs to the stored ones and this is utilized especially advantageously for wear determination.

That values for wear adjustment or for compensation of not yet adjusted (or not adjustable) wear, which express e.g. the wear adjustment which is recognized as necessary, e.g. the wear adjustment still to be executed, the e.g. wear adjustment not yet performed, e.g. the wear adjustment which cannot be executed at all and/or also statistical statements for how important or probable or otherwise how evaluated these values are. Preferably, for example, wear which has not yet been adjusted or wear which cannot be adjusted can be treated as if it had been adjusted by shifting the operating range which is linearly related to the movement of the lining by these values, thereby achieving in principle the same or similar effect as with other wear adjustment, and the non-linearity is designed in such a way that this shifted operating range is also possible and/or possible to a limited extent.

Wear adjustment which is derived from the brake actuator or with an additional adjustment device (which can also be adjusted manually or without an additional adjustment device), also executed several times, when it is recognized or assumed that too little or no adjustment has been assumed or the brake actuator is also intentionally operated additionally in an adjusting manner at least once, even after e.g. a braking operation has been completed.

That the adjustment quickly passes through the air gap area to easily detect small lining contact forces (e.g., with the brake actuator) and can trigger an adjustment on additional movement and have intentional play or tolerance in order to not trigger an adjustment or movement when the air gap is correct. That the wear adjustment has a holding function available (e.g. friction) which prevents unintentional adjustment (e.g. by vibration) and can have a one-way function which permits adjustment in only one direction, which can preferably be returned to an initial status when the lining is replaced or advantageously returns to an initial status itself when the lining is replaced, and/or in that a necessary wear adjustment is detected while the wear adjustment cannot be actuated and the necessary adjustment can be “noted” (e.g. by a tensioned spring action) until the wear adjuster can readjust it, e.g. It is therefore relieved.

That the transference ratio, which can be altered via the actuation movement, is designed in such a way that part or all of the wear adjustment can be executed with the brake actuator, so as to provide the brake actuator with controllable positions which are shifted by the necessary wear adjustment (and, where applicable, that the advantageous designs are also possible in this respect).

That a force distribution and/or torque distribution can guide an actuator action to at least two different determinations, e.g. a brake actuator initially actuates a wear adjustment via e.g. a planetary gear or e.g. a slipping clutch and then subsequently e.g. the lining press-on force.

That the wear adjustment is determined from measurements on the brake actuator, which advantageously utilizes calibrations such as springs and preferably utilizes a loss-free case as the midpoint between actuation and loosening.

That springs support the loosening of the brake and/or to separate the discs with air gaps when the contact press-on force is withdrawn, whereby also a device can create the air gap of the first friction pairing, e.g. with a spring-loaded pin, which holds a momentary position of this friction pairing and to which the first air gap is produced with e.g. a spring, and that all energies can be caused also differently than by the springs.

In the case of multi-disc brakes, loose springs located between the stationary and/or also rotating discs support the lifting of the brake linings and, advantageously, a stroke limitation also limits the currently permitted lifting movement.

That model temperatures and thermal expansion are preferably formed by taking into account the braking capacity(ies), cooling by air and/or black body radiation(s) as well as heat capacity(ies) and at least one thermal resistance or only taking into account at least one of these values (or utilizing at least one value describing similar effects).

That also additionally or alternatively certain procedures for the determination of these values are stored (which can consider also influencing factors) like e.g. an aircraft landing procedure e.g. under influence of e.g. weight and/or speed or e.g., a motor-powered vehicle braking under e.g. consideration of e.g. speed (e.g. brake beginning and end), e.g. air temperature, e.g. dryness humidity rain (and e.g. strength).

That these determined values are taken into account in the brake control system and/or regulating e.g. In order to improve the accuracy of the braking effect or wear adjustment and/or of a wear model, to determine a brake actuator position (or a permissible position range), to compare measured temperatures with these determined ones and to draw conclusions from them, such as e.g. whether additional spray water or wind cools a brake, whether the braking effect on one or different wheels is classified as corresponding to the required one, or to form a correction from a deviation.

That the wear adjustment compares temperature measurements (also via heat pipes such as heat-pipes, infra-red) with a model temperature and executes a wear adjustment in case of deviation.

That the wear adjustment also utilizes a minimum of one force sensor and utilizes it in multiple decision algorithms.

That the wear adjustment combines various measurements such as measurements on the actuator, temperature, the forces.

That a part of the press-on force is executed place with an approximately constant transference ratio or with such a ratio which thereby takes into account the stiffness alteration of the brake during wear and, with this element, the wear adjustment is executed and the amendable transference is executed in the direction of the actuator.

That the transference ratio, which varies over the actuation movement, permits that a part or the whole wear adjustment is assumed with the brake actuator and therefore to preset positions to the brake actuator which are shifted by the necessary wear adjustment. For example, EMBs can also be operated without or with manually executed wear adjustment.

That the EMB is controlled via the instantaneous stiffness characteristic curve, whereby e.g., a position specification is determined at a required press-on force, or e.g. a required press-on force is determined by setting the actuator torque required for this, taking into account non-linearity(ies) and, if applicable, spring effects.

That errors, faults or malfunctions in measurements are eliminated, e.g. the instantaneous losses are estimated or e.g. periodically detected brake disc thickness variations or other inaccuracies of e.g. drums or rails or superimposed oscillations of force measurements or torque measurements are eliminated or statuses of brake control signals not useful for braking are eliminated (e.g. detection attempts for closed circuit or e.g. detection of voltage shifts of ground references, change of supply voltage(s)).

That the force-displacement characteristic is measured in the air gap and therefore the effectiveness of the air gap springs can be concluded (whether, for example, a floating calliper is stuck or discs are not loosened) and therefore the detection of the point of contact is improved. That the EMB is positioned above the instantaneously expected energy for a certain press-on force or that an energy range is maintained and/or that the energy (or a value describing the same) is measured when changing the position of the brake (e.g. when actuating, e.g. the energy (or a value describing the same) is measured when changing the position of the brake (e.g. when actuating, e.g. via actuator torque times actuator angle) and the actuation is performed up to the expected energy or that the expected energy in an energy range limits the actuation to permissible values and preferably includes the expected energy on the current status of the brake.

That deviations from the stiffness characteristic (from the force-displacement behavior) are immediately corrected by controlling the brake actuator with positions which are shifted by the necessary wear adjustment.

That a force sensor measures an entrainment or press-on force and preferably a comparison with a setpoint value is made, e.g. in a control of the actual value: the control is preferably electronic, but can also be made by mechanical comparison. Instead of measuring the force, it is also possible to execute a force measurement in e.g. at least one point, e.g. a switch can be actuated if a lining carrier force exceeds a certain value against a spring force, e.g. and a small braking torque is therefore generated. Therefore, for example, the air gap can be inferred and, with the (preferably instantaneous) stiffness characteristic curve, a more accurate braking can be performed with this knowledge of the onset of braking torque.

That analog filters or digital filters are also of higher order or pole number in the input signal (PWM, analog) or in the force measurement signal or torque measurement signal, e.g. In order to suppress malfunctions and/or to out average or smooth over the value, where a low-pass can also interact with an additional high-pass in order to reduce time delay, similar to a “compensated voltage divider”.

That a pre-learnt system or learning-capable system (e.g., Deep Learning, neural network) or a corrective system (e.g., fuzzy logic, models in microprocessor) has been treated for improvement prior to operation or is treated during operation and incorporates other data, such as e.g. from other brakes, temperatures etc., and thereby improves the behavior, e.g., improves the accuracy of a brake torque control or operates the control entirely with it.

That a brake actuator (e.g. BLDC, synchronous motor or asynchronous motor, DC motor, electromagnet, Piezo or an existing electrical machine such as e.g. wheel hub motor, wheel hub dynamo) actuates a brake or at least two of a group (e.g. axle).

That a second actuator motor is present which actuates at least one parking brake position or moves against an actuating spring, which can also serve as a service brake function (or for safety reasons) and/or which executes a wear adjustment, if applicable in coordination with the first actuator, and that this second actuator completely, partially or not, utilizes the same actuating mechanism as the first actuator and that this second actuator also actuates at least two brakes which belong to one group, e.g. on one axle.

That a wear model also supports wear adjustment.

That a wear measurement is also executed.

That the brake utilizes a spring in order to support the release and/or to support the actuation, which can also act through a variable or constant transmission.

That it is a drum brake, disc brake, multi-disc brake or other brake for any preferred movement as a self-enforcing or non-self-enforcing parking brake, which also utilizes spring effects, e.g. for actuation and which also permits actuation via e.g. spring-loaded intermediate parts, when the self-enforcement e.g. does not act at standstill and which can assume two or more positions of which at least one remains or is reached when the brake does not receive any electrical energy and it is possible to maintain positions even with reduced holding current.

That the brake must be supplied with electrical energy in the case of positions which could remain without electrical energy, so that it can amend its position and that the release speed or actuation speed is, is or can be controlled or limited (e.g. by at least one resistor or short-circuit or a mechanical, hydraulic or pneumatic speed influence reducing the motor speed, by applying currents or voltages or by electronic actuator control) and that this speed limitation serves for comfortable starting or stopping or also for material protection.

That the parking brake is also released via a brake actuator in a predetermined time range, the brake actuator is initially permitted (time or position controlled) to have a higher torque, which can also go so far that the brake actuator can handle unusual conditions such as e.g. too much air gap or e.g. disassembled (still no friction surface such as e.g. (e.g. no friction surface such as disc or drum present yet) and that on reaching a certain soldered position or range or a time provided for this purpose, the actuator is amended to a lower soldered-hold current (e.g. with a low-loss controller) and that the electrical parts, which are necessary for this purpose, are single or e.g, for safety reasons completely or partially multiple and advantageously also several different, completely or in partial ranges independent power supplies can be present.

That the parking brake can be mono-stable, e.g., can go into the actuated status without electrical energy being applied, that it can be bi-stable, e.g., can remain in the actuated status or released status without electrical energy being applied, that it can have even more stable statuses, that in an advantageous version, in other than the mono-stable embodiments, it needs the provision of e.g. electrical energy or some other release in order to be able to make a status amendment. That it can be amended into other stable versions by simple means (e.g., the simple removal of a part such as a screw), e.g. when an end-stop screw is removed e.g. from a mono-stable version to e.g. a bi-stable version.

That it is a drum brake, disc brake, multi-disc brake or other brake for any movement as a self-amplifying or non-self-amplifying service brake, which also utilizes spring effects and which also enables actuation via e.g. resilient intermediate parts, if the self-amplification does not work e.g. at standstill.

That the brake combines a parking brake function and service brake function in one brake and, if applicable, can also amend the functions, e.g. that a parking brake function is simulated for buses at e.g. bus stops, in which e.g. a service brake is applied to an e.g. necessary degree, in order not to apply an e.g. fully braking or strongly braking parking brake at every e.g. bus stop.

That at least one brake also fulfills special functions such as e.g. theft protection, steering or steering support e.g. of a vehicle (such as tractor or caterpillar vehicle) or aircraft or e.g. trailer (e.g. as maneuvering aid for trailer), steering in case of failure such as e.g. of the actual steering, holding of a wheel e.g, for tire change, intentional (possibly brief) blocking or braking of at least one wheel e.g. to build up a “snow wedge”. e.g. the actual steering, holding of a wheel for e.g. tire change, intentional (possibly temporary) blocking or braking of at least one wheel e.g. to build up a “snow wedge” or any other useful feature which e.g. facilitates driving downhill e.g. facilitating downhill driving, removal of wet on e.g. brake discs, removal of e.g. rust, performing a test operation for e.g. safety reasons, comparison of a (also intentional, preferably minor) braking operation or modification of a braking operation for measurement purposes, e.g. to compare the presumed braking torque with a known or a known effect, e.g. by determining the effect on an e.g. electric motor or other vehicle drive motor.

Vehicle (e.g., passenger car, commercial vehicle, truck, agricultural vehicle, bicycle, moped, motorcycle, appendix thereto), aircraft (e.g., wheel brake, propeller brake), machine (e.g., driving simulator or flight simulator, moving machine part, elevator, lifting device, wind power blades or ship propeller) or other linearly moving, rotating or otherwise moving part with relative motion to be braked when it is equipped with this brake.

That the brake is directly attached, if applicable, is attached via a connecting part such as e.g., thermal insulation on a rotating or stationary part of an electrical machine such as a motor or generator i.e., for example with a brake drum via thermal insulation onto the rotating part of a wheel hub motor as fixed, which is internally designed with or without a transmission unit.

That on at least one actuating part, an additional non-electrical actuation can act, e.g., a mechanical handbrake function or for reaching a position required for assembly or other handling, or an emergency function (e.g., mechanical or pressure-actuated) in case of failure of the EMB for releasing and/or actuating.

That pressure is applied via a (also non-linearly acting) lever or a press-on part (or also via distributions, branches, “croppings”, multiple pressure is applied), which preferably utilizes pressed-in hard, hardened and/or wear-resistant needles, rollers or other prefabricated parts and is then inserted or joined (e.g. welded, screwed, clamped, plugged) parts for pressing on, or that the counterparts to these parts are inserted or joined (e.g. welded, screwed, clamped, plugged in, inserted) and that these are preferably hard, hardened or wear-resistant. A height error can be utilized, for example, to follow the deformation in the brake during actuation or release. However, the height error can also be made harmless in existing play.

That the press-on force in a brake calliper is applied as close as possible to the lining surfaces in order to prevent long distances and heavy dimensioning of force-bearing material.

That a carrier force is calculated on the average of a lining or from the sum or integral of many partial driving forces and that the total carrier force of a lining as a press-on force on at least one additional lining in turn causes an additional carrier force for this lining or a sum and/or or an integral of many partial driving forces which form a total carrier force (braking force), and in that the number of friction surfaces is taken into account, i.e. whether, for example, 2 friction surfaces are pressed on as is the normal case in a conventional disc brake or several are pressed on as is the case, for example, in a multi-disc brake.

That this entrainment force and an instantaneously known coefficient of friction are able to determine a mean total deformation force, which also corresponds to a mean total press-on force, and this mean total press-on force is either applied directly, or only a portion is applied, and subsequently multiplied by an instantaneous self-amplification to the total press-on force.

That the wholly or partly analog or wholly or partly digital or combined control electronics are wholly on or in the EMB or wholly or partly outside the EMB or one electronics operates several, e.g. the two EMBs of an axle, that higher-level properties such as vehicle stability are in or outside the brake electronics, that the electronics are wholly or partly multiple (e.g, for safety reasons) or that one electronics can take over the function or control of another. The electronics can interact with the environment or the surroundings which exist, e.g. Be equipped with sensors or values or communicate values, e.g. to a vehicle or driver, e.g. via bus system(s) or wirelessly, e.g. radio, WIFI, Bluetooth, telephone network.

That vehicle stability functions such as ABS, ESC, Sway Control, Hill Holder or “blending” with another brake (e.g. regenerative braking) are integrated into these brake electronics, that fast braking torque amendments are preferably performed with a fast reacting brake (e.g. regenerative braking), that tires are preferably operated in a range of good grip (instead of release and actuation), that vehicle stability is continuously taken into account and these EMBs are controlled according to it and not waiting until the vehicle gets a need for stability action. That a slight modulation (preferably with electric motor or generator) is executed in order to possibly detect improved adhesion. That electrical loads in the vehicle are utilized in order to consume regenerative braked energy, or that regenerative energy generation is intentionally operated at a lower efficiency in order to provide more regenerative braking.

That during actuation, especially quickly or as quickly as possible, wheel slip or other magnitude indicative of excessive braking, such as e.g. wheel speed drop or lock-up, is thereby utilized to not permit such a suboptimal condition by permitting only those brake actuator positions (or other brake action settings) which can prevent these suboptimal conditions. If the suboptimal conditions have not been prevented, then the brake can be adjusted back to the point where it was located before the suboptimal conditions and the braking effect can also be increased again in the aforementioned process. In particular, a predictive method can be involved which, from the amendments in e.g. wheel slip, wheel speed, will classify an imminent suboptimal condition as possible and thereby increases the braking effect only in such a way that this condition is prevented. For example, the brake actuator control system, which is classified as optimal, can also be stored and then the stored values will be utilized for brake adjustment, whereby the values can also be e.g. situation-related, e.g. As temperature-dependent or for e.g. asphalt, snow, ice etc.

That the measured or estimated braking effect (and/or other data such as temperatures, brake actuator current, torque and position, error messages) are made available to the outside and, if applicable, functions are implemented there outside with it, such as starting with “Hill Holder” where, for example, the detected braking torque is observed from the outside and a reaction is made to special values and/or amendments. For example, when a braking torque decreases during start-up (e.g. engagement of the vehicle clutch) and the brakes are released, because this is seen as a favorable start-up situation, in order to enable a jolt-free start-up which is as free as possible from unintentional rolling forwards or rolling backwards.

Whereby the braking effect and drive effect (e.g., braking torque, drive torque) are also advantageously adjusted to one another during this starting-up process, e.g. the starting-up torque is increased and the braking torque is adjusted in such a way that there is as little or no unintentional rolling forwards or rolling backwards as far as possible. Similarly, a braking effect can also e.g. be intentionally induced, for example, in order e.g. to brake the constant “pulling” of, for example, a torque converter of an automatic transmission.

That from total vehicle deceleration (which can be measured and/or derived from wheel speed revolutions) and respective wheel slip (e.g. deviation from total vehicle speed, which is formed e.g. By taking into account the deceleration), the braking effect of a wheel is concluded and this is subsequently compared with a model and a correction is thereby created (and, if applicable, stored and reused) in order to approximate the wheel braking effect to the model and therefore a more uniform braking effect of all the wheels is achieved. That in the case of heavy braking on one side of the vehicle or side of an aircraft, it is taken into account that this causes a yaw torque and that this is reduced (also depending on time and situation) to a permissible yaw torque by less heavy braking on one side, or that other yaw torque reducing measures are effected alone or in addition, such as e.g. Steering intervention or rudder intervention or adjustment of other braking effects such as thrust reversal, propeller blade position(s), engine statuses such as power, rpm or speed.

That the rate of build-up speed and/or alteration speed of an undesired condition, which has been caused by braking (e.g., yaw, slope, roll), is slowed down in such a way that a driver, pilot, or such automatic system can control or compensate for this condition.

That with this brake, the slip of a wheel or another magnitude, which indicates suboptimal road contact, is adjusted as far as possible in such a way that this results in a shortening of the braking distance or an increase in the vehicle stability or the stability of the overall vehicle train, i.e. as close as possible and consistently in the range of optimal slip or e.g. optimal respective wheel speed, and that is procedure is made consistently, therefore that the ESC or

ABS are continuously active as monitored and do not intervene only when the vehicle becomes unstable.

That at least one trailer wheel is braked in the case of trailer roll, with which the roll can be reduced, or that several trailer wheels are braked for this purpose.

That the mechanical design of the EMB and electronics is suitable for the required environment, e.g. waterproof including wading depth for automotive use, and the components are suitably resistant, e.g. corrosion-resistant to salt water and/or water-protected plug-in connections.

Additional features in accordance with the invention can be derived, if applicable, from the claims, the description of the examples, the embodiments and the figures.

The invention will now be additionally explained by means of exemplary, non-exclusive and/or non-restrictive embodiment examples.

Unless otherwise specified, the reference signs correspond to the following components:
Brake 01, brake disc 011, brake drum 012, floating calliper 013, housing 014, losses 016, wear adjustment 02, spring for wear adjustment 021, adjusting screw 022, slipping clutch 023, wrap spring 024, carrier 025, toothed gear 026, non-linearities 03, ball ramp 031, actuating cam 032, roller for it 033, cam rotation axis 034, adjustable cam 035, rotation axis cam adjustment 036, deformable cam 037, clamping point 038, actuator 04, motor 041, actuating spring 042, motor electronics 043, brake torque control 044, transmission unit 045, calibration spring 046, parking brake drive unit 047, parking brake spring 048, calibration spring characteristic 049, press-on force 05, spreading part 051, spreading part drive unit 052, unbraked position 053, braked position 054, press-on force measurement 055, s-cam 056, spreading part pivot 057, friction pairing 06, stator discs 061, rotor discs 062, brake lining 063, carrier force measurement 064, carrier force control 065, roller for brake shoe 066, brake shoe 067, air gap 068, brake shoe support 069, spring(s) for air gap generation 07, stator springs 071, rotor springs 072, stroke limiter 073, calliper slide spring 074, slide support 075 wear adjustment actuation 08, area utilized for braking 081, area not utilized for braking 082, fixed part e.g. wheel bearing part 09, certain static friction 091, initial position 092, braked position 093, carrier 094, vehicle dynamics control 10, signals in electronics 101, from the electronics 102, vehicle data 103, self-generated signals 104, brake functions 105 (also mechanical), areas on curve 11, no lining stroke 111, onset of wear adjustment and/or springs 112, actual rotational movement in wear adjustment 113, actual rotational movement in wear adjustment and/or slipping clutch or coupling, further increasing torque 114, fully executed wear adjustment and/or an end stop 115, lining movement+at least one spring action 116, lining movement+possibly a wear adjustment 117, larger air gap 118, smaller air gap 119, wheel hub motor 12, wheel bearing 121, axle 122, rotating parts 123 (magnets . . . ), stationary parts 124 (coils . . . ), assembly plate (among others) for drum brake parts 125, connecting cable 126 for wheel hub motor or dynamo, connecting cable 127 for EMB, drum mounting 128, heat insulation 129, wheels 1301-1308, initiated braking 1401, sudden slip increase 1402, 1st local slip maximum 1403, 1st corrected slip, sudden wheel adhesion decrease 1405, 2nd local slip maximum 1406, 2nd corrected slip 1407, sudden wheel adhesion increase 1408, slow wheel adhesion increase 1409, insufficient slip 1410, brake effect increase 1411, brake effect modulation 1412, vehicle speed 1413, wheel speed 1414.

Within the context of the present invention and, if applicable in the following figure description, the terms wear readjustment device, wear adjuster and wear adjustment are to be utilized for the same component and therefore basically have the same meaning.

In the figures, “non-linearities” 03 refers to a component or combination of components which results and/or result in a non-linear relationship between actuator operation and lining stroke. The non-linearities can be designed and equipped as a transmission unit component, in particular as a worm gear, as a cam, as a ball ramp 031 and/or as a lever. The non-linearities can be implemented via the design of this transmission unit component, in particular the design of the geometry of this transmission unit component, preferably the design of the radii.

Some components, in particular the brake disc 011 and the brake drum 012, can represent typical formations of friction surfaces as counterparts to at least one brake pad or brake lining 063. In addition, these components 011 and 012 can also be equipped with special friction linings. Within the context of the invention and in the description of the figures, brake pad or brake lining 063 can be understood as such in particular.

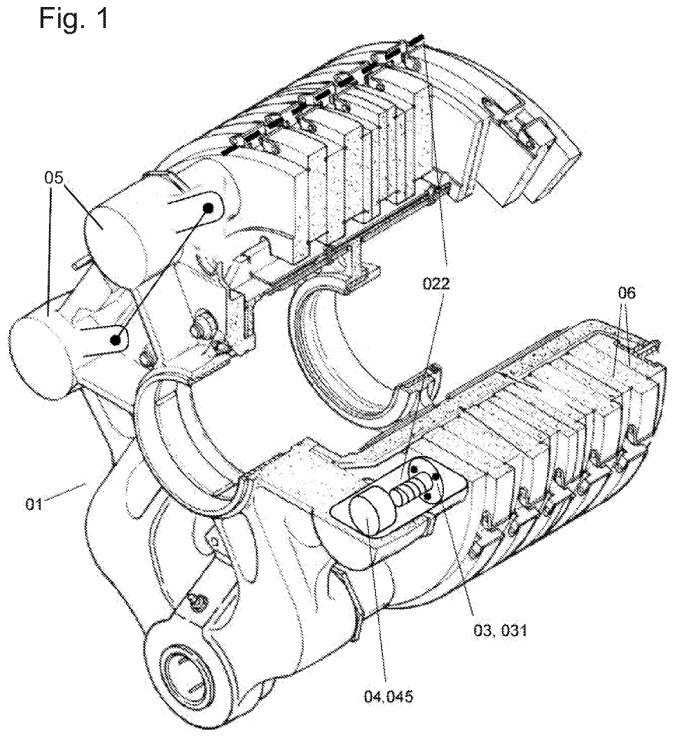

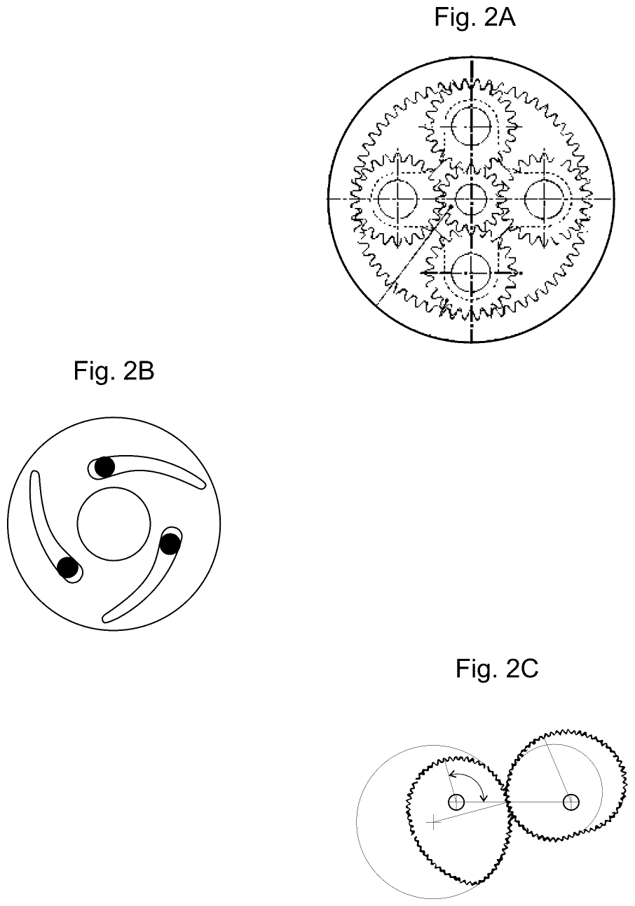

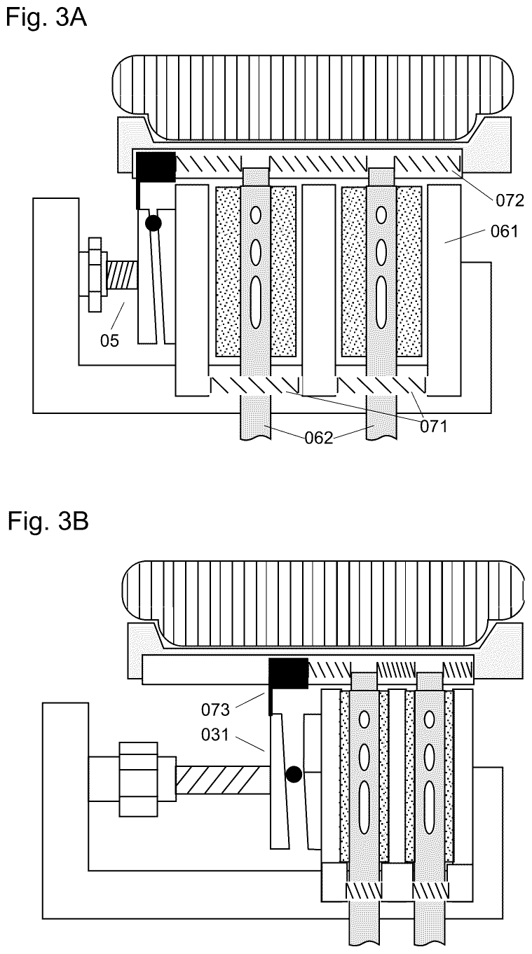

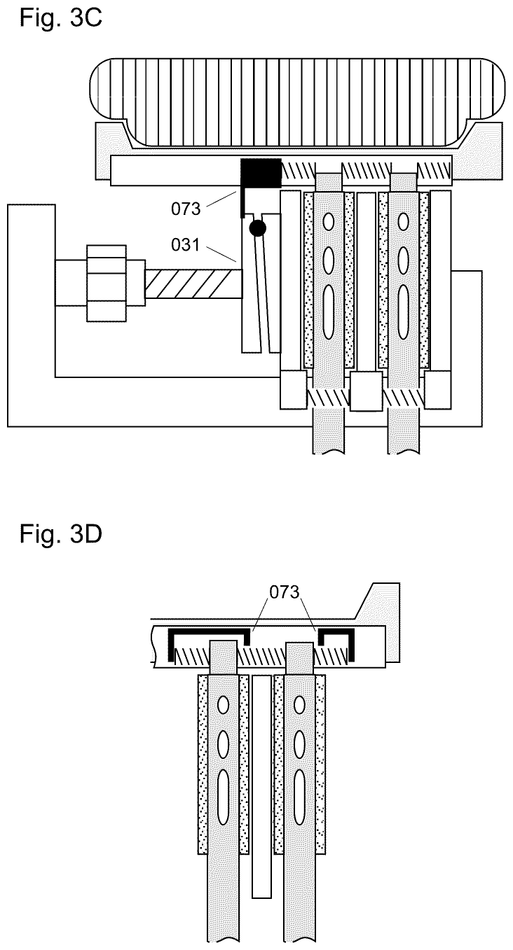

By utilizing a brake 01, in this case several disc brakes or multi-disc brake (as utilized e.g., in aircraft), a non-linear EMB with wear adjustment 02, in this case an adjustment screw 022 (in which e.g. a nut can be driven e.g. by the outer ring of a planetary gear, which can also be adjusted e.g. when e.g. the actuator runs against the normal operating direction) is shown here in FIG. 1 before build-up of normal press-on force. The non-linearities 03 here comprise at least one spherical ramp with, for example, a non-constant ramp slope and/or a spiral-shaped path, where several can be arranged in series in order to multiply the non-linearities, or several can be arranged in parallel for several press-on points as in FIG. 1. A non-linear drive unit for the rotary movement (with e.g. actuator 04 and transmission unit 045) via e.g. lever positions and/or toothed gears with non-constant radius (as e.g. shown in FIG. 2C) is also possible, just as other non-linearities such as cams are possible. The actuation of press-on forces 05 (which cause lining press-on force, e.g. with actuator 04, non-linearities 03, also wear adjustment 02) can or also cannot be synchronized, as indicated at the ends of the lever by connection, in order, for example, to still press on with the remaining elements in the event of failure of one element. As torque distribution, e.g. a planetary gear can initially direct the rotary movement to the at least one adjusting screw 022, when e.g. the ball ramps cannot yet be rotated via e.g. springs 07 for air gap generation (not visible in FIG. 1) or other co-rotation obstacles such as e.g. friction. If the adjustment screw 022 builds up a certain lining press-on force, then it can thereby stop and guide the rotary movement into the ball ramp. The adjusting screw 022 can remain in the thread from the time the press-on force builds up due to friction and can only produce an air gap 068 again from the time the brake is released (not visible in FIG. 1, since friction pairs are present), which can subsequently be distributed more or less equally to the friction pairs 06 by springs located between the stationary discs (FIG. 3A, stator discs 061) and springs between the rotating discs (FIG. 3A, rotor discs 062). The at least one adjustment screw 022 was therefore turned before and after each brake application for the air gap adjustment.

The rotation after braking can be reduced, for example, when the blades can contract thermally.

If the 022 adjusting screw(s) are not to be turned with every braking operation (e.g, for wear reasons), then the screws can be prevented from turning, e.g. by deliberate play or tolerance positioned in the screw turning drive unit, as long as the air gap is correct:

In this case, the torque distribution would initially twist the ball ramp(s) 031. When the air gap was too large, then the 022 adjustment screw(s) would now be turned in order to reduce the air gap setting after overcoming the clearance. As above, the torque distribution would cause the adjustment screw(s) 022 to stop when they were causing lining press-on force. This can be favorable for passenger car brakes, for example, so as not to cause wear on the at least one 022 adjustment screw with every braking operation. The torque distribution can be implemented with any arrangement, e.g. also with a slip clutch, which turns the screw(s) only until the slip clutch slips through due to lining press-on force. The at least one adjusting screw 022 can also be replaced by other operations such as inclined planes (also circular) or, for example, pressure transmissions.

Therefore, the actuation motion preferentially passes through different non-linearities: First wear adjustment and/or control, whether it is necessary, then with increasing drive torque (e.g. actuator torque), amend to increasing press-on force (whereby the actuator can e.g. run through the range of maximum power when the actuation time is to be as short as possible) and then a range with reduced actuator torque can sensibly follow when the heating of the brake reaches the actuator in the position holding range. Then a range of actuator torque can still follow, in which e.g. fading can be compensated for, but in which no fast reaction and therefore no operation in maximum actuator power makes sense.

In the case of ball ramps (as shown, for example, in FIG. 2B), spiral paths can be advantageous: For the same amendment in the angle of rotation of the ramp disc, the balls therefore cover more distance on the outside than on the inside, i.e. when the ramp slope is constant over the linear ramp, and more linear ramp length is covered on the outside than on the inside for the same alteration in the angle of rotation, which results in more stroke on the outside. This also reduces the mechanical rolling losses of the balls because they travel less distance as the press-on force increases internally (loss energy=loss force*distance). If the ramp slope is linearly constant, then the balls are in an indifferent status between two such ramp trajectories, i.e. they do not seek a preventing position.

If the slope amends, then the balls can assume an unstable status i.e. they found an evasive position where the ball ramp loses its stroke. Due to their friction on the ball track, they are thereby prevented from swerving when the gradient amends, but this only works to a limited extent and only if the gradient alteration is not too great. This does not occur with constant slope spirals. For example, a spiral ball ramp can have spirals located on both sides whose mating paths are flat, which multiplies their non-linearities by 2 spirals. In an interesting possibility, both ball tracks are spiral-shaped, which means that the ball must be located in the intersection point and therefore also different linear gradients can be stable at the same time, because the ball can only be located in the intersection point and cannot deviate from this position.

One can also arrange linear ball ramps with different gradients, created as one after the other, and to use a spring, for example, in order to cause the larger gradient to be started with a small press-on force and only then (also increasingly with several) to amend to a smaller slope. Especially when large strokes are required, ball ramps which can be arranged in series (cascaded) become interesting, e.g, for multi-disc brakes. One can also therefore derive a wear adjustment when, for example, a ball ramp with a larger gradient (or a non-linear ball ramp arrangement) can be twisted further than expected i.e. when, for example, the contact point occurs later than expected when actuated, which can of course also be applied to single-disc brakes and drum brakes.

In FIG. 2A, it is indicated that e.g. via a planetary gear, a common actuator can be utilized for e.g. For a ball ramp and wear adjuster by driving e.g. the sun gear. The wear adjustment (e.g. screw) can be driven e.g. via the outer ring of the planetary gear. FIG. 2B shows a sphere or ball ramp with e.g. spiral shaped orbits, whereby the planet carrier (the cross supporting the planets) can be driven e.g. a sphere ramp like e.g. FIG. 2B.

If applicable, one can also execute the aforementioned wear adjustment as a “readjustment after performing an operating movement”, whereby one can separate the measurement of the wear condition from the readjustment process. During brake application and/or brake release, for example, at least one force-displacement characteristic can be recorded via measurements (e.g. of the actuator torque via angles) and it can be detected whether the at least one characteristic is displaced by a suspected wear and therefore a wear estimation can be made. Since wear adjustments are preferably executed when the adjuster is unloaded, a wear adjustment can be implemented, for example, with a special movement of the brake actuator after release and therefore use of a corresponding non-linearities, e.g. that after release for a part of a ramp, a cam or e.g. lever position etc. which is otherwise unused for braking, is utilized to adjust the wear adjuster a certain, e.g. By a continuous or stepped amount.

The following FIGS. 3A-3D show a multi-disc brake in which springs, e.g. stator springs 071 or rotor springs 072, support the lift-off of the linings and the lift-off stroke is limited (in the upper part with the tire dashed with rim gray), whereby FIG. 3A shows a “brake released” status with full linings and FIG. 3B for comparison for a “braked” status with worn linings whereby a stroke limiter 073 limits the stroke on the springs to the stroke which can be generated by the ball ramp 031 which is exemplified here. FIG. 3C shows the now released brake from FIG. 3B (with worn linings), with the springs now pushing the discs apart and the function of the stroke limiter 073 becoming apparent: Since during actuation, the multi-disc package can only be compressed with the stroke, which has been provided by the ball ramp 031, the springs are only permitted to apply this stroke again in order to press the discs apart, which can be achieved, for example, by limiting the stroke by means of stroke limiter 073. In FIG. 3D, stroke limiters 073 are utilized in a different way to FIG. 3C, which do not operate with respect to the ball ramp, rather assume their position in the event of heavy braking (e.g. aircraft landing) and maintain their position by frictional locking or positive locking (e.g. similar to a ratchet), whereby the frictional locking could be imagined e.g. at the top of the contact with the rim (or naturally also attached in a different way) and would also affect e.g. only the rotor springs 072.

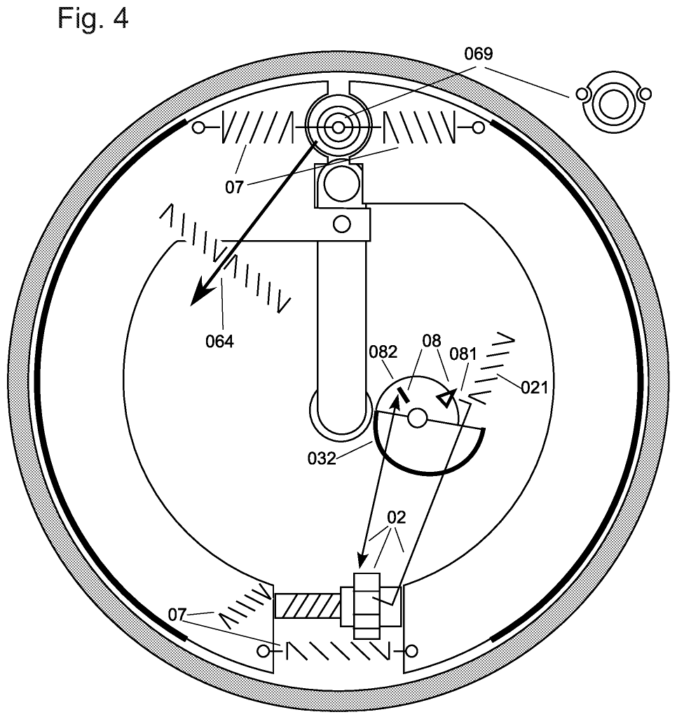

However, readjustment after an actuating movement can also be executed mechanically, as shown in FIG. 4 by using the example of a non-linear electromechanical drum brake, which is based on a servo drum brake with braking force (carrier force) acting in both directions of travel—measurement e.g, for electronic control of the braking force by regulated actuation.

At an actuation cam 032 there can be, for example, an “area otherwise unused for braking” 082 (special non-linearities as described above), or there can be, for example, a mark in the area 081 utilized for braking for wear adjustment e.g. on an actuation cam when the brake is actuated, which stores a necessary actuation of the wear adjuster 02 for the time being (e.g. in a wound-up spring 021), because when the brake is actuated the wear adjuster can be under load. After releasing the EMB, the storage can execute the readjustment process, e.g. turn the wound spring 021 on the adjuster.

The variant shown in FIG. 4 for storing the adjustment, when the stroke is too long, is of particular interest here, for example, in the case of a spring-operated parking brake.

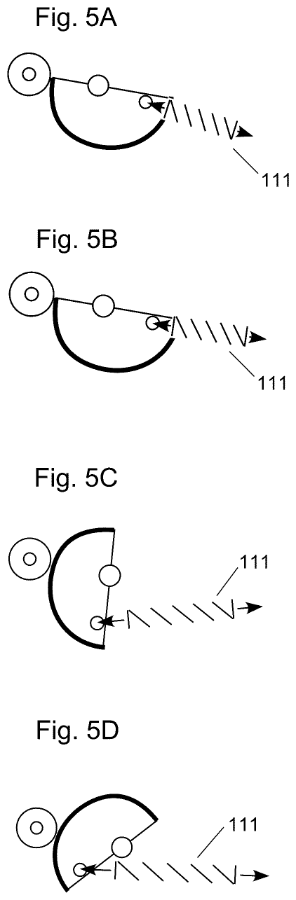

FIGS. 5A-5D show an advantageous embodiment of a spring-actuated non-linear EMB, whereby in the “mono-stable” embodiment (FIG. 5B) in the released status, the “released” holding torque of the actuator (e.g. by the lever position of the actuation spring 042, which can actuate the brake from the position in FIG. 5B), is designed in such a way to be so small that the EMB will go into the braked status by itself when the actuator is de-energized. When the spring 042 is actuated (released), then it will compress in this design until a desired press-on force is developed via the non-linearities of spring articulation and cam slope, which is shown in FIG. 5C. In this wear adjustment method, these non-linearities are preferably designed in such a way that, with too large an air gap, the release position for “noticing” the subsequent wear adjustment is exceeded by the spring action and therefore the subsequent wear adjustment is scheduled, which is shown in FIG. 5D by the fact that the spring can rotate further than in FIG. 5C. Instead of “noticing”, the position can also be measured or determined at the start of the release process or at the end of the actuation movement, and the wear adjustment can subsequently be executed by actuating the brake actuator in a way which is not otherwise utilized for braking.

Advantageously, the non-linearities can be designed in such a way that, if the air gap is too large, then the larger actuation can be detected, but the lining press-on force still remains within a permissible range. The drum brake from FIG. 4 shows one that a carrier force can be detected in a protected manner in drum brakes (e.g. at a brake shoe support 069 of a lining carrier or brake shoe), e.g. by supporting the brake shoe with an eccentric pin (brake shoe support 069). When the braking force presses on the eccentric support, then the eccentric element wants to rotate, whereby as the carrier force measurement 064, the springs thereby cause the counterforce against the eccentric rotation and the deformation therefore corresponds to a force, naturally with lever and eccentric replacement ratio. Brake shoe support 069 can be of various designs e.g. with pins (right).

It is also possible to utilize only a certain carrier force as a triggering function, e.g. at or close distance to the touch point, which is easier to install on disc brakes, for example,

FIG. 5A as a “bi-stable” variant (where the drawn lever position acts in the “released-hold” direction) addresses a different safety concept. The mono-stable design (FIG. 5B) can advantageously be operated in such a way that it is self-actuating i.e. brakes, when there is no current. In the event of a fault, however, this can become critical with regards to safety when, for example, such a mono-stable parking brake suddenly causes a moving vehicle to lock up with loss of control in the event of a cable break or supply line fault. The bi-stable variant (FIG. 5A) can be designed in such a way (e.g. by the lever position of the actuation spring 042 snapping to self “hold released” or also by other locking, e.g. by interlocking or magnets) so it requires switching on the power supply for any status alteration e.g. it therefore remains braked when parking, but remains unbraked when driving and only goes into the braked status when the power is switched on and the brake actuator is brought into a position from which it can subsequently go into the braking status. Several stable positions are conceivable, which can also be achieved, for example, with magnets, electrically detachable parts such as electromagnets, interlocks, designs of non-linearities such as flat or reversing cam slope, dead centers, etc.

The aforementioned spring-cam combinations (or other non-linearities) can be advantageously designed, for example, to be close to “energy swing” equilibrium, i.e. The forces from brake and spring action are roughly in equilibrium and therefore minimum actuator force is required for actuation/release.

Another advantageous design would be that, even with a significantly reduced air gap, one can still ensure a release with the actuator and/or even also ensure that the EMB can be brought into the released status by the actuator even without counterforce from the drum and/or disc. It can be desirable (e.g. during assembly) that, by supplying power to the dismantled brake, the brake is released and can therefore be assembled, even when the brake actuator is very loaded during this release and runs unusually slowly. These embodiments “release with too much air gap” or even “release without drum and/or disc” can cause non-linearities which can deviate very significantly from the theoretically favorable one (operation in ONE optimum over largely the entire operating range, i.e. the greatest power).

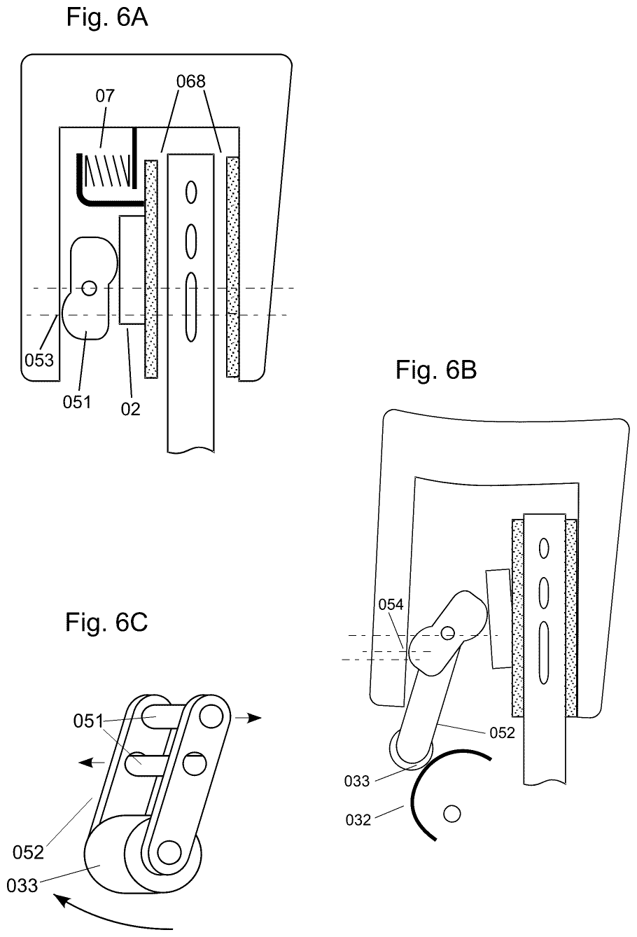

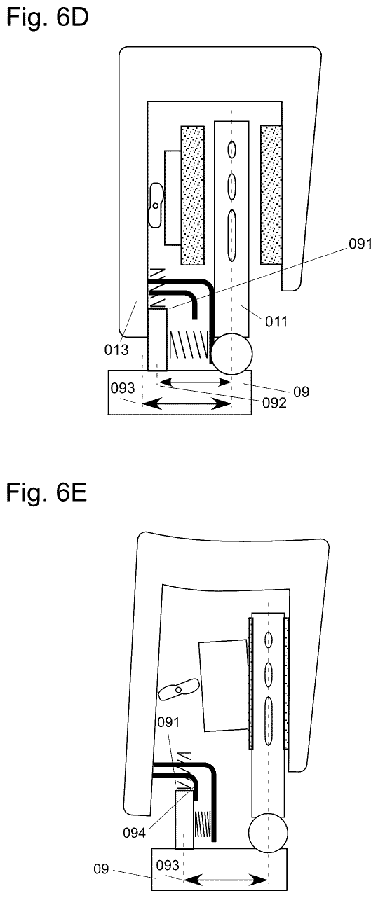

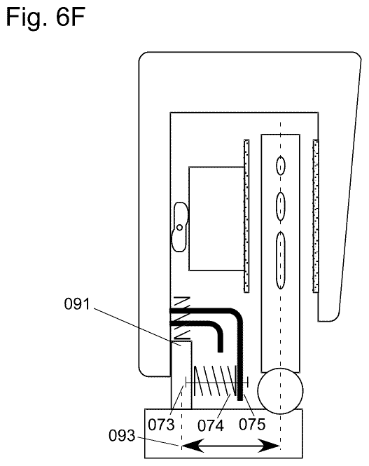

FIGS. 6A-6F show a floating-calliper disc brake (unbraked in FIG. 6A) in which the inboard lining is pressed on via, for example, a cam-like expanding part 051, as is also known, for example, as an expanding part in mechanically operated drum brakes. The EMB expands out and bends itself during clamping, as shown exaggeratedly in FIGS. 6B and 6E. The cam-like spreading part can perform a “scraping” movement on its two bearing surfaces, because its rotation results in a difference in height (between the unbraked position 053 and the braked position 054) and also in a rolling movement on its surface areas. On the one hand, this spreading part can be designed and installed in such a way that its “scraping” incorrect alignments match as closely as possible to the misalignments which are caused by deformation of the brake parts in a compensating manner. Remaining defects in the heights can be taken up in clearance and displacement, as indicated, for example, by the skewed positions of the wear adjuster. Since high surface pressures occur at the expansion part, hardened surfaces are desirable, as shown, for example, in the variant FIG. 6C with the pressed-in hard pins with any cross-sectional shapes. Of course, all other methods of spreading can also be utilized, such as spherical ramps, also with variable slope or variable, e.g. spiral, path and multiple spherical ramps. The wear adjuster can work, for example, as already described for the multiple disc brake.

At least one spring 07 can be provided, which therefore pushes or pulls back from the calliper or another point, for example, so that the spreading device or the wear adjuster remain together and for pushing back the operated lining (usually the inboard lining). The spreading part 051 has a drive unit like e.g. 052 and preferably runs rolling like e.g. 033 as e.g. roller for e.g. operating cam. FIG. 6C proposes a particularly favorable shape, which is also easy to manufacture because, for example, hard needles can be pressed in or otherwise inserted and can also be cropped with a roller and also two ends onto which needles can also be inserted. The needles or pins act as an expanding part 051 and can also be non-circular or ground down and/or contacting.

FIGS. 6D-6F show a floating calliper disc brake (unbraked in FIG. 6D) in which both linings (inboard and outboard) are lifted off. It is well known that the brake linings (preferably inboard and outboard) of disc brakes can be lifted by active pull-back action. In the case of EMBs, the directly actuated lining can also be retracted. Known methods for complete lining lift-off of all linings in EMBs (“zero drag” or “true zero drag”) currently rely on intentional play or tolerance (which again argues against high accuracy), air-tolerance recovery devices, mechanically coupled additional actuation parts, support structures, and drive units which introduce a small displacement movement e.g., after brake releasing and/or brake loosening, and in some cases are unique due to complexity, which can lead to jamming of the displacement due to one-sided actuation. The problem is of course the financial and component effort and expenses, but in practice it is also the fact that air gaps tend to be kept small (e.g. 0.1 to 0.3 mm on each side of the disc) and the many additional parts which are required develop play when they mesh with each other over time, so that the small free-sliding movements no longer take place very well. In FIGS. 6D-6F, a method is proposed which can be achieved with an extremely small component effort, namely a best-fit static friction 091 (or similar position-holding effect against a Part 09 which is assumed to be “fixed”, e.g. a wheel bearing part, i.e. e.g. a press-on force part under spring preload) and which, most importantly in this case, does not require an additional lift-off drive unit, rather it works with the already existing lining movement.

On the one hand, one requires the positions of the actual rubbing surface areas for lining lift-off, but on the other hand, these surfaces can hardly be captured in real terms. One can, however, find the center of the actual friction pairings when one remembers a “centered” position when the brake is applied, which creates a “certain static friction” 091 which takes the centered remembered or noted position in FIG. 6E when it is applied because it is drawn in there by the carrier end stop. During releasing, at least one stroke-limited spring can now push the outboard lining out from this position by a defined air gap. The inboard lining is pulled back as already shown (no longer drawn here). The two designated end stops in bold font can also be represented as slotted holes or similar effects. This lifting method does not require additional drive unit mechanisms and can be reliable because the stroke limitation can be accurate. The raised position, which is achieved in this way, is also stable against subsequent calliper shifting, since the spring effect is always maintained.

FIG. 6D shows a released brake with full linings, where 092 shows the initial position of the pin, measured here, for example, against a ball bearing center (arrow) and 093 comparatively shows an end stop position of the determined static friction reached when the linings are worn. FIG. 6E shows a braked condition with worn linings and FIG. 6F shows the again braked condition with worn linings, in which air gaps were achieved on both sides of the brake disc. In order to prevent jamming, it is proposed to generate the air gap-generating displacement movement at least two points of a floating calliper, whereby in principle only one would also be possible. Symmetrical arrangement is favorable, e.g. close to guide pins or guide surface areas of floating saddles. Since the manufacturing or production costs play an extreme role and complexity must be prevented for the longest possible trouble-free operation under adverse conditions, attachment to a protection capable area, e.g. of the floating calliper 013, is recommended here, although other attachment locations can of course also be utilized in order to set up the displacement movement.

The function can be well explained by FIG. 6E: Due to lining wear and braking, the floating calliper 013 moves to the left and also pushes the carrier element 094 to the left, and this carrier element also takes the certain static friction 091 (or a part of similar effect) to the left until the braked position 093, which can be, for example, an end position with worn linings and (possibly strong) braking and can be compared, for example, with the initial position 092 in FIG. 6D. In the case of the multi-disc brake, it has been shown that stator springs and rotor springs can press the linings apart, which in this case comparably executes the calliper sliding spring 074 as acting against a sliding support 075 and can also prevent the problematic play of a certain static friction by possibly not requiring any additional play. Since EMBs can have parts located in the area of a floating calliper, such a mechanism can preferably be accommodated on or in the area of the floating calliper and protected, for example, with covers. Alternatively, these parts which are proposed for lining lifting can in principle be placed anywhere where a certain static friction 091 can be built up against a part which does not amend, or does not amend significantly, in a position with respect to the friction surfaces over at least one operation of applying and releasing the brake. Of course, additional parts can therefore be involved, such as fastenings, stroke limitations (as indicated here, for example, by application of the certain static friction to the floating calliper, but also advantageously achievable by, for example, a stroke limiter 073 of the relaxation length of the calliper slide spring 074, but can also limit it elsewhere). Of course, the practical implementation will only be functionally the same or similar and can also look quite different, e.g. the parts shown here as bent, carrier 094 and sliding support 075, will preferably be integrated into others (e.g. sheet metal parts). As a significant improvement compared to other methods, it should be mentioned that the spigots are possible without tolerance or play (which makes the adjustment of small air gaps possible), that even unavoidable play can be “pushed away” by spring action, that a protection capable mounting, e.g. on the floating calliper, is possible, and that no additional movement needs to be generated apart from the existing lining movement.

FIG. 6A shows a spreading part 051, which in principle has the same effect but is designed differently and is implemented in many mechanical brakes.

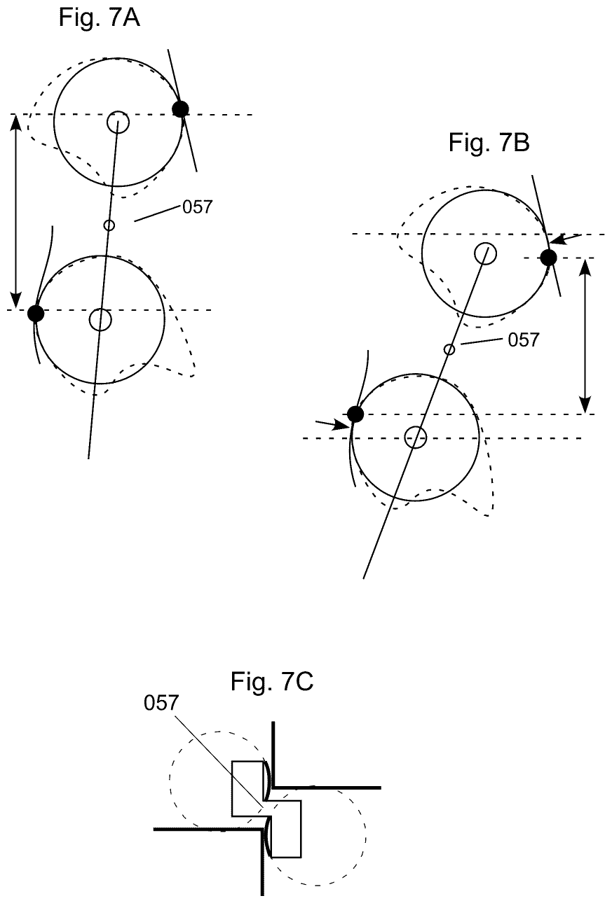

In mechanical drum brakes, it is often “screwdriver-like” between the lining carriers: in truck air disc brakes, a part called a “lever” presses onto a lining with a short lever arm with powerful leverage, and the air cylinder acts on the long lever arm. What all of these have in common is that they “cause multiple height errors”, see FIGS. 7A-7C:

FIGS. 7A and 7B show various unwinding bodies, most of which utilize a circular segment as the unwinding surface, but which could of course be of any shape or, in the case of small dimensions, could have inaccurately small contours due to the manufacturing process. It would be advantageous to use (e.g. press-fit into bores) needles or rollers from e.g. rolled bearings in order to achieve hardness, good circularity and cost-effectiveness. The other rolling surface area will mostly be a straight line (FIGS. 7A and 7B above), but could also be different (FIGS. 7A and 7B below) and will deviate minimally from the original one (e.g. straight) due to usage effects. When this spreading part is rotated from the left status (FIG. 7A) to a lining-pressing one with the spreading part pivot 057 (FIG. 7B), then there are several procedures: A xy sine-cosine movement describes the circular path of an initial contact point, whereby one can aim for a lot of x (in the press-on direction) and little y (high deviation). In addition, rolling along the circumference of a circle creates a path which is proportional to the rolling angle.

With 360° roller rotation, the entire circumference was unrolled, here only one angle-proportional unrolling segment. This unrolling causes more y than x movement in the drawing. These movements can never be height compensating because one height difference starts with an angular function and another starts with angular proportional. If rollers do not roll circularly and/or unwinding surfaces are not flat, then this could bring advantages in terms of a high error, but price disadvantages. In addition, there can be an error that a touch point must always have the same tangents to both touching curves by definition and therefore this would also have to be taken into account with respect to a high error.

For example, when 6 mm needles are spaced at, say, 15 mm, then a lever length of 45 mm would have a transference ratio of 1:3 and would turn 2 mm of stroke into 6 mm of stroke and create a swing angle of about 7°, which therefore amounts to 0.19 mm of unwinding per roller at 19 mm of roller circumference and +3.6°, and 0.03 mm of height error from circular motion.

One can only operate such a pressure lever with respect to its rolling geometry in the range of minimum height error, which mathematically would be a certain range of a cycloid. However, one can also focus on the acting forces, movements and the manufacturing or production possibilities: in passenger car front wheel disc brakes, for example, work act up to 35 kN, in trucks up to e.g., 240 kN, whereby press-on force strokes of e.g., 1.8 mm (passenger car) are made. Now; when one chooses roller diameters of about 6-8 mm (passenger car), for example, because of bending and flat pressing, then the rollers could be ground down to bring them closer together, but one will not always easily reach the mathematically optimal range of the high optimal cycloidal trajectory. Practically, approximating the minimum mathematical height error results in a difficult-to-fabricate geometry with small roll-off radii which are close to each other and where a force-transmitting connection of both roll-off radii is geometrically difficult because the connection can be thin in order to connect through the middle between both roll-off radii.

FIG. 7C shows the spreading part with spreading part pivot 057 and the thick circular parts (which represent the press-on force of the spreading part). The thick circle parts therefore press on the two thick rectangles, which are not rotated with the spreading part. The spreading part pivot 057 could be supported, although in FIG. 7C it can also be rotated without a bearing, since the spreading part cannot essentially leave the position between the thick contact surfaces, which are shown here as rectangular, for example.

FIG. 7C represents a pair of rollers as mathematically operated close to the optimum of the cycloid, with the thick circular arcs rolling on the thick corners. With clockwise rotation, a support point was moved further up by the angle function. The rolling circumference on the arc was also rolled up. This means that the support point does not remain at the same height, but both movements are similar, so that little or no relative movement (“scratching”) is required. The two circular arcs could be connected between the roll-off corners, which already provides little material in the area which connects through the center. These unwinding bends with e.g. 4 mm radius are unpleasantly precise to manufacture. When holes are now drilled in order to insert pins (dashed circles), then the through-connecting material is largely drilled away and the roll-off areas must be recessed for the pins. These are some reasons to abandon the process near the mathematical optimum.

In this opposite design, a position of rollers of suitable diameter will be chosen which is favorable from the point of view of production technology and force. The height error can either be accepted and, if applicable, it can also be assumed that undesired movements or deformations occur, e.g. that a wear adjuster (which serves as a rolling surface) is slightly inclined, or that slight scratching movements occur from certain braking (the vast majority of braking takes place, for example, at % to ⅓ full brake delay). Or one can use unavoidable movements or deformations which occur when the brake is actuated whereby one allows high errors and other movements to act at least in the same, compensating direction or they are preferably designed in such a way that high errors and other movements compensate each other as well as possible. This “other” movement occurs in drum brakes, for example, when the pressed-on lining carrier moves (e.g. around its bearing point) or when calipers of disc brakes deform under press-on force, e.g. widen and bend.

In fact, scratching movements during braking can be even less significant than e.g. continuous friction movements caused by vibrations, e.g. from an unbalanced wheel or diesel engine, and therefore (e.g. partial) permitting for high defects, which cause scratching movement, is entirely possible and can provide significant benefits in terms of manufacturing and cost.

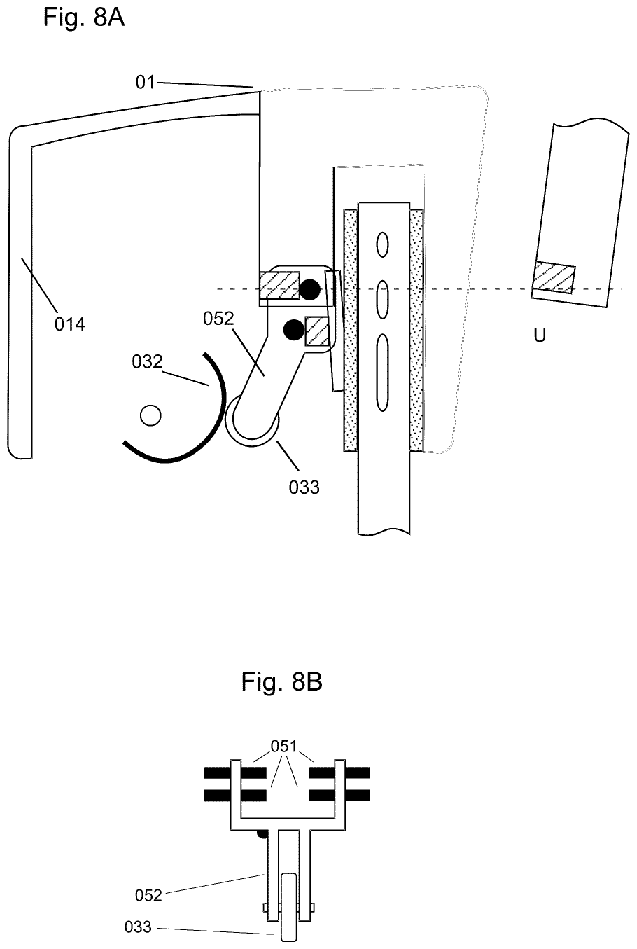

FIG. 8A shows an advantageous solution for a brake 01 in which the high press-on force is transmitted as little as possible in order to save material at the highly stressed points:

Preferably, a housing 014 is separated from the press-on force and the press-on force is thereby generated as close as possible to the lining press-on force or the intermediate wear adjuster.

Dashed in the drawing here are inserted or otherwise attached or secured (clamped, welded, screwed) parts with special properties such as hardness, wear resistance and the black sections here are inserted needles or otherwise attached or secured (clamped, welded, screwed) parts with special properties such as hardness, wear resistance.

The geometry of the rolling of the black needles on the gray surfaces is preferably designed in such a way that the parts can be manufactured or produced sensibly, but that errors in the rolling movement are e.g. small or such that they can be absorbed or tolerated by play, deformations, displacements, but also preferably so that deformations during operation have as far as possible the same effect as the errors and therefore compensate each other as far as possible. Here, for example, one could select the length of the circular arc as unrolled during actuation, in comparison to the angular movement of a point on a needle, in such a way that it was possible to compensate for the lifting of the dashed unrolled surface (right), approximately. Residual defects are absorbed here, e.g. by slanting the part which presses against the covering.

FIG. 8B shows a possible embodiment with a lever with a roller 033 for the actuating cam 032 and two ends for two contact pressures, i.e. e.g. as a spreading part 051, which can be located e.g. on both sides of the wear adjuster so that the wear adjuster has space in between. Each of the two pressing ends can, for example, apply the needles, rollers or other press-on parts on both sides, so that four synchronized press-on operations are produced here, for example. The mating surfaces for the press-on operations must, of course, also be appropriately positioned and frequently available. This lever can also be joined, e.g., from parts such as strip steel, sheet metal, etc., e.g., welded (indicated as a welding point in FIG. 8B in the corner at the writing “FIG. 8B”), spot-welded, riveted, screwed, glued, use folded and bent joints, etc.

Each of these lever designs can also have other functions attached, such as wear adjustment, springs, switches, position transmitters etc. The above geometries can of course also give rise to non-linearities, all of which together provide the required overall non-linearity, i.e. all the strings shown here as lever-like are preferably non-linear lever-like parts.

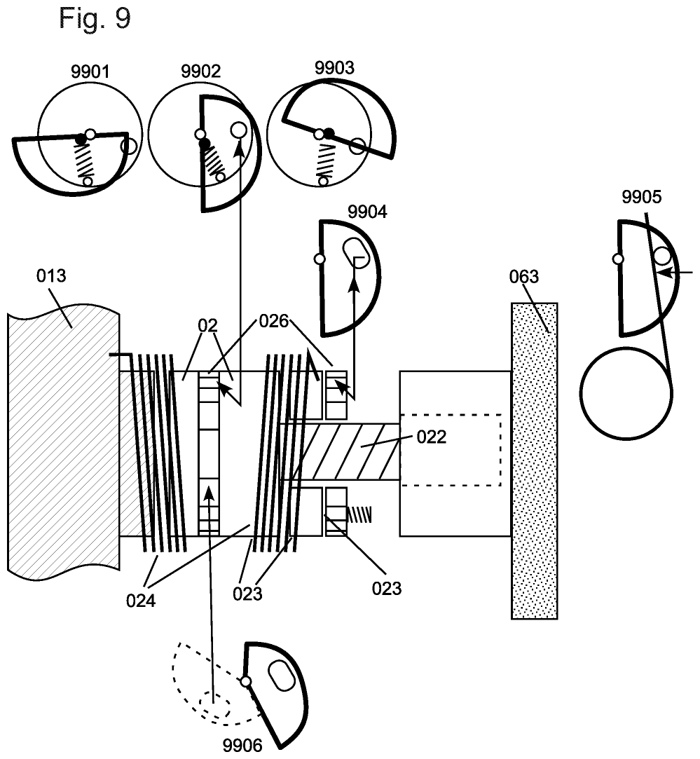

In FIG. 9, an advantageous wear adjustment is shown, which is advantageously driven by a rotatable part 9901 to 9906, which returns less than one revolution although, for this, as much angle of rotation as possible (because with more angle the accuracy can be higher), e.g. by a cam, a ball ramp or a lever. The practical implementations of a rotating part such as 9901 to 9906 can, of course, look and be arranged quite differently, only the functionality is shown in this case.

The rotational movement of a rotatable part 9904 (e.g. a cam) pulls (arrow, other transference movements are also possible) on a slipping clutch 023, which tries to rotate on an adjusting screw 022, but cannot rotate when the touch point is reached. Intentional play or tolerance would not turn when the wear adjustment is correct, only when the play or tolerance is exceeded the rotation occurs. This slipping clutch 023 is implemented here with a wrap spring 024 (right), whereby of course in general, any torque-limiting transmission is possible, which can (should) also make a directional specification, so that the adjusting screw 022 is turned, for example, essentially in the adjusting direction (since wear can only cause less lining material, with exceptions such as brake dust collecting).

Another drive unit possibility for the wear adjuster screw is shown with the rotatable parts 9901-9903, here the screw is driven via a torque limiter with a spring at e.g. the cam, which saves having to implement the utilization for the slipping clutch 023, whereby the spring can simultaneously adjust from a certain rotation and therefore preset the air gap and limit the adjustment torque. The rotating part 9901 can rotate the spring with the circle when the cam is turned counter-clockwise (which would be e.g. a press-on force movement), which is also possible in the further rotated rotating part 9902 (here already torque limitation by spring compression occurs). When the rotating part reaches 9903, the dead center of the circular entrainment by the spring is passed. The arrow pointing upwards to the rotational position of the rotatable part 9902 indicates that at the small circle in 9902 an e.g. pulling adjusting movement (rotation) takes place via e.g. a ratcheting toothing 026 at the wear adjustment 02 on the adjusting screw 022.

With the rotatable part 9906, it is shown that a part of the cam rotation, which is not normally utilized in a braking operation, can also act on the e.g. ratcheting teeth 026 (arrow of 9906), whereby the dashed position presses on the arrow (e.g. a nudge). All these proposals can have something in common in that a wrap spring secures the adjusting screw against unintentional rotation and ensures the direction of rotation of the screw in all operating conditions. One could also provide another ratchet or friction here in order to prevent twisting. It is possible to dispense with the anti-rotation device under certain circumstances, e.g. when the friction on the screw is sufficient in order to always achieve the above effect.

The left wrap spring 024 can be trimmed, for example, by a part connected to the floating calliper 013. For 063, for example, the inboard lining can be pressed on.

The two wrap springs on the left and right can of course also be made into a common one or driven in such a way that a common one can suffice if applicable. A suggestion for a common or even both is in the rotatable part 9905, where at one long end of the wrap spring an actuation occurs in the direction of the arrow, turning a shaft along with it (by further necking). The rotation can stop when the adjustment screw requires more and can lead, for example, to the elastic bending of the end of the actuation at the arrow, whereby the opposite direction of the arrow direction can also find a useful application. The wrap spring can also generate friction or ratchet action (e.g. also at the other end) against turning back the screw.

Rotatable part 9904 performs a readjustment, starting at a particular cam position, which could be in an otherwise normal unused area (or direction), but could also be flagged (or performed) when there is too much readjustment cam travel, such as when, for example, a spring-applied brake over applies due to wear. The torque of the adjusting screw 022 can be limited e.g. by the right slipping clutch 023 and e.g. the right wrap spring 024 can prevent jerking and therefore retain the position by friction, so that the left wrap spring 024 can be omitted but, also vice versa, only the left one could be utilized without the use of the right one.

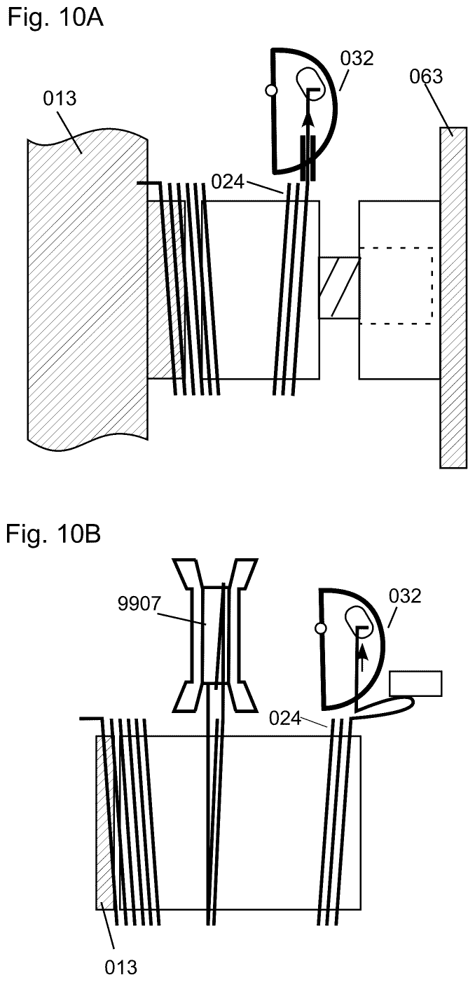

In order to reduce complexity in the area of the wear adjuster, FIGS. 10A-10B are still proposed, wherein a part holding the rotational position and/or acting as a ratchet is therefore braced against a non-rotating part 013, e.g. It is connected to the calliper, drawn here as a wrap spring 024. For a simplified drive of the adjusting screw (other movements would also be possible), e.g. a carrier on the actuating cam 032 pulls on one end of a wrap spring 024, possibly via a guide (drawn as a black rectangle under the arrow in this case), whereby the adjusting screw direction of rotation is provided and the screw torque is limited, e.g. by the fact that the pulling effect of the wrap spring 024 only enables the circumferential force transferable by the rope friction equation.

FIG. 10B is very similar: Here, for example, instead of a rather rigid wrap spring, something elastic is rolled up on a 9907 roller in order to turn the adjusting screw, e.g. a rope, wire or cord. In the tension of the possible cam 032, for example, something torque-limiting or stroke-limiting is inserted, here indicated as an elastic loop with a rectangular stop. Of course, only basic principles can be shown for all of these re-enactments, practical executions will look (also quite) different or will be oriented only on principles. The actuation of a basic adjustment movement can also be executed from any moving part (e.g. pressure lever, ball ramp, transmission unit part etc.), the cam in the figures serves only representatively for explanation.

All these wear adjustments can, of course, be executed not only during the actuation process, rather also at special points of the rotary movement of the cam, ball ramp or lever, which are not otherwise utilized for braking, and thereby preset the magnitude of the adjustment and/or make torque-limited adjustments. One can also hereby save on components, such as e.g. a torque limiter, when the rotation of the adjusting screws is controlled differently, e.g. via the rotation angle which is provided by the cam, ball ramp or lever.

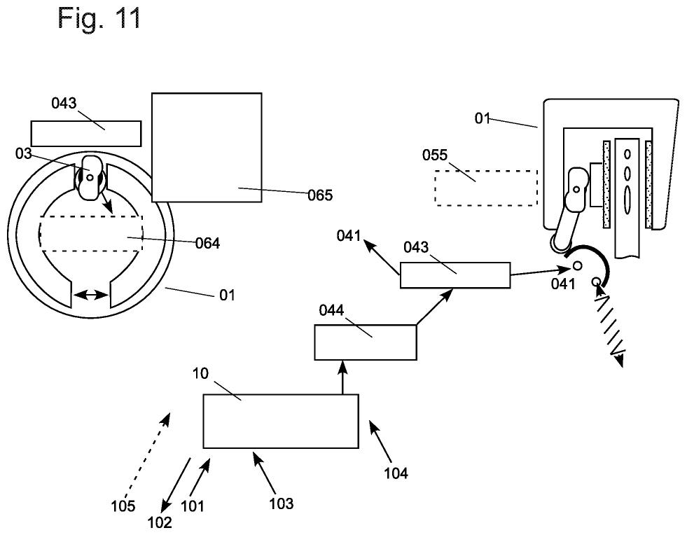

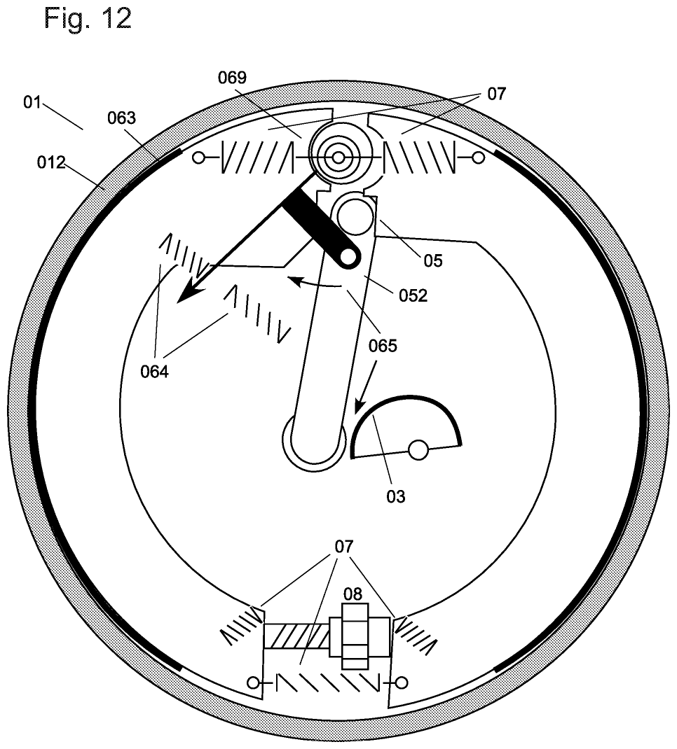

FIG. 11 indicates possible setups which can issue signals into electronics 101 from the environment (e.g., deceleration request or braking torque from brake pedal) and possibly output signals from electronics 102 to the environment (e.g., braking torque or temperatures), each via, for example, CAN, analog, PWM, radio, Bluetooth, WIFI. In addition, brake functions 105 can enter into the brake as and when preferred e.g. mechanical handbrake, mechanical emergency brake.

FIG. 11 shows the basic parts of a structure in its entirety (i.e. only parts of FIG. 11 can be utilized) with a superordinated vehicle dynamics control system 10 (‘Vehicle Dynamics’¹ for e.g. ABS, ESC, sway control, blending), which can be central for a vehicle, but also in copies or variants in individual control units or also unused in advance for later functional structure. From this, a braking torque is usually provided to the braking torque control 044 (or control, when braking torque can be determined), which controls the motor electronics 043.

For example, in one design variant, all of the aforementioned can be installed in one electronic system on or in one EMB, although in another extreme case, there can also be individual electronic groups for everything, which can be positioned at any location, e.g. the motor electronics 043 in one EMB or, for example, together for two EMBs on one axis. Control units can also assume these calculations for other EMBs, e.g. when, for safety reasons, at least 2 calculations should be available or compared.

A drum brake 01 is located on the left (e.g. as a “duo-servo”, whereby both linings are spread apart and then, via the braking force, one lining also actuates the other and the second lining in the direction of rotation subsequently finds a support on a cam as a result of co-rotation), in which the carrier force slightly rotates a cam or non-linearities 03 (or other force or displacement detection is provided) and a comparison between the target carrier force (required braking torque) and the detected carrier force (carrier force measurement 064, actual braking torque) controls the EMB in such a way that the actual torque corresponds as closely as possible to the target torque (e.g. in an analog or digital control system). In this simple case, for example, one could apply an analog target braking signal 101 (e.g., on a two-wheeler or trailer) to, e.g. apply an operational amplifier circuit and actuate the actuator until the actual braking torque is as close to correct as possible. A target braking effect could be obtained on a bicycle trailer, for example, from a drawbar overrun force (which is adjusted for vibrations, e.g., pedaling vibrations) and/or wheel speed variation and/or driver input (e.g., handbrake lever position) (e.g., via radio, Bluetooth, WiFi). In the simplest case, the actuator position was simply controlled (e.g. via a characteristic curve) from the desired braking demand without real carrier force measurement, and e.g. a wear effect was manually readjusted, as is sometimes implemented with mechanical brakes, e.g. on two-wheel brakes.

One could also utilize this method, for example, to make existing solenoid-operated drum brakes, where the “solenoid current” is controlled by a PWM signal, more accurate by detecting the actual braking torque and fading out PWM pulses when the actual braking torque is too high.

For example, the right disc brake 01 is actuated via a spring, non-linear spring adjustment to the cam, and the non-linear cam is subsequently released by the actuator (motor 041), and multiple motors 041 can be set. A press-on force measurement 055 can be provided. The press-on force can also be determined from actuator torque and instantaneous non-linearities, including instantaneous spring action if applicable.

Of course, any measurements can be implemented on the brakes 01, such as for e.g. temperature, wear, etc. The “vehicle dynamics” 10 will naturally preferentially receive or exchange vehicle data 103 such as wheel load, revolutions per minute, temperature, rain, vehicle speed, deceleration, delay, yaw rate, steering angle. Preferably in the “vehicle dynamics” 10 (also possible at other positions), “self-generated signals” 104 can be generated or communicated, such as e.g., with a deceleration sensor, calculation of an overrun force in order to be able to brake, for example, without a brake signal or brake signal generator and/or, for example, the current braking torque can be estimated and, if applicable, adjusted with the setpoint, for example in a closed-loop control, or utilized for control.

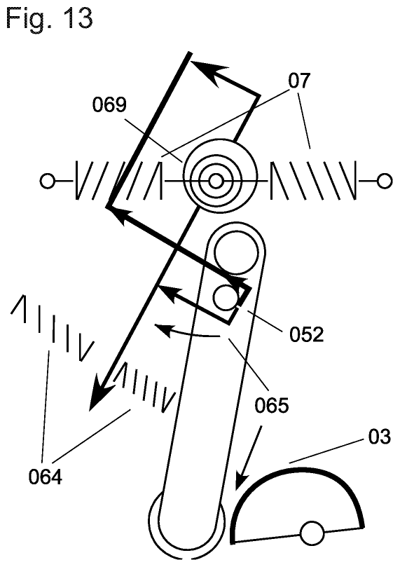

A proposal for a mechanical “brake force control” is shown in FIG. 12 as a mechanical regulating method for the brake force, in this case with servo drum brake with support in one direction of rotation (clockwise): A drum brake 01 with springs for air gap generation 07 (below they also have a cohesive function) thereby supports the carrier force on the brake shoe support 069, which in this case e.g. as an eccentric method provides the carrier force to a pointer and the springs act as a carrier force measurement 064. The upper arrow with the carrier force regulating 065 indicates that too much braking force pulls the bearing point of the spreading section drive 052 to the left, thereby relieving the actuation and therefore acting at the lower arrow of the carrier force control 065 as if the actuation was less actuated by the non-linearities 03 at contact pressure 05, causing less braking.

The higher the self-amplification, the smaller the actuating force, therefore a “servo brake” with “brake force control” in one direction is illustrated here. If the braking force is too high, then the path is taken out of the mechanical actuation, which is easier the lower the actuation force is. One can see the procedure remotely with the negative feedback of an operation amplifier: however, the mechanical amplification is not high in this case.

This can also be executed according to FIG. 13 with a pull-back effect in both vehicle travel directions: FIG. 13 consists in principle of the parts of FIG. 12, except that in FIG. 13, the direction of rotation and therefore the carrier force at the carrier force measurement 064 is reversed, so that no reduction of the braking, by pulling back the bearing point at the spreading part drive 052, would be possible. Therefore, in FIG. 13, a second carrier element (arrow pointing to the upper left) is implemented as mirror-symmetrical to the brake shoe support 069, which is then passed on to the arrow which is pointing to the upper left at the spreading section drive 052, which thereby results in retraction in this direction of rotation.

The procedure is also possible for disc brakes, especially for highly self-energizing ones such as the “wedge brake”, since the actuating movement can also be reversed here if too much of a disc brake pad is entrained. Of course, these are principle functional representations and the practical implementation can also look (completely) different.

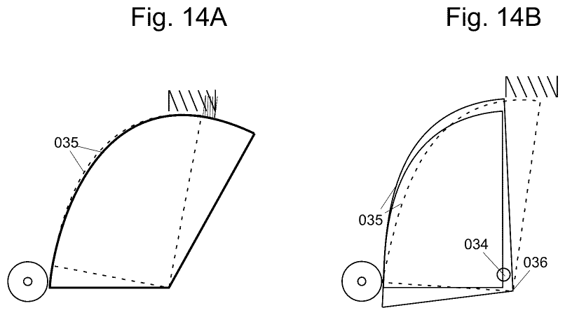

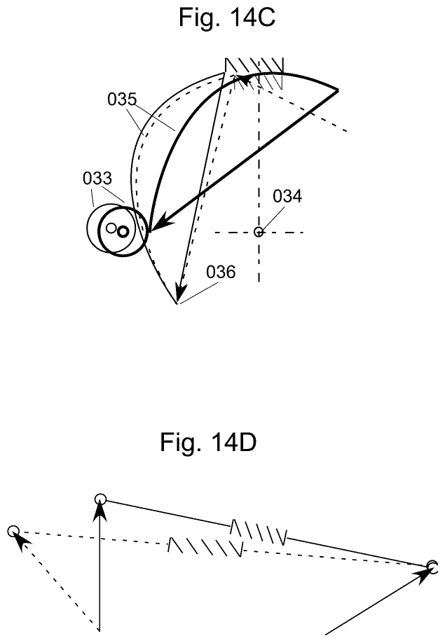

FIG. 14A indicates how a non-linearity for fast lining movement can recede, e.g. when touching the lining: When the first cam is too steep, then it can recoil (dashed section) against the spring until the less steep and longer (thick) one comes into play, which needs less torque due to less slope and more angle if applicable. It can be very steep at the beginning, e.g. In order to detect the contact point and the starting back rotation can be measured. A sensor cam for contact point detection can be made of sheet metal, for example, because only a small force occurs here. For example, the first cam can start steeply enough so that, with a correct air gap at a correct actuator angle, it is rotated back slightly when the lining is in contact, and then quickly builds up contact pressure before transitioning to the second cam. If the air gap is too small, then one can observe the backtwist earlier (and utilize the observation), if the air gap is too large, then later. In particular, the later cam could guarantee operability under all circumstances and the earlier cam could attempt a particularly advantageous, e.g. fast, operation. Instead of the spring, a slip clutch could also be utilized, for example,

FIG. 14B shows a cam arrangement which is similar to an “automatic transmission”: a cam which can move back to enable operation with slower lining movement when the drive torque for the fast-lining movement has become higher than the spring allows: If the cam drive torque is too high, then the cam (dashed) is misaligned, e.g. in the case of a hot disc brake or cold drum brake, i.e. the cam is pressed back into the dashed position by the forces acting on it. The back adjustment can also be measured, for example. The axis of rotation of the cam adjustment 036 can also coincide with the cam axis of rotation 034: e.g. a brake position can be specified by the actuator and the cam only follows this when, for example, incipient self-amplification permits this.

FIG. 14C shows that different adjustment pivot points are possible in order to also reduce the stroke, for example, when the brake becomes stiffer due to worn linings. Similar to FIG. 14B, one can see that the cam is pressed back here, e.g. because it starts too steeply (bold roller 033, bold cam 032). With further cam actuation, the cam and roller move to the non-greased position, but can also (depending on the slope and the forces) be pressed back to the striped position. Backtwist can also provide less final stroke to the roller, which can also be correct if, for example, the brake is stiffer than expected or more cam rotation angle can be utilized. There can also be a pre-adjustment if, for example, the brake is softer than expected or there is more air gap than expected.

Similar effects as described above can also be achieved, for example, with several (also non-linear) ball ramps or with adjustable or adjustable lever reductions, as FIG. 14D shows: Here the arrows represent rotatable levers with an elastic connection (indicated spring). Under load, the spring is compressed, the connection is shorter, and the newly adjusted angles change the moments on the levers.

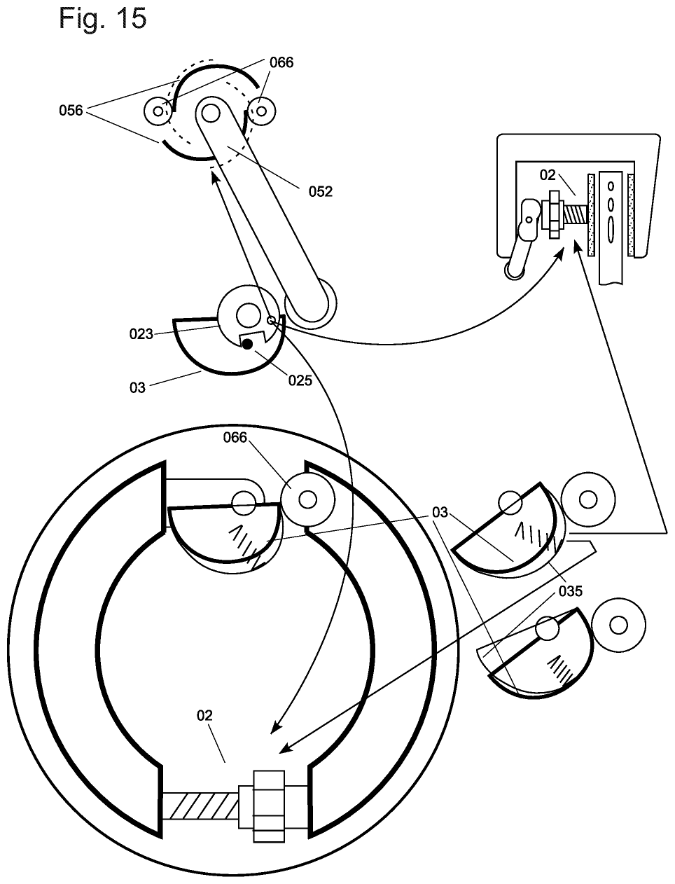

FIG. 15 shows wear adjustments (actuated by the electric brake actuator) on drum brakes and disc brakes where, for example, the correct size of the air gap is established by play, tolerance and/or cam rotation, but where (possibly by omitting the actuation play or tolerance) the detection of the contact point and the adjustment can be separated and the contact point can be determined, for example, by measurements on the brake actuator. the detection of the contact point and the adjustment can be separated and the contact point can be determined e.g. by measurements at the brake actuator and therefore an adjustment can be triggered, which can be located e.g. in an area of the brake actuator which is otherwise unused for braking.

In the case of drum brakes, there is on the one hand the advantageous possibility of making the adjustment in the drum with adjustment screws and on the other hand the possibility of building on existing, e.g. air-operated drum brakes. On the other hand, there is the possibility of building on existing, e.g. air-operated drum brakes, in that a linearizing so-called S-Cam 056 can also cover the lining stroke over the wear and, outside the linkage of an actuating lever, the S-Cam can be adjusted against the lever for wear readjustment, which in this process takes place with the energy of the electric brake actuator. The S-Cam 056, which e.g. presses on the brake shoes via the rollers 066, can not only have a linearizing effect, but also a compensating effect and e.g. compensate the stiffness variation of the brake via the lining wear via its characteristic curve. For example, a worm gear can be rotated against a worm-gear wheel with the wear adjuster in order to rotate the position of the S-Cam 056 against the spreading section drive 052. For this purpose, a carrier element 025 (e.g. arranged at the non-linearities 03) can, e.g. after exceeding a deliberate clearance (which can define the air gap) via e.g. a torque limiter (e.g. slipping clutch 023 or spring), rotate the position of the S-Cam 056 against the spreading part drive 052 or, e.g., act on the wear adjustment 02 of an e.g. drum or disc brake (arrows). Other possibilities are e.g. adjustable cams 035, where e.g. a wear adjustment can take place if a steep cam e.g. advances too far during actuation or e.g. no wear adjustment takes place if e.g. a steep cam is pushed back during actuation.

FIG. 16 shows that a cam does not have to be made of solid material, rather can also be, for example, a cam 037 or adjustable cam 035 which can be deformed in any way. For example, a wire or rod with e.g. a round or rectangular cross-section can also be bent in order to produce a smooth rolling surface for the roller at low cost. On the other hand, the springy effect of this bent rod can also be exploited in order to get an automatic adjustment of stroke and slope at any point: Thickly drawn is an unactuated initial position, darkly drawn would theoretically be a somewhat actuated position. By springing back, the bent rod (deformable cam 037), it thereby returns to the dashed position with less slope. When the force of the roller 033 against the resilient rod (deformable cam 037) is greater than expected, it springs back even further and gets even less slope and therefore a smaller “cam drive torque”, since the bent rod acts as a cam.

This process can be repeated at any point. Although this creates a kind of “automatic transmission”, by definition the actuator (which, for example, drives this “cam” directly or via, for example, a gear train) is never operated at constant cam drive or actuator torque, because increasing drive torque is always required for more bending back. The right figure shows that the bent bar (deformable cam 037) itself can have little to no spring behavior, and the spring behavior comes from protrusions against a center section, corresponding to an adjustable cam 035.

The bending back behavior depends on the spring property of the bar, on the position and type of the clamping point (which could also be, for example, only a pivot point) and it can be additionally determined, also area-wise, by further behavior-influencing springs (at the dashed area of the deformable cam 037). This could also or additionally be designed by utilizing a leaf-spring-like structure of e.g. several or locally several or variously curved spring letters. The deformable cam 037 can be preloaded so that, for example, no additional deformation occurs when it follows the preloaded contour, the preload being indicated in the bend of the arrow to the lower left. In 034, one can imagine the cam rotation axis and 038 can be a more or less pronounced clamping or fastening point.

At a constant actuator torque, the torque-averaging spring (the retreating spring action) was always loaded to the same extent. Since the spring length determines the adjustment, there can never be a constant actuator torque. The instantaneous non-linearities are automatically set by this method in the operation of the actuator, but not in the design calculation of a single non-linearities.

The non-linearities can also be designed in such a way that a new advantageous non-linearity is achieved with each spring change, e.g. that a flatter area of the cam follows when the spring is compressed.

The spring deflection and instantaneous non-linearities can be utilized to infer the press-on force in order to carry out a particularly accurate wear adjustment.

A particularly advantageous design would be, for example, a “cam” as a bent spring rod, which initially makes a particularly large lining stroke, more than is required, for example, with a correct air gap and elasticity of the brake with full lining. Due to the particularly fast movement of the lining in the air gap, the contact point can be easily determined by measurements on the actuator (e.g. torque, current, position). For this purpose, the deformation of the bar can also be recorded (measurement, switching function), for example, From the moment of contact, the contact pressure can be built up as quickly as possible for vehicle displacement. If the air gap is smaller (also due to e.g. brake disc expansion), then the rod is bent back for smaller slope. This is repeated at each position until a final position. When the brake is now stiffer due to worn linings, the rod is in turn bent back more and the stroke is also reduced.

This method “releases”, if applicable, actuation energy into the bar deformation, so it therefore requires more actuation energy than with a rigid non-linearity.

Preferably, delay can be achieved as quickly as possible, which would not be possible for safety reasons with rigid non-linearities, because possible undesired states must also be actuatable and would lead to suboptimal rigid non-linearities. However, with this method, more energy can be put into bending if the brake is stiff (worn linings) and, if applicable, than when the brake is softer. On the other hand, the difference between full linings and worn linings in rigid non-linearities once again translates into suboptimal non-linearities in order to cover “everything”. When a preload is present, then the energy lost to the spring can be less than or zero.

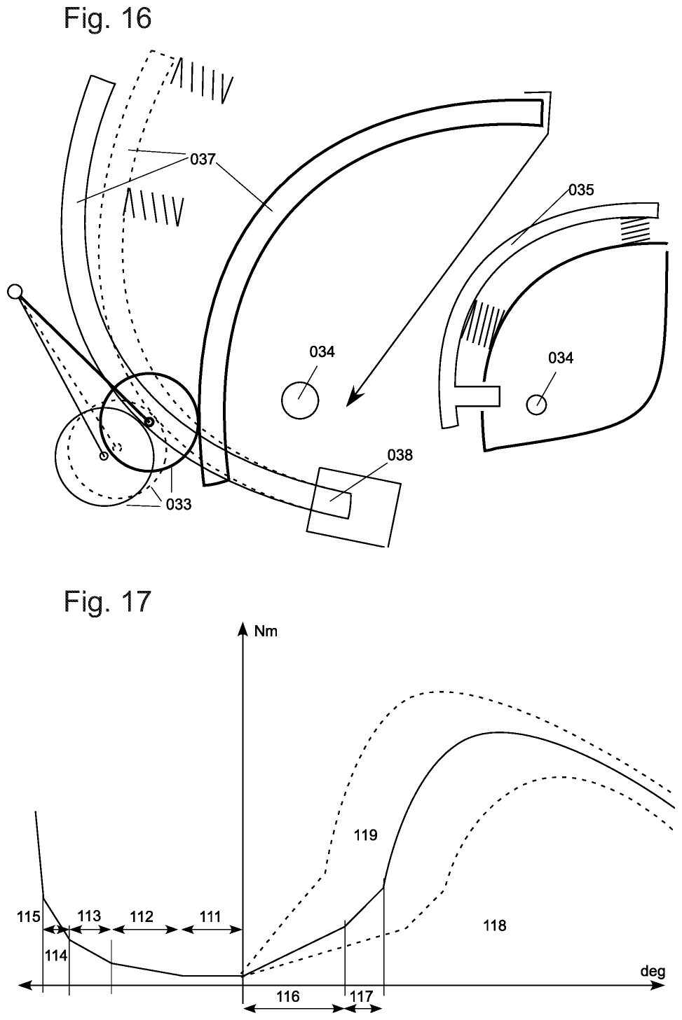

FIG. 17 with actuator angle on the X-axis and actuator torque on the Y-axis points to the positive X-axis various traversed lining contact forces, which can of course also be recorded on the brake actuator as a torque. However, there can also be an area 111 in negative X-axis, where no lining stroke (or only a small one, no “functional”) is made, whereby the instantaneous mechanical losses also become visible, which occur without contact pressure. There can be an area 112 where an onset of wear adjustment and/or springs in wear adjustment become determinative of actuator torque. In area 113, an actual rotational movement in wear readjustment can require more actuator torque. In area 114, an actual rotational movement in wear readjustment and/or slipping clutch can additionally increase the actuator torque. From 115, a fully executed wear readjustment and/or an end stop (e.g, for actuator angle), if applicable with a spring, can subsequently increase the actuator torque again. The negative actuator movement here is also utilized here in order to determine these areas and to trigger these actions and movements and, if applicable, in order to determine the actuator torque. In principle, there should be no stroke on the lining present, rather a small positive contact pressure path which must not be a problem here.

As soon as the lining is lifted, then it can be possible to detect at least one spring action 116 in addition to the losses without lining movement, e.g, for lining lifting. With an additional lining stroke, a wear adjustment 117 can possibly set in, which can also be visible on the actuator torque. From then on, lining press-on force will take place as the actuator angle increases. The wear readjustment, including the spring action, can also take place, as shown and described above, in actuator positions which are otherwise unused for braking, shown here as “negative lining movement”, which naturally only exists from the point of view of the actuator angle. Naturally, there is a shift in the curves (especially from lining pressure) when a wear readjustment is made (e.g. with the brake actuator). One will determine the requirements by utilizing the course of the curves in the contact pressure area, e.g., in area 118 and e.g. less actuator torque with hot brake for a more cost-efficient motor and/or, for example, in area 119 by geometry and mechanical load capacity, because, for example, high clamping forces can occur due to a small air gap. The dashed curves therefore show a smaller (left) and larger (right) air gap than compared to the full curve.

In particular, the adjustable cams, which have already been indicated, can be designed in such a way that they start so steeply that the contact point can be detected very accurately, e.g. by the fact that the adjustment, by turning back against the spring, starts too early when actuated, when too little air gap is set or there is hot expansion, and that the turning back from the contact point does not start yet, when the contact point comes too late when actuated and too much air gap is set. This return adjustability and therefore slope can be advantageously selected in such a way that a very precise detection of these small forces is possible through a large slope although, by utilising the return adjustability, a slope can always be found which enables a safe brake application.

Something similar can be achieved with multiple linear or non-linear ball ramps, or with lever transference with adjustment possibility.

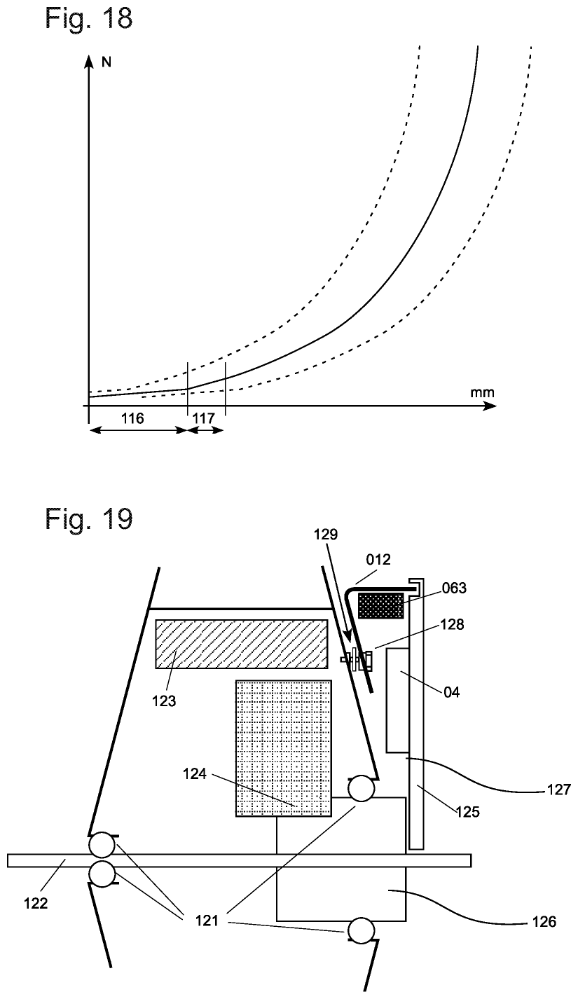

FIG. 18 shows the lining conditions (lining stroke on X-axis, lining press-on force on Y-axis) of FIG. 17 with otherwise identical signage. The actuator movement without lining stroke is not shown in FIG. 18.

FIG. 19 shows a possible assembly for an EMB on a wheel hub motor for e.g. a bicycle, bicycle trailer, moped etc., whereby a wheel hub dynamo is of course equally possible. An axle 122 can be mounted on one or both sides and has wheel bearings 121 of any preferred type and quantity which support substantially stationary parts 124 (e.g., coils, gears, etc.) with rotating parts 123 (e.g., magnets, etc.). There can be connecting cables 126 for wheel hub motor or dynamo and connecting cables 127 for the EMB present, the cables preferably being located on the same side of the brake, preferably on the mounted and/or inboard side of the vehicle and/or preferably on the side of the brake which does not substantially rotate and has, for example, an assembly plate (or otherwise formed part) for drum brake parts 125. e.g., on which e.g. also in any arrangement, an actuator 04 (or actuator parts such as e.g. springs) can be located, or the actuator (or parts) can also act from another location. There will still be brake drum 012 (with brake linings 063) present, and the brake drum can be produced together with a rotating brake part, for example, or attached thereto such as drum attachment 128, and there can also be thermal insulation 129 located there between. It can be favorable that the wheel with the brake and/or the brake can be easily pulled off and/or removed (that e.g. also the brake drum is removed) and, if possible, the cable connections do not have to be separated and, if possible, no greased parts are exposed after pulling off, which would be at risk of damage or loss. Even though in FIG. 19 a brake drum 012 rubs against the brake lining 063, any other friction geometries can be utilized, including discs or conical ones. When the “brake drum” is designed as conical, then a conical lining can be pressed axially into it for actuation, e.g. with a (also non-linear) ball ramp. Additional contact pressure can be generated by the carrier force (braking force), e.g. by a (also steep or non-linear) contact pressure movement (of e.g. a ball ramp or a part of a ball ramp), in that e.g. a steep ramp is slightly rotated by the carrier force, which subsequently can act in one direction of travel or in both directions of travel. Such a construction design or a similar construction design and/or cone brake is of course also possible without an electric machine.

As a particularly advantageous embodiment, it is recommended that the motor and/or generator or dynamo can also be electromagnetically excited (respectively as a combination of electromagnetic and permanent magnet excitation), instead of permanently excited as is customary today: When no or little current is to be produced, then one can significantly reduce the magnetic snapping, which appears as rolling resistance, by not magnetizing it, on the other hand, the voltage can also be increased as a generator with stronger excitation and/or the torque can be increased as a motor function and/or the motor rpm can be increased with field weakening, in addition, no seldom magnetic materials are required. Particularly advantageous here is that a motor torque and/or generator torque can therefore be coordinated with the torque of the friction brake in additional areas and/or a generator voltage can be achieved for better regenerative braking and/or improved battery charging. The (also additional) electromagnetic excitation can of course also be utilized when the motor, generator and/or dynamo is structurally separated from the brake. One would transfer the excitation current to rotating parts preferably without slip rings, i.e. similar to a transformer effect, and the current for the power would be preferably transferred to a stationary part. Alternatively, or additionally, the rotational speed of one of the two (rotor or stator) can be increased (e.g. via the transmission unit, but also electrically) and/or the relative speed between rotor and stator can be increased. One can therefore implement this electrically, for example, by superimposing an additional rotating field on the “field” (which can be e.g. located on the rotor): The field can usually be generated with direct current, here it is also proposed that it one could also generate it as a rotating field and therefore increase the relative speed between power coils (e.g. stator) and the field. One can therefore utilize this method, for example, to retain the voltage of a generator higher as the rpm decreases, or to reduce the size of a generator, for example, with apparently higher rpm. One could also designate this as a conversion machine and/or rotating field machine or rotating field generator.

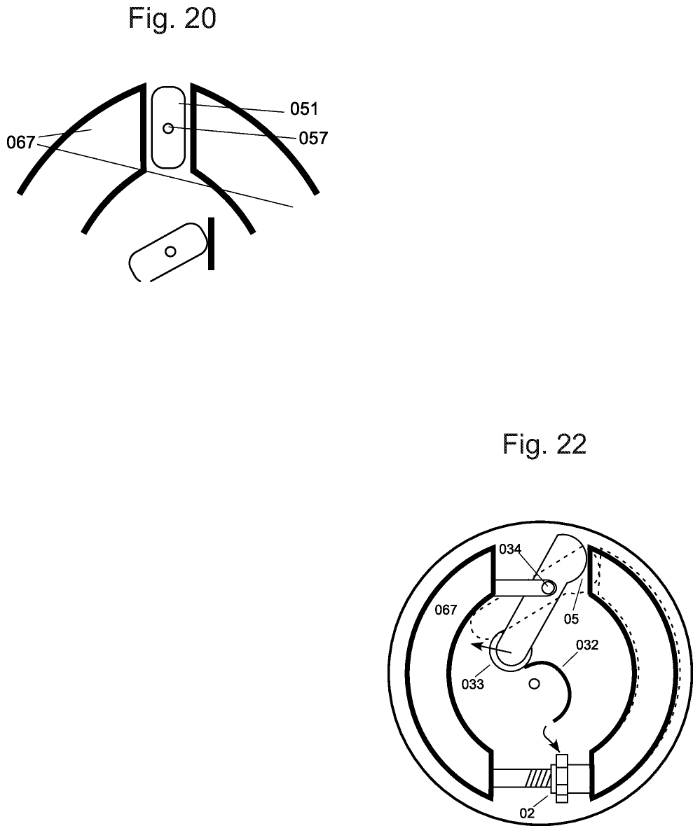

In FIG. 20, the problem of a “screwdriver-like” spreading part 051, which is common in drum brakes today, can be explained: it produces scraping losses (e.g., at the brake shoes 067) when rotated about the spreading part pivot 057, has a non-linear cosine-shaped stroke which becomes zero in the horizontal position, and has no compensating capability for different lining thicknesses when the pivot is usually fixed.

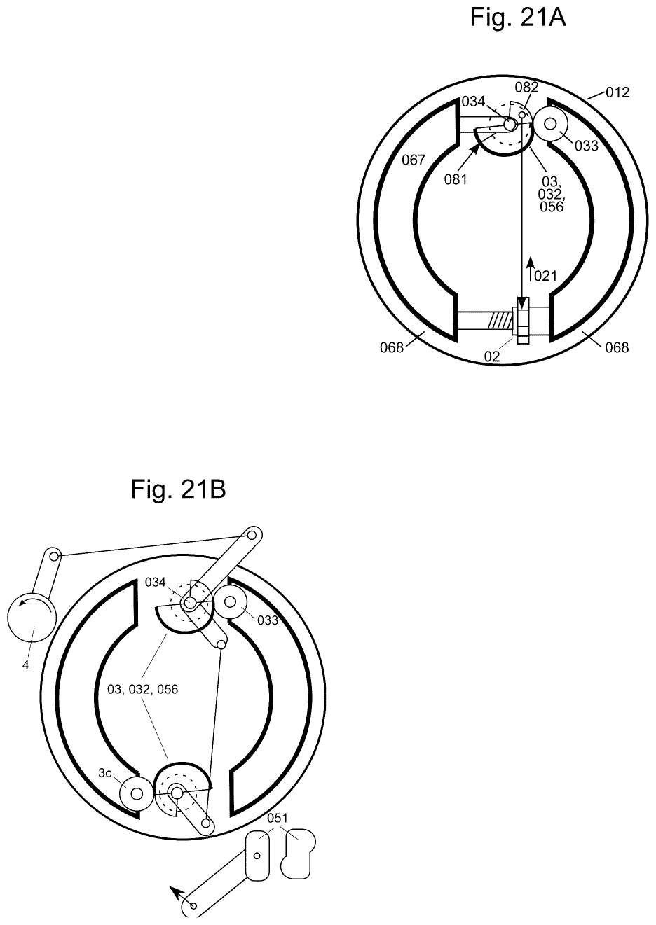

Improvements are therefore proposed in FIG. 21A: a non-linearity 03, which can also be formed as an operating cam 032 or similar to a part of an S-Cam 056, rolls on the roller 033 with reduced friction, for example, and can also have the pivot point cam pivot axis 034 located on the left brake shoe 067 in order to obtain lining pressure on both sides. The arrow pointing downwards indicates that the wear readjustment actuation of the wear readjustment 02 can be actuated, for example, by an area 082 of the non-linearities 03 which is not utilized for braking and which does not make any stroke and is therefore not utilized for the braking process, whereby the readjustment force can also be limited by means of a slipping clutch (dashed) and respectively force and/or the path can also be influenced by means of a spring for wear-adjustment 021. A pre-setting for a wear readjustment or a triggering a wear readjustment in case of too much stroke (similar to a self-adjusting car drum brake) can also be affected via an area 081, which is utilized for braking, whereby again a slipping clutch, spring or other influence is possible in such a case. The wear readjuster area around the wear readjustment position 02 can also transmit the braking force of one shoe to the other and therefore enable so-called servo braking. The wear readjuster side of the cam can also make a stroke in order to determine the contact point (via actuator torque, slipping clutch, etc.) and for the actuator torque a spring can serve as a reference, with which the start of the lining pressure can be determined.

In FIG. 21B, it is shown how an actuator 04 can actuate e.g. a duplex drum brake, whereby the cam rotation axes 034 can be e.g. fixed and e.g. non-linearities 03, linearizing actuating cams 032, also like a part of a S-Cam 056, can press on the shoes and the actuations of these cams can be e.g. connected with an indicated rod. A wear readjustment can, for example, readjust or pre-turn the cam(s) in rotary motion (e.g. with a ratchet) (as is known, for example, with S-cams) or, for example, trigger a readjustment in an area which is not utilized for braking against the normal direction of actuation. Below in FIG. 21B, it is shown that a spreading part 051 is usually actuated, for example, by a cable tension (arrow) and, in this case, can have any mechanically favorable shape which preferably follows the movements during the lining pressing-on action. Necessary compensating movements can be absorbed in the play of the components, so that there is as little “scraping” movement as possible between the parts.

FIG. 22 shows an actuating cam 032 which is combined with a lever, the movements of contact pressure 05 and lining carrier preferably being such that they are as equal as possible, i.e. with little relative movement, and the relative movement preferably being taken up by existing play. The actuating cam 032 can, for example as indicated by the arrow, execute a readjustment on the wear readjustment 02. For example, an electromagnet could also pull (arrow at roller 033) instead of the pressing actuating cam 032. Dashed area shows the fully braked condition.

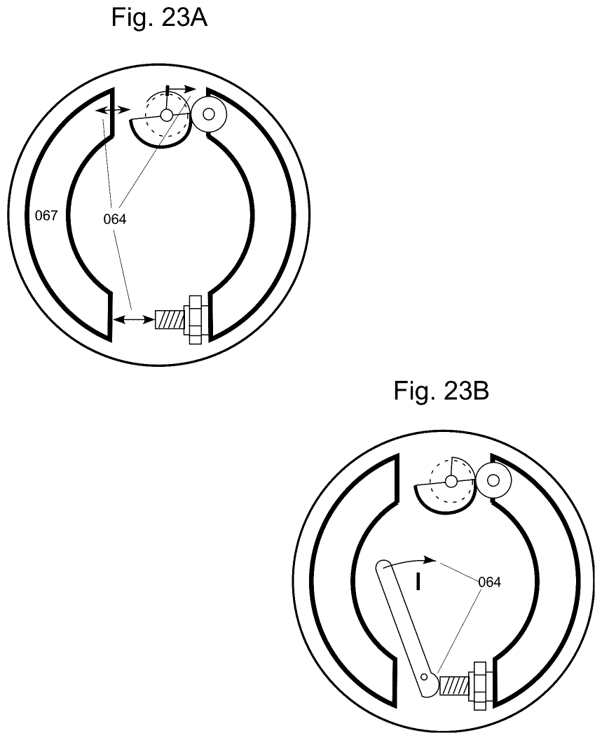

FIGS. 23A-23B make proposals for brake force measurement, as they can also be combined in a modified form with all the brakes which are shown. FIG. 23A shows the basic possibilities for how and/or where carrier force measurements 064 can be implemented in a protected area (inside a drum brake, without external force). The small right-pointing arrow above the cam indicates that, for example, any spring force, e.g. of a lining compression spring, can also be measured in an area without functional lining stroke. Since the direct carrier forces are correspondingly high, then FIG. 23B proposes converting the high carrier force (e.g. with a lever) into a smaller one with a greater path and measuring the force or path on the arrow of the lever, or even just a switching function, e.g. with the indicated end stop (short, thick, vertical line), which shows, e.g. with a small braking torque, the start of usable contact pressure and therefore a point on the instantaneous force-displacement characteristic.

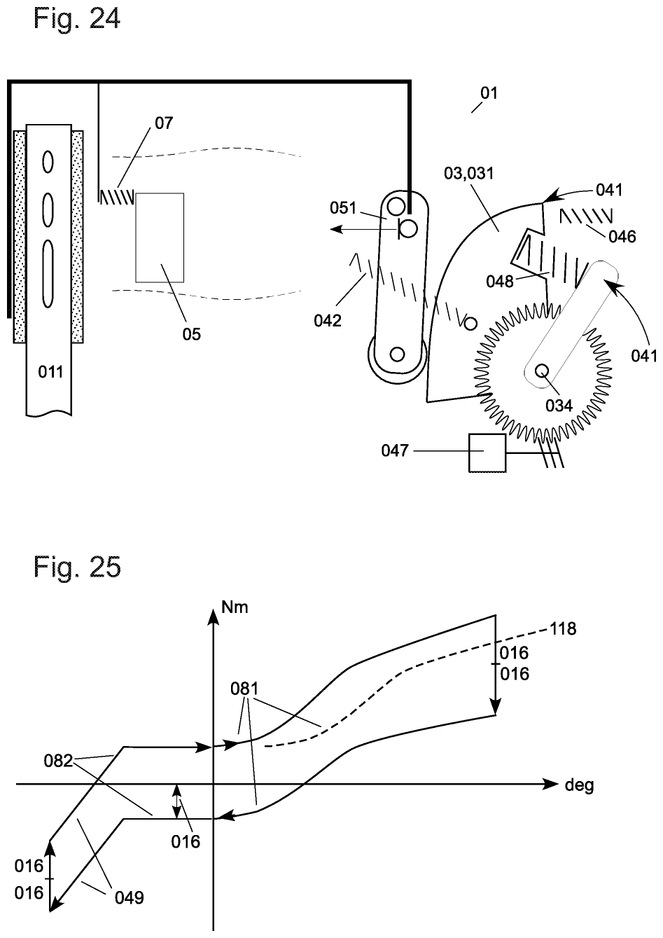

An example of a comprehensive brake 01 is shown in principle in FIG. 24, i.e. it can be applied with a brake disc 011 but also any other friction such as a drum and/or, for example as a linear sequence and, of course, not all the parts which are applied need to be utilized and/or functions can also be designed differently (e.g. low-energy release or low-energy actuation). In this example, it is actuated by a non-linearity 03, e.g. a cam 032, via a contact pressure 05 (which can also include a wear readjustment, for example), in which case, for example, one (or more, also for lifting off all linings) air-split generating spring 07 can act. An actuating spring 042 can be provided in order to bring the brake to a braked status, for example, without energy from the motor 041, and/or also to operate in “energy swing” so that the motor 041 is supported by spring action in the direction of “actuate” or “release” (although both effects can also be cycled). The motor 041 could act rigidly on a non-linearity 03, but could also act, for example, via a spring 048, which could act, for example, as a “parking brake spring” 048: It can be difficult, or even impossible, to achieve a certain parking brake position, especially with self-energizing brakes (e.g. drum brakes, also known as “servo” brakes) or when a brake disc, for example, expands when heated by the motor torque. The parking brake spring 048 can subsequently still enable the actuator to move when it is e.g. therefore compressed in the process.

When the opportunity arises (e.g. when there is minimal movement of the brakes during self-amplification or cooling), then the spring will release the movement for contact pressure. Now, when a parking brake actuator 047 is utilized with, for example, the toothed gear around the cam rotation axis 034, then the parking brake actuator 047 can operate the brake independently of the actual brake actuator (with, for example, the motor 041), preferably when the toothed gear is decoupled from normal brake operation via a coupling (e.g., acting and/or ratcheting only in the actuation direction) or a carrier element, therefore not interfering with normal operation. This can also be utilized as an emergency brake drive, e.g. to brake when motor 041 is not effective. The direction and/or directions of rotation in which the springs (in particular the actuating spring 42), motor 041 and parking brake drive 047 interact must of course always be selected in such a way that the desired function is created, e.g. “release” or “actuate”. In general, the less the actuator torque alters in the range of the observed alteration due to influences from the one which is already known, then the better a known, occurring alteration in the actuator torque can be recognized, which is intended in particular to keep alterations from the contact pressure effect (at least insofar as they are not known precisely enough) low. This brings us to the general formulation of the functional lining stroke: when the intentional alteration to be recognized is well enough recognizable, despite the (low) lining stroke, then one can also speak of “no functional lining stroke” in this definition.

In FIG. 25 it is shown on the basis of actuator torque (Y-axis), via actuator angle (X-axis), how an area without functional lining stroke here e.g. in an area 082 not otherwise utilized for braking, e.g. against the direction of rotation normally utilized for braking, can utilize a calibration spring 046 with spring characteristic 049: with negative rotation, in this case, and correspondingly negative actuator torque, the unwanted (e.g. mechanical) losses 016 are thereby passed through without any other force build-up until the calibration spring characteristic 049 is passed through. Afterwards, the direction of rotation is reversed and the losses are now visible in the opposite direction, i.e. they basically appear in double height during reversal. When thereafter a brake actuation is applied in an area 081 which is utilized for braking, then one can see positive losses by positive actuator rotation here, which can increase with increasing contact pressure and, in turn, become visible in double height when the direction of rotation is reversed (direction loose), therefore the losses 016 are larger on the right and shown twice. With more air gap, the curve could shift to the dashed larger air gap 118. The procedure in the area 082, which is not utilized for braking, does not have to executed in the unbraked state, e.g. A positive direction of rotation in a “braked” status would also be possible, again advantageously without functional lining stroke.

A “calibration spring” 046 can be provided, for example, in order to enable comparison of a known or stored spring characteristic 049 (or at least one value) with the motor torque determined (e.g., from the current) in a non-braking condition, and/or to enable comparison of different values determined during movement, and to enable more accurate control of the brake or better detection of incipient contact of the brake lining with the disc. This calibration spring 046 can not only act in a braking action, in an air gap or also in an actuator movement which does not cause any significant lining movement, but also in several such areas or subject matter, also with different action and task. A spring which fulfills at least one other function can also be utilized for calibration purposes. How the motor torque is represented here is arbitrary, as it can also be as a “force”, current or without unit in this case, advantageously this calibration will capture and consider, however, the momentary friction in the drive unit. A “release spring” (spring for air gap generation 07) can help in a known way in order to press friction linings and brake linings apart in the unbraked status, i.e. away from the braking effect. The release spring can also therefore be related to the motor torque for calibration purposes. The spring behavior can also be included in the determination of the mechanical losses, also in connection with air gap, touch point and the course of the non-linearities. The calibration spring 046 can be utilized, for example, in a motor area with no lining stroke or very low lining stroke and, from lining stroke onwards, the additionally acting spring for air gap generation 07 can also be utilized for calibration purposes. This calibration can also be seen as a determination of a deviation, also as a comparison (also including the course of non-linearities and characteristics of the springs) with something measured, but also as an instruction (what to do to become better or to achieve something), whereby here at least one value is worked out, which explains deviations in such a way that they can be compensated.

In order to find the initial position of the actuation cam 032 (or other non-linearities such as ball ramp), for example, a stop or a spring can also be approached, i.e. also the calibration spring mentioned, which can have the special advantage that it can be approached e.g. before the first real braking and can lie e.g. in an actuator rotation range which can have special properties such as e.g. no appreciable lining stroke or e.g. in a direction or range of rotation which is not utilized for normal brake operation. For example, before the initial braking, a calibration can therefore be implemented in order to determine which values are measurable on the actuator (e.g. current, power, energy, etc.) and correspond to which spring action and this also, for example, via the (possibly also extrapolatable) calibration spring characteristic 049 or points thereof.

The instantaneous, occurring unwanted mechanical losses 016 can also therefore be detected with this action. A distinction can also be made as to whether only “idling losses” occur as long as no significant lining movement is associated with the actuator movement, and a spring is not yet acting, and from when the spring action is detected for this purpose. In this way, it can be concluded very precisely when the lining press-on force begins to increase during braking for which, of course, the instantaneous non-linear transference between the value, which is measurable on the actuator and the lining press-on force, must also be taken into account.

A possible recommendable procedure would therefore be, for example, (advantageously, for example, also in a range of little stroke to essentially no lining stroke, for example, also in an actuator rotation direction 082 which is not utilized for normal operation or other braking: Increase of actuator rpm still without spring effect, holding of speed still without spring effect (which can be seen e.g. as running with covered losses without other energy supply), tensioning of spring from (e.g. essentially) the mass inertia of the rotation, determination of the “braking distance” until the spring brings the rotation to a standstill, acceleration by the spring (now e.g. against the above direction of rotation), whereby this acceleration can e.g. also run with defined motor current (therefore e.g. also advantageously zero), approaching of a point, from which a normal operating braking or other braking is then started e.g. in the area 081 which is utilized for braking. This procedure could be executed in a short time. e.g. when switching on the brake, and already provides a very comprehensive image before the initial braking operation and brings the brake into a defined status for the following braking operation(s): One can see electrical and mechanical losses during acceleration, also until the spring is reached, then during tensioning of the spring, tensioning e.g. without (or with defined. e.g. loss-covering) electrical energy can make the mechanical losses visible, before reversal of direction of rotation a measurement can show what is necessary (e.g. current, torque etc.) in order to retain the spring tension at standstill, during the following acceleration after reversal of direction of rotation e.g. the mechanical effect of spring force against mass inertia can be seen, after acceleration e.g. a “coasting phase” (e.g. without additional electrical energy supply or e.g. with defined) and could show the use of the rotational energy to overcome the mechanical losses. It is recommended (but not obligatory) to place the spring in a position for the transference, where the actuation of the spring is greater than in the stroke of the lining because, then with a smaller spring force, the aforementioned procedure will be closer to the range of normal braking or a smaller spring can be utilized. In the aforementioned procedure, a lot of measurements can be made, although this is not mandatory, one can also measure e.g., only the total energy consumption over the whole procedure and since, without loss, no energy would have been necessary, then conclude from the energy on the loss status. How exactly the procedure functions, whether only parts of the procedure will take place or are utilized and what is measured when and how, is therefore freely configurable, the essential thing is that the procedure can be utilized for calibration (e.g., when switching on, but also otherwise). It can also make any measured values recognizable. e.g. also the measurable status on the actuator which is to be expected for a certain press-on force (braking effect). Generally speaking, the aforementioned procedure is the conversion of one form of energy into another (e.g. electrical into mechanical and/or e.g. kinetic into potential such as spring tension, mechanical into electrical). Of course, the method can be applied to this energy conversion in general and is not limited to named components such as “calibration spring”. A physically equivalent procedure (and/or partial procedure) therefore occurs, for example, when the actuated brake (which acts as a spring) accelerates the motor and/or decelerates an actuating movement as braked during releasing, for which purpose it is possible for one to run the acceleration or deceleration with zero motor current, for example, in order to essentially detect the mechanical losses. The clamping force (or the resulting torque) in the brake (and possibly other forces, e.g. from springs) therefore acts as an acceleration force or deceleration force. When this is stored (e.g. as a characteristic curve), then the actual status of the brake could deviate from the stored one and, when the clamping force is measured or estimated (e.g. from current), then the measurement has tolerances, i.e. one would compare something stored, for which it can be questionable to what extent it is true at all, with something measured, which has tolerances. Hence the proposal that measurements arising during actuator angle alterations can also be compared, whereby even systematic measurement errors can be compensated for when they are similar. In a brake where the actuator movement and lining movement are linked by a stable transference ratio, the actuator torque would vary greatly with the contact pressure position, which can of course still be an application case for the energy method which has been described here. However, it is recommended to utilize a so-called non-linear EMB, because the actuator torque does not vary as much over the actuation as with a linear EMB, and therefore the accelerating torque and/or braking torque is better known in case of deviations than with a linear EMB, or does not contain such strong deviations.

The described procedure can be modified for the purpose of status determination, e.g. by omitting or altering the sequence, the procedures can be abrupt or arbitrary. e.g. sinusoidal or S-shaped (e.g. velocity or motion), although they can also be superimposed on the motion (e.g. by velocity alteration, current alteration, also up to short-time switch-off and/or even current direction reversal). The procedures do not have to be selected from this method, rather can also be utilized from those which are caused by other means. For example, a “brake release” can be utilized by the driver in order to observe actuator acceleration. In particular, it is known that “in sum, no energy can disappear or be gained”, based e.g. on the fact that the signed sum of torque from mass inertia plus torque from brake actuation plus torque from losses plus torque from the actuator plus moments from others (e.g. springs) must always be a total of zero. In particular, it is proposed that intentional or unintentional alterations (e.g. of the actuation) on the conversion of the energy form are also to be investigated: For example, intentional accelerations (or decelerations) could be inserted in an actuation rpm in order to determine the reaction, or the accelerations (or decelerations) do not have to be inserted intentionally, rather can also occur “by themselves” or, for example, be executed by the driver. This now brings us to the general formulation of the procedure: Each actuator movement and/or alteration of it can be examined for conversion of the energy form, if applicable including conversion into losses, in order to find parameters of the process such as e.g. total losses, partial losses, expected actuator values with certain braking etc. In particular, the motor torque (or, e.g., the torque-generating current) can be examined with the known mass inertia, the presumed and/or from measurement closed clamping force from the brake, known spring effects and possibly other known effects to find out how the sought influence quantities (e.g., losses) must be (or are presumed to be) in order to explain the actuator torque curve, possibly taking into account the conversion of the energy forms. One can, of course, execute this in order to obtain a wide variety of results, e.g. to explain the motor torque curve for certain actuator observations. In general, one can considered it, for example, as a finding for an explanation for an observation. It could also be called a transformation: In a Fourier transformation e.g. a temporal amplitude course is transformed into the strength of frequencies, here e.g. a temporal course of an e.g. actuator torque is transformed into parameters (e.g. losses), which are seen as co-determining for the course.

As shown, the actuator had to return a negative angle and overcome losses, which were also negative due to the negative direction of rotation. When no force is taken or added for other purposes, the actuator torque now corresponds to the losses and can be detected immediately, even without difference to another direction of rotation. These are “idling losses”, e.g. of a motor transmission unit. These can vary due to, for example, different location or toughness of the grease which is utilized, so it is favorable to know the instantaneous value. Loss fluctuations can also be detected in the course of rotation. The spring characteristic curve can be recorded from the spring guide and also compared with the spring characteristic curve of the actually installed spring or, for example, angular points on the spring characteristic curve are connected with a resulting torque from the spring. When this spring is e.g. Located in the rotary motion of the actuation worm gear, then the spring can be relatively small in the lining stroke, in contrast to the spring discussed above, and still generate appreciable actuator torque, because an additional transference between rotation of the actuation worm gear and lining stroke greatly increases the press-on force.

“Considerable” can thereby mean that e.g. roughly that actuator torque is generated which later corresponds to a customary e.g. light or defined brake actuation and one already knows now which actuator torque can be expected at actuation, also with the problem of the losses (which were already included here). This spring also does not require useless tension energy in the braking operation. It does not have to be a spring either, it can also be a rubber or a stop, for example. An end stop would cause very high distortion forces when driving into the end stop (e.g. In order to find it), which a spring and/or rubber with lower distortion forces can do. It does not have to be an explicit part, an existing or arbitrary part can be utilized, also “nothing” would be possible in the sense that the actuator does not move further in this direction. Therefore e.g. torques which occur when operating a function (e.g. a wear adjuster) can also be utilized. Something which can be found by the actuator torque (e.g. stop, spring, rubber, etc.) is also recommended here in the sense that an initial position can be found or determined at the same time.

When the actuator now rotates back towards the starting position, then the losses are now suddenly in the other direction of the torque and, if the direction of rotation alters, then the losses are in principle twice as high. This procedure can take place e.g. when a brake is switched on and can provide e.g. the following statements: how large are no-load losses, also with possible fluctuations, also as possibly dependent on the direction of rotation, where is an initial position or e.g. angular reference point (however called), how large will the actuator torque be when a certain, e.g. weak braking occurs?

However, since it does not trigger braking, the procedure can be implemented at will, except possibly during braking.

Of course, it is also possible and/or meaningful to record an actuation characteristic of the brake (e.g. actuator angle and actuator torque, also with the difference actuation-release), also up to the range of lining contact forces, e.g. when the vehicle is at a standstill, or also to use a normal braking process as a characteristic recording.

For the determination of losses, it is also recommended that another known force can be utilized alternatively or additionally to the spring: Due to the fact that the share of the fast rotating parts increases with the square of the transmission ratio, the mass load-carrying capacity is determined to a large to predominant part by the motor (the slower parts can, of course, also be taken into account). This makes it possible, for example, to apply a certain speed variation over time in a range without significant lining stroke (others are of course not excluded), to measure the actual behavior, and therefore to measure the torque going into the load-carrying capacity, which, however, still contains the mechanical losses in the measured value. When the theoretically necessary torque is subtracted, the losses remain. This calculation can be made in any other way describing the same physics, e.g. time for certain motion, motion in time, torque and time, etc. For load-bearing or inertia-based loss detection, all other physical quantities involved in the procedure, such as energies (rotation, losses, etc.), can also be utilized.

A measurement at the actuator motor will, of course, preferably be executed electrically, e.g. via current (preferably the Iq, the “torque-generating current” is suggested), voltage, angle sensors (or others). An “actuator power” could be calculated from this, for example, as current multiplied by voltage (and the efficiency when shaft power is required). Power and torque can be, as is already known, transferred into each other via angular velocity (e.g. rotational speed). Now; in the efficiency, there is the unpleasant fact that it strongly depends on other things, such as e.g. the current (also squared), the temperature, the voltage etc., therefore, besides this calculation, a more favorable one is also proposed: Electric motors (e.g. BLDC) have a well representable (e.g. characteristic curve) or almost linear relationship between current (preferably Iq) and torque, because current and magnetic force are causally related and the motor force comes from the magnetic force. Voltage and efficiency are not required in the above sense: corrections can of course be assumed, such as temperature or aging dependence, etc. In addition to mechanical losses, electrical losses can also be determined or included with this knowledge, if the reference to the electrical input (e.g. current, etc.) is utilized for the mechanical reaction (e.g. torque, angular acceleration).

With what has been explained so far, it would not be (easy to) distinguish the division of losses (up to here partially also called mechanical losses) from the electrical input to the contact pressure effect on the lining, whereby of course the described method with the current-torque relationship helps a lot. Therefore, another procedure is proposed here, which can also determine the division of the losses between mechanical and electrical: above, two forces are already shown, which act purely mechanically (others could be imagined in addition, of course): the spring and the mass carrier. When now only these act, e.g. in the unpowered status, then the electrical losses will be switched off and one can distinguish between a system with electrical losses and one without and thereby distinguish these two losses. Of course, the question still remains whether an unpowered motor has no electrical losses at all, but this does not have to be clarified scientifically, only applied practically. Other “de-energized statuses” can also be utilized for reaction measuring e.g. reversal of direction or brake release. Instead of “current-free”, statuses of different currents can also be compared and therefore a “current-free” can also be calculated. “Current-free” does not have to be exactly 0, but can be any suitable value. When the same force is applied, multiplied by the same path in a shorter time, then proportionally more power is required.

It is hereby recommended that something similar is also utilized in order to determine the electrical losses (or, respectively, to determine the separation between mechanical and electrical). When a movement of the same energy takes place in a different time, then there is a correspondingly different power and one can determine or estimate the losses at different powers from at least two such procedures. This can subsequently be extended mathematically in such a way that also procedures with different energy can be compared. “Energy” is here only a physically meaningful expression: other values can also be utilized with which this principle can be achieved. When a brake actuation takes place now, then one will find (above representation) e.g. increasing actuator angles with an actuator torque sequence and one can also already always compare, how the respective actuator torque (including instantaneous losses) behaves with respect to spring characteristic curve, whereby in the figure, the spring characteristic curve has the opposite signs (the signs must be considered only correctly or e.g. be calculated for this case as unsigned). Utilizing the known non-linear transference ratio will also make it possible to draw very precise conclusions about the lining press-on force, since the losses are also well known. In addition to the “no-load losses”, there can be additional losses up to the lining press-on force, but these can depend more strongly on contact forces than on fluctuations (e.g. due to grease viscosity). Therefore, they can be e.g. well calculated or extrapolated or even recognized in dependence of the influencing factors, as shown below. Of course, the actuator torque curve does not have to correspond exactly to the planned curve, the measurements can also show the dashed curve. One can subsequently e.g. recognize that the contact point (at which actuator angle the lining comes into contact with the friction surface) is different than the planned one, e.g. due to lining wear, and a wear readjustment can be requested. When the brake is released, then the curve again jumps down by twice the losses, at least under the assumption that nothing affecting the relevant conditions in the brake has altered, which could indeed be the case, for example, when braking has taken place without e.g. significant heat and/or thermal expansion and/or wear. These visible losses here are now not only the no-load losses, but include also all others. What is referred to here as “jumping losses”, when the direction of rotation is reversed, in reality take place within relatively little actuator angle change, especially when constant load direction (e.g. Lining press-on force) “pushes” the play or tolerance out of the mechanisms and the clearances are essentially on the same side.

A non-linear brake, i.e. with a transference ratio which varies over the lining stroke, is recommended as advantageous when it operates over the lining press-on force with an actuator torque which does not vary very much, because the torque range in which the spring characteristic is compared is then relatively limited. In contrast, with a linear drive unit (e.g. ball screw), the actuator torque varies extremely from air gap to full braking. Particularly recommendable is also a non-linearity which is divided into ranges, because this facilitates the implementation of e.g. a range without significant lining stroke.

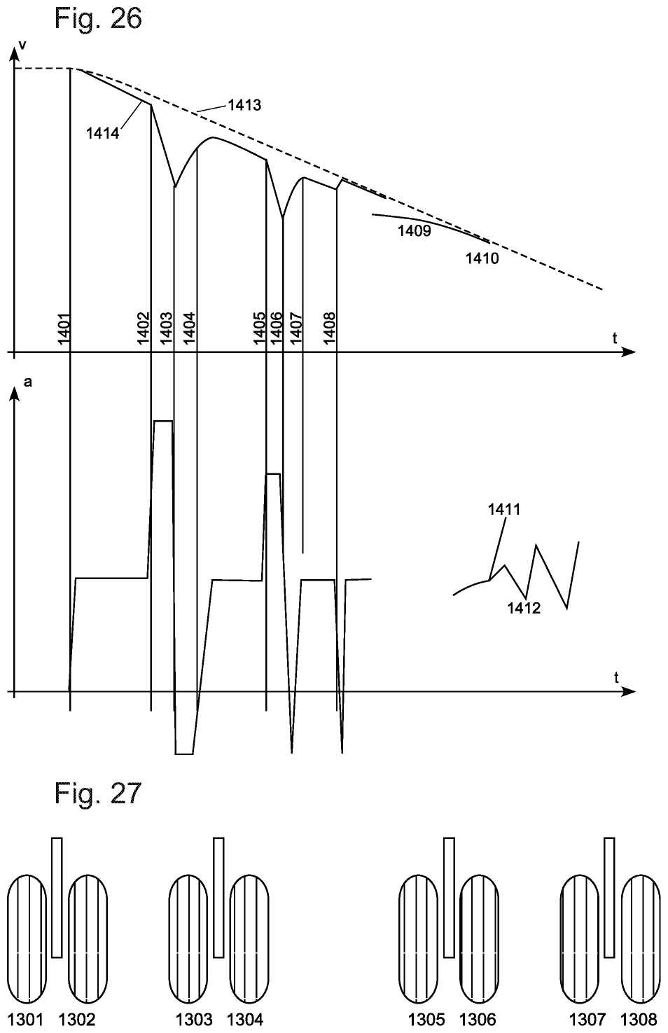

FIG. 26 proposes a possible operation of an anti-lock braking system which takes advantage of an EMB and one that is based on the positioning capability of the actuator, which is not naturally possible in this way with hydraulic brakes. The diagrams have the time t entered on the x-axis, the upper diagram shows the velocity v on the y-axis, more precisely the vehicle velocity 1413 (dashed) and a wheel velocity 1414, the lower diagram indicates the rotational speed, rpm, delay of the wheel as the first derivative of the wheel velocity on the y-axis. ABS is possible with a jointly actuated brake to a limited degree. It occurs preferentially differently from pressure-actuated braking.

For example, one can initially observe wheel locking when braking is increased, e.g. on an icy side of the road. Now, with additionally applied braking, e.g., more braking effect became possible when the wheel rotates on the other side, e.g., on asphalt. This increasing braking effect can be limited in the speed of increase and in the braking effect in order to prevent unwanted yawing moment and/or to build it up so slowly that the driver can therefore start to compensate for it. With these jointly applied brakes, the wheel with less grip will now start to lock, but the wheel with grip can retain lateral control and therefore braking can be good and stable even though one wheel will lock.

1401 is an incipient braking. Whereby the wheel rpm becomes slightly lower than the vehicle speed due to permissible slip. The vehicle speed, when considered as the speed over the ground, can be determined in many ways, e.g. by the instantaneous deceleration, by the highest wheel speed, by GPS or other measurements. 1402 is braking which is too hard, because the slip increases and the wheel speed decreases too fast. The brake actuator position for this, still favorable point, will be stored. Now, however, the brake actuator was braking too hard in the direction of movement and will unfortunately increase the braking input at the wheel to 1403, although one goes back to the still good brake actuator position and reaches the again favorable state 1404, where again favorable wheel slip prevails and, for the time being, there is a favorable braking effect. Now, at 1405, for example, the wheel adhesion deteriorates and the wheel speed starts to drop too much, which causes a reduction in the braking input and, from 1406, the target braking effect had actually already been reduced enough and the wheel speed approaches the vehicle speed again due to reduced slip. This brake actuator position for the improved status of 1406 will be stored. However, the actuator, which now rotates in the released direction, differs from this favorable point. But one knows the favorable point and returns, at 1407, to it again and to a favorable nominal brake position.

At 1408, there is a sudden improvement in wheel adhesion, which can be viewed from the decreasing slip and therefore from the increasing wheel rotation speed. At 1408, the nominal braking effect has been increased again and the whole procedure was restarted from 1, since it is not known at this point how good the adhesion is. 1409 now describes an unrecognizable or hardly or not pronouncedly recognizable wheel adhesion improvement: the wheel speed approaches the vehicle speed. In this case a nominal braking effect increase test can be implemented, as shown in 1410 and at any increase with 1411, the cycle was started again with 1401. However, it is also possible to start with a modulation of 1412 in order to determine the instantaneous adhesion state and also to provide the modulation with a sequence, e.g. to intensify it and/or to vary it in the average value, e.g. to increase it. This modulation can also be applied always on the braking, or only in suspicion cases, or only with certain criteria, like e.g. a little expressive slip. It is also possible to require a minimum variation of thickness (e.g. of a brake disc or rail) and/or out-of-roundness of a brake drum (e.g. next to maximum values) in order to obtain at least a minimum variation of the braking effect over the revolution and thereby utilize it as modulation.

It is also possible to have slippage conditions present which do not indicate the described characteristics. For example, blocking can occur immediately on ice without pronounced increasing slip. In this case, e.g. braking can be implemented by other or additional methods, e.g. to use a brake actuator position which just alters from locking to running wheel or to remain at a brake actuator position (possibly also limited in time) where just the starting wheel speed was observed.

Certain rapid, small, or modulating alterations in the braking action can be implemented by the drive unit motor and/or generator.

These procedures can be executed jointly for the connected wheels in the case of mechanically connected EMBs, or per wheel in the case of individually braked wheels.

Naturally, the maximum permissible yaw torque can once again limit braking or the build-up rate of yaw torque can be limited or shaped.

As an appropriate method for vehicle stability (ESC), it is hereby proposed that the desired distribution of forces on the wheels for optimal stability (e.g., lateral steering, propulsion, braking, rear wheel breakaway, pushing over the front wheels) is constantly calculated at this EMB control system and the wheel target braking effects are constantly adjusted according to this calculation. Steering or single wheel steering can also be therefore included.

If the drive unit motor of the vehicle (also of the trailer!) should be equipped with a decoupling possibility, e.g., freewheeling, then this vehicle drive unit motor could serve naturally advantageously in a direction of rotation as a vehicle drive unit and, in the other one, as a brake actuator or this allocation could take place by whichever kind of alterations in the drive unit.

“Vehicle stability” in the sense of an ESC can only be achieved to a limited extent with these associated brake actuators. However, it is possible to let the trailer exert a pulling force on the towing vehicle, which can help against trailer rolling away.

When a desired braking effect and the achievable braking effect are not, or not well, compatible (e.g. when the wheel loads can be very different), then this ABS can also be used to execute the brake control in such a way that, despite this incompatibility, the achievable braking effect is utilized as well as possible, i.e. systematic too little, too much or blocking braking is prevented as far as possible, as would be possible with a well and/or optimally matching desired braking effect and which would have the achievable braking effect. An example would be a target braking desire, which e.g., always goes from 0 to 100% and a trailer axle with very different axle load, where e.g. the target braking torque is applied for high trailer load, but is limited early by wheel slip and therefore a better actual braking behavior is achieved, e.g. as whether the target braking wish took into account the actual axle load. This can of course be applied to wheels, axles or a vehicle and can be related to any wheel slip determinations, also e.g. that too little braking is executed and, from too little wheel slip, a higher braking effect setting follows and, of course, it can be extended to vehicle stability like ESC or sway control.

In FIG. 27, an aircraft landing gear with many braked wheels is represented, whereby a mechanical connection of the brake actuation is not possible in a reasonable way. Despite the independent brakes in this case, an undesired or uncontrollable yaw torque should be prevented, which can of course also be applied to other multi-track vehicles.

For this purpose, it is therefore proposed to control the actuator positions of the individual brakes electrically in the same or similar way and also to make the same wear readjustments, because then again, as described above for mechanical synchronization, stronger braking EMBs will approach the weaker braking ones by more lining wear and vice versa. For this purpose, it is advantageous to utilize a controlled wear readjuster in which the degree of readjustment is known so precisely that small tolerances are compensated for by stronger/weaker lining wear and do not therefore result in constantly accumulating inequalities. In all the embodiments shown here, it is advantageous to include a wear model which prevents excessive or insufficient adjustment and takes into account, for example, wheel speeds, rpm, velocities, braking torques, distortions, temperatures and braking power.

One would basically implement ABS as in the simple braking system with mechanically connected brakes, except that no wheels have to be deliberately operated as locked, rather than any braking effect can be set correctly. For yaw torque control, for example, one can correctly combine the left 1301-1304 and right 1305-1308 wheels into yaw torque and the rate of rise-limited groups, e.g. 1301 with 1308. The permissible yaw torque can also be speed-dependent, for example, in order to compensate for side-rudder effect which decreases with speed, or aircraft weight can be included. Instantaneous thrust reversal effects can also be included. One can also intentionally create a yaw rate or yaw torque in order to steer directly or support steering. This can also be implemented in combination with the rudder, so that e.g. steering with the rudder is preferred and only when it is not thereby sufficient with the wheel brakes, possibly including steered wheels.

This “steering with the brakes” can, of course, also be executed with all other vehicles, e.g. in the event of failure of a steering system or insufficient effectiveness of a steering system such as, for example, tight curves and/or unfavorable substrates, ground or unfavorable inclination positions.

In the case of EMBs, a vehicle stability system such as ESC would naturally be used in order to calculate the best possible braking effect for each individual wheel and not, as is usual with hydraulics, apply the same brakes on the left and right and only counteract with individual wheel braking when instability is classified.

In an embodiment which is not shown here, the electromechanical brake 01, comprises an actuator 04, in particular an electric actuator 04, a transmission unit 045, a brake lining 063 and a friction surface.

The actuator 04 moves within a limited actuator operating range. Furthermore, the actuator 04 executes a lining stroke via the transmission unit 045 in at least a portion of its actuator operating range, which presses the brake lining 063 towards and against the friction surface in order to generate a press-on force as well as a resulting braking torque for braking.

The transmission unit 045 of this embodiment displays a non-linearity 03, which is a transmission ratio that is not constant over at least a portion of the actuator operating range. In other words, the transmission unit can be non-linear and/or configured in such a way to enable a non-constant transference.

The transference for the transmission unit 045 is selected and/or designed in such a way that at least two subsections with differently acting non-linearities 03 are therefore created along the actuator operating range. These two differently acting non-linearities 03 are selected from the following non-linearities 03: non-linearity 03 for overcoming an air gap 068 between the brake pad 063 and the friction surface, non-linearity 03 for determining the contact point of the friction surface and the brake lining 063, non-linearity 03 for achieving a minimum braking effect, non-linearity 03 for generating an increasing braking torque, non-linearity 03 for operating with lowered electrical power requirements, non-linearity 03 for rapidly achieving high braking efficiencies, non-linearity 03 for measuring and/or adjusting parameters, non-linearity 03 for reducing electrical and mechanical loads during lining stroke start, non-linearity 03 for compensating for brake fade, and/or non-linearity 03 for wear readjustment 02.

The invention is not hereby limited to the embodiments which are represented, rather it includes any electromechanical brake, any machine, any wear readjuster and any method according to the following claims.

1. An electromechanical brake comprising:
an actuator;
a transmission unit;
a brake lining; and
a friction surface, wherein:
actuator moves in a limited actuator operating range;
the actuator executes a lining stroke via the transmission unit in at least a portion of its actuator operating range, which presses the brake lining towards and against the friction surface in order to generate a press-on force as well as a resulting braking torque for braking;
the transmission unit displays a non-linearity, i.e., a transference ratio which is not constant over at least a part of the actuator actuation range;
the transference for the transmission unit is selected and/or designed in such a way that at least two subsections with differently acting non-linearities are therefore created along the actuator operating range; and
the two differently acting non-linearities are selected from the following non-linearities:
a. non-linearities for overcoming an air gap between brake lining and friction surface,
b. non-linearities for determining the contact point of the friction surface and the brake lining,
c. non-linearities for achieving a minimum braking effect,
d. non-linearities for generating an increasing braking torque,
e. non-linearities for operation with lowered electrical power requirement,
f. non-linearities for rapidly achieving high braking effects,
g. non-linearities for measuring parameters and/or setting parameters,
h. non-linearities for reducing electrical stresses and mechanical stresses during lining stroke start,
i. non-linearities for compensation for brake fading,
j. non-linearities for wear readjustment.

2. The electromechanical according to claim 1, wherein:
the transference for the transmission unit is selected and/or designed in such a way that the actuator is operated in at least one partial range, in particular with a brake-effect relevant and/or functional lining stroke, at an operating point which deviates from the optimum operating point of the actuator, and
if applicable, the actuator is operated in at least one partial range, in particular with functional lining stroke, preferably with braking effect-relevant lining stroke, in an operating point which deviates from an operating point of maximum power of the actuator.

3. The electromechanical brake according to claim 1, wherein:
the transmission unit, starting from a zero position of the transmission unit for braking, executes or converts a movement of the actuator in one first direction; and/or
the transmission unit, starting from a zero position of the transmission unit for adapting the air gap, in particular for actuating a wear readjustment and/or wear readjustment device, executes or converts a movement of the actuator in a second direction, in particular opposite to the first direction.

4. The electromechanical brake according to claim 1, wherein:
the transmission unit is only one part of the movement of the actuator, in particular the actuator range or area which is converted in one, particularly functional, preferred braking-effect relevant, lining stroke, and
the actuator is moved, if applicable, before and/or after the part of the actuator actuation range or area which is relevant for the, in particular functional, preferably braking-effect relevant, lining stroke via the transmission unit in the first and the second direction without generating a, in particular functional, preferably braking-effect relevant, lining stroke.

5. The electrotechnical brake according to claim 3, wherein:
the transference for the transmission unit is selected and/or designed in such a way that, starting from the zero position of the transmission unit along the movement of the actuator, in particular of the lining stroke, in the first direction, the non-linearities are arranged in the following sequence:
a. if applicable, non-linearities for reducing electrical stresses and mechanical stresses during lining stroke start,
b. non-linearities for overcoming an air gap between brake lining and friction surface,
c. if applicable, non-linearities for determining the contact point of the friction surface and the brake lining,
d. non-linearities for achieving a minimum braking effect,
e. non-linearities for operation with lowered electrical power requirement,
f. non-linearities for rapidly achieving high braking effects,
g. non-linearities for generating an increasing braking torque, the braking torque therefore being adapted to the respective braking dynamics, if applicable,
h. non-linearities for compensation for brake fading.

6. The electromechanical according to claim 3, wherein:
the transference for the transmission unit is selected and/or designed in such a way that, starting from the zero position of the transmission unit along the movement of the actuator, in the second direction, the non-linearities for measuring parameters and/or setting parameters and/or the non-linearities are arranged to the wear readjustment.

7. The electromechanical brake according to claim 3, wherein:
the non-linearities for measuring parameters and/or setting parameters, if applicable, are designed to measure mechanical losses, the zero position of the transmission unit, the zero position of the actuator position and/or at least one spring action;
the non-linearities for measuring parameters and/or setting parameters is designed in such a way that the actuator, starting from the zero position of the transmission unit, is moved in its first direction whereby due to the movement of the actuator in its first direction, at least one parameter of the brake, in particular motor losses, transmission unit losses, mechanical losses and/or the effect of any springs present, can be measured, whereby in particular resulting from the movement, can be detected, and wherein the assessment as to whether an adjustment of the brake is necessary is made on the basis of a comparison of the at least one parameter of the brake, in particular the moment of the actuator, with expected values and/or with measured values of the moment of the actuator at other operating points and/or in other operating statuses;
the non-linearities for measuring parameters and/or setting parameters is designed in such a way that the actuator, when starting from the zero position of the transmission unit, in its second direction, whereby a force measuring device, in particular a spring and/or an end stop, which is to be provided in the second direction, is positioned against at least one part of the transmission, in particular the actuator, is in contact, with which the zero position of the actuator position can be measured and/or set.

8. The electromechanical brake according to claim 1, wherein:
the non-linearities for reducing the electrical and mechanical loads during lining stroke start are designed in such a way that the transference ratio for the transmission unit, in particular the speed transference for this non-linearity, preferably the ratio between the speed of the actuator and the speed of the lining stroke, when located in the first half of the air gap, in particular in the first half of the path for overcoming the air gap, is more than twice as great as the speed transference in the second half of the air gap.

9. The electromechanical brake according to claim 1, wherein:
the non-linearities for overcoming the air gap between the brake lining and friction surface are designed in such a way
that the transference ratio for the transmission unit, in particular the speed transference for this non-linearity, preferably the ratio between the speed of the actuator and the speed of the lining stroke, over more than half of the air gap, in particular more than half of the distance, which is required to overcome the air gap, is less than half as great as the maximum speed transference in the lining stroke region adjoining the air gap, so that the air gap is overcome more quickly in comparison with normal operation.

10. The electromechanical brake
according to claim 1, wherein:
the non-linearities for determining the contact point of the friction surface and the brake lining are designed in such a way that the contact point of the brake lining and the friction surface can be recognized, in particular from the energy, current and/or power consumption of the actuator and/or from the actuator load sequence, in particular the torque, so that it is possible to inspect whether a readjustment of the brake, in particular a readjustment of the brake lining and/or an adjustment of the air gap, is necessary, in that the transference for the transmission unit of this non-linearity, in particular in the possible region of the contact point of the brake lining and the friction surface, generate an evaluable combination of transference ratio and actuator torque, in particular an interpretable curve from the energy, current and/or power consumption of the actuator, the actuator load and/or the actuator torque, over the actuation, in particular taking into account the respective transference ratio, so that, if applicable, a significant difference from the behavior in the air gap will therefore result from the contact between the friction surface and the brake lining.

11. The electromechanical brake according to claim 1, wherein
the non-linearities for achieving a minimum braking effect are designed in such a way that a certain required minimum braking effect, in particular in the case of emergency braking, is achieved within a minimum action time, the minimum action time being that which is only a maximum of 20% above the time which is technically possible with the electromechanical brake, in particular for achieving the minimum braking effect.

12. The electromechanical brake according to claim 1, wherein:
the non-linearities for generating an increasing braking torque, whereby the braking torque is to be adapted to the braking dynamics, if applicable, in such a way that the speed of the braking torque build-up is adapted to the dynamic weight shift of the commanding device caused thereby, in particular of a vehicle comprising the electromechanical brake, so that a locking of the wheels of the vehicle is counteracted, if applicable in this case.

13. The electromechanical brake according to claim 1, wherein:
the non-linearities for operation with lowered electrical power requirement are designed in such a way that the power consumption of the actuator, during operation of the transmission unit at low speeds and/or when the actuator is at a standstill, is at least 20% lower than in comparison with a non-linear transference which is designed in particular according to the criteria of the maximum achievable motor output power, for the same or a similar operation and/or operating point, in particular for operation at low rpm and/or when the actuator is at a standstill, so that the power consumption of the actuator is reduced, in particular during longer continuous braking.

14. The electromechanical brake according to claim 1, wherein
the transference for the transmission unit is selected and/or designed in such a way that, starting from the zero position of the transmission unit along the movement of the actuator, in particular of the lining stroke, in the first direction, non-linearities for operation with lowered electrical power requirement is arranged in such a way that, in operating statuses which have a long holding period and/or a high temperature load, a low consumption of electrical energy and/or a low heat loss of the, in particular electrical, actuator will therefore result.

15. The electromechanical brake according to claim 1, wherein
the non-linearities for compensation for brake fade are designed in such a way that the actuator is operated with a motor torque which, under the same operating conditions, in particular the operating temperature, is higher, in particular higher than the maximum permissible motor torque and/or higher than the maximum permissible shaft power, than that with a non-linearity which has been designed according to the criteria of the maximum achievable motor output power, so that a braking effect is also achieved in the event of brake fade.

16. The electromechanical brake according to claim 1, wherein:
at least one non-linearity, in particular over the lining stroke, for compensating for air gap errors is designed in such a way that an air gap error, in particular a deviation of the size of the air gap from the assumed dimension, is thereby compensated for, the air gap error preferably resulting from wear, and/or
if applicable, the brake will be operated up to a certain deviation of the magnitude of the air gap error, in particular by adapting the movement of the actuator, preferably without implement any wear readjustment.

17. The electromechanical brake according to claim 1, wherein
the non-linearities for wear readjustment are designed in such a way that the actuator executes a movement against the direction of movement which is utilized for braking, in particular a movement in the second direction, and that the wear readjustment device is actuated by this movement of the actuator, in particular without any braking effect.

18. The electromechanical brake according to claim 1, wherein:
the non-linearities for wear readjustment are designed in such a way that the actuator executes a movement in the direction of a braking, in particular a movement in the first direction, that the wear readjustment device is thereby actuated by this movement of the actuator, in that, if applicable, after a maximum position of the actuator which is required for the braking, in particular for the parking braking, has been reached, an additional movement of the actuator will result in the actuation of the wear readjustment device or prepares this.

19. The electromechanical brake according to claim 1, wherein
the actuator and/or the transmission unit is set up for braking and wear readjustment, in particular for actuating a wear readjustment device; and/or
the brake comprises only one actuator for braking and for wear readjustment, in particular for actuating a wear readjustment device.

20. The electromechanical brake according to claim 1, wherein:
the brake comprises a brake readjustment device which, in particular, is exclusively actuated by the actuator.

21. The electromechanical brake according to claim 1, wherein:
the actuator comprises numerous parts;
the actuator comprises a spring and an electric motor, whereby the spring and the electric motor are optionally independent of each other in terms of component and/or direction of action, and/or wherein, optionally, the spring cooperates with the electric motor via at least one additional component and/or via the transmission unit with the electric motor; and/or
the actuator comprises two electric motors; and/or
the electromechanical brake interacts with at least one electric machine or electromagnetically excited electric machine.

22. The electromechanical brake according to claim 1, wherein:
at least a minimum of one actuator position of the actuator is retained with a lowered, in particular very low, electrical power requirement or as current free by a corresponding design of at least one non-linearity and, if applicable, by the interaction of this, at least one non-linearity with a spring, in particular a spring action.

23. The electromechanical brake according to claim 1, wherein:
transmission unit comprises a kinematic device; and/or
the transmission unit comprises a can, a ball or spherical ramp and/or a lever.

24. The electromechanical brake according to claim 1, wherein:
the transference for the transmission unit, in particular in brake operation, can be altered; and/or
the transference for the transmission unit, in particular when active, can be altered as preferred with rotating a ratchet, and/or
the transference for the transmission unit, in particular when passive, can be altered as preferred by a spring-loaded retraction of components, elastic deformation of components.

25. The electromechanical brake according to claim 1, wherein:
the effective range of at least one non-linearity is distributed over several parts of the transmission unit, in particular several transmission components, preferably cams and/or ball ramps which are twisted against each other, and
if applicable, the effective range of at least one non-linearity will be assigned to a specific actuator actuation range in each case.

26. The electromechanical brake according to claim 1, wherein:
the transference for the transmission unit is selected and/or designed in such a way that an actuator movement without braking effect will cause a movement of brake components, such as in particular the brake lining carrier; and
this movement, if applicable, will not cause any and/or a minimized residual friction torque.

27. A machine, in particular a transport device, a conveying device, vehicle, elevator or bicycle, comprising an electromechanical brake according to claim 1.

28. The machine according to claim 27, comprising an additional, in particular, electronic brake device, hereby characterized by the fact that the additional brake device is designed as, in particular, a spring-loaded parking brake.

29. A wear readjustment device designed to be actuated by the actuator of an electromechanical brake according to claim 1.

30. A procedure for operating an electromechanical brake according to claim 1, wherein
the actuator will move the brake in a limited actuator operating range;
the actuator executes a lining stroke via the transmission unit in at least one part of the actuator operation range and, for braking the brake lining is pressed towards and against the friction surface for generating a press-on force as well as a braking torque resulting from this; and
the transmission unit displays a non-linearity, i.e. a transference ratio which is not constant over at least a part of the actuator operating range, so that the actuator is moved along the actuator operating range via the transmission unit over and/or along at least two differently acting non-linearities, and whereby the two differently acting non-linearities are selected from the following non-linearities:
a. non-linearity for overcoming an air gap between brake lining and friction surface,
b. non-linearity for determining the contact point of the friction surface and the brake lining,
c. non-linearity for achieving a minimum braking effect,
d. non-linearity for generating an increasing braking torque,
e. non-linearity for operation with lowered electrical power requirement,
f. non-linearity for rapidly achieving high braking effects,
g. non-linearity for measuring parameters and/or setting parameters,
h. non-linearity for reducing electrical stresses and mechanical stresses during lining stroke start,
i. non-linearity for compensation for brake fading,
j. non-linearity for wear readjustment.

31. The procedure according to claim 30, wherein:
the transference for the transmission unit is designed in such a way that the actuator is operated in at least one partial range, in particular with functional and, or braking effect-relevant lining stroke, at an operating point which deviates from the optimum operating point of the actuator, and
if applicable, the actuator is operated in at least one partial range, in particular with functional lining stroke, preferably with a lining stroke which is relevant to braking effect, in an operating point deviating from an operating point of maximum power of the actuator.

32. The procedure according to claim 30, wherein:
a movement of the actuator in an initial direction is converted by the transmission unit, starting from a zero position of the transmission unit for braking, so that a movement in an initial direction is executed by the transmission unit if applicable, and/or
a movement of the actuator in a second direction, in particular opposite to the first direction, is implemented by the transmission unit, starting from a zero position of the transmission unit, for adapting the air gap, in particular for operating a wear readjustment device, so that a movement in a second direction is executed, if applicable, by the transmission unit.

33. A procedure according to claim 30, wherein:
only part of the movement of the actuator, in particular of the actuator operating range, is converted by the transmission unit into a lining stroke, in particular a functional one, preferably one which is relevant to the braking effect; and
the actuator is moved, if applicable, before and/or after the part of the actuator operating range relevant for the, in particular functional, preferably brake-effect-relevant, lining stroke via the transmission unit in the first direction and the second direction without generating a, in particular functional, preferably brake-effect-relevant, lining stroke.

34. A procedure according to claim 30, wherein:
the transference for the transmission unit is designed in such a way, starting from the zero position of the transmission unit, so that the actuator is moved in the first direction, in particular along the lining stroke; and
along this first direction, the non-linearities are arranged in the following sequence:
a. if applicable, non-linearities for reducing electrical stresses and mechanical stresses during lining stroke start,
b. non-linearity for overcoming an air gap between brake lining and friction surface,
c. if applicable, non-linearities for determining the contact point of the friction surface and the brake lining,
d. non-linearity for achieving a minimum braking effect,
e. non-linearities for operation with lowered electrical power requirement,
f. non-linearity for rapidly achieving high braking effects,
g. non-linearity for generating an increasing braking torque, whereby the braking torque is to be adapted to the respective braking dynamics, if applicable,
h. non-linearities for compensation for brake fading.

35. A procedure according to claim 30, wherein
the transference for the transmission unit is selected and/or designed in such a way that, starting from the zero position of the transmission unit, the actuator will move in the second direction, and
along this second direction, the non-linearity for measuring and/or setting parameters and/or the non-linearity for wear readjustment are to be arranged.

36. The procedure according to claim 30, wherein:
the non-linearity for measuring and/or setting parameters, which is designed in such a way that the actuator, starting from the zero position of the transmission unit, is moved in its first direction, by at least one parameter of the brake, in particular motor losses, transmission unit losses, mechanical losses and/or the effect of any springs present, are being measured by the movement of the actuator in its first direction,
the torque of the actuator, in particular arising and/or resulting from the movement, is detected, and whereby the at least one parameter of the brake, in particular of the actuator torque, is compared with expected values and/or with measured values of the actuator torque at other operating points and/or in other operating statuses, and the comparison is utilized in order to judge whether an adjustment of the brake is necessary, and/or
that the non-linearity for measuring and/or setting parameters is designed in such a way that the actuator, starting from the zero position of the transmission unit, is moved in its second direction;
whereby a force measuring device, in particular a spring and/or an end stop, is provided in the second direction, against which at least a part of the transmission unit, in particular the actuator, abuts, whereby the zero position of the actuator position will be measured and/or adjusted.

37. The procedure according to claim 30, wherein
the non-linearity for reducing electrical and mechanical loads during the lining stroke start is designed in such a way that, as a result of the transference ratio of the transmission unit, in particular the speed transference for this non-linearity, the actuator in one part, is moved less quickly, in particular less than half as quickly, preferably in the first half, of the air gap than the maximum speed in the lining stroke region which is located as adjoining to the air gap.

38. The procedure according to claim 30, wherein:
the non-linearities for overcoming the air gap between the brake lining and friction surface is are designed in such a way that, due to the transference ratio of the transmission unit, in particular the speed transference for this non-linearity, the actuator, is moved over more than half of the air gap, in particular more than half of the distance in order to overcome the air gap, and is moved faster, in particular more than twice as fast as the maximum speed in the lining stroke range which is located as adjoining to the air gap, so that the air gap is overcome more quickly than in normal operation.

39. The procedure according to claim 30, wherein:
the non-linearity for determining the contact point of the friction surface and the brake lining is designed in such a way, that the point of contact between the brake lining and the friction surface is detected, in particular from the energy, current and/or power consumption of the actuator and/or from the profile of the actuator load, in particular the torque, whereby an inspection will be executed for whether a readjustment of the brake, in particular a readjustment of the brake lining and/or a readjustment of the air gap, will therefore be necessary, in that by the transference by the transmission unit of this non-linearity, in particular in the possible region of the contact point of the brake lining and the friction surface, generates an evaluable combination of transference ratio and actuator torque, in particular an interpretable progression from the energy, current and/or power consumption of the actuator, the actuator load and/or the actuator torque, via the actuation, in particular taking into account the respective transference ratio, so that, if applicable, a significant difference from the behavior in the air gap is obtained as a result from the contact of friction surface and brake lining.

40. The procedure according to claim 30, wherein:
is the non-linearities for achieving a minimum braking effect are designed in such a way that a certain required minimum braking effect, in particular in the case of emergency braking, is achieved within a minimum action time, the minimum action time being that which is only a maximum of 20% above the time which is technically possible with the electromechanical brake, in particular for achieving the minimum braking effect.

41. The procedure according to claim 30, wherein:
the non-linearity for generating an increasing braking torque, means that the braking torque will be adapted, if appropriate, to the braking dynamics, and is designed in such a way that the speed of the braking torque build-up is adapted to the dynamic weight displacement of the transporting device or conveying device which is caused thereby, in particular of the vehicle, so that blocking of the wheels, if applicable, of the vehicle will therefore be counteracted.

42. The procedure according to claim 30, wherein:
the non-linearity for operation with reduced electrical power requirement is designed in such a way that at least 20% less power is absorbed by the actuator during operation of the transmission unit at low speeds and/or when the actuator is at a standstill, than for the same or a similar operation and/or operating point, in particular for operation at low speeds and/or when the actuator is located at a standstill, in comparison with a non-linearity which is designed in particular according to the criteria of the maximum achievable motor output power, so that the power consumption of the actuator is therefore reduced, in particular during longer continuous braking operations.

43. The procedure according to claim 30, wherein:
the transference of the transmission unit is selected and/or designed in such a way that, starting from the zero position of the transmission unit along the movement of the actuator, in particular of the lining stroke, in the first direction that the non-linearity for operation with reduced electrical power requirement is arranged in such a way that, in operating statuses which have a long holding time and/or a high temperature load, there is a low consumption of electrical energy and/or a low heat loss of the actuator.

44. The procedure according to claim 30, wherein:
the non-linearity for compensating for brake fading is designed in such a way that the actuator is operated with a motor torque which, under the same operating conditions, in particular for the operating temperature, is higher, in particular higher than the maximum permissible motor torque and/or higher than the maximum permissible shaft power, than that with a non-linearity which is designed according to the criteria for the maximum achievable motor output power, so that a braking effect is also achieved in the case of brake fade.

45. The procedure according to claim 30,
a minimum of at least one non-linearity, in particular over the lining stroke, for compensation of air gap errors is designed in such a way that an air gap error, in particular a deviation of the size of the air gap from the assumed dimension, is compensated for whereby the air gap error preferably results from wear; and/or
if applicable, the brake is operated up to a certain deviation of the magnitude of the air gap error, in particular by adapting the movement of the actuator, preferably without implementing wear readjustment.

46. The procedure according to claim 30, wherein:
the non-linearity for the wear adjustment is designed in such a way that the actuator is moved against the direction of movement which is utilized for braking, in particular in the second direction, and
by implementing this movement of the actuator, in particular without braking effect, the wear readjustment device is actuated.

47. The procedure according to claim 30, wherein:
the non-linearity for the wear adjustment is designed in such a way that the actuator is thereby moved in the direction of a braking, in particular in the first direction, that the wear readjustment device is actuated by this movement of the actuator, in that, if applicable, after a maximum position of the actuator which is required for the braking, in particular for the parking braking, has been reached, then the wear readjustment device is actuated by an additional movement of the actuator or this actuation is prepared.

48. The procedure according to claim 30, wherein:
the brake comprises a wear readjustment device which is actuated, in particular exclusively, by the actuator.

49. The procedure according to claim 30, wherein:
at least one actuator position of the actuator is retained in position with a lowered, in particular very low, electrical power requirement or as current-free, if applicable, by corresponding design of at least one non-linearity and optionally by the interaction of this at least one non-linearity with a spring, in particular a spring action.
